(19) United States
(12) Patent Application Publication
(10) Pub. No.: US 2019/0340516 A1
(43) Pub. Date: Nov. 7, 2019

(54) SYSTEM AND METHOD FOR QUANTITATIVELY ANALYZING AN IDEA

(71) Applicant: EXCUBATOR CONSULTING PVT LTD, Bangalore (IN)

(72) Inventor: VIVEK KUMAR, Bangalore (IN)

(21) Appl. No.: 16/404,346

(22) Filed: May 6, 2019

(30) Foreign Application Priority Data
May 6, 2018 (IN) 201741039471

(51) Int. Cl. G06N 5/02; G06Q 10/06

(52) U.S. Cl. CPC G06N 5/02; G06Q 10/0635

(57) ABSTRACT

A system and a computer-implemented method for quantitatively analyzing an idea, for example, a business idea, and generating decision-based contextual recommendations on the idea are provided. The system selectively extracts data sets associated with a context of an idea input, from one or more internal and external data sources. The system computes measurement indices related to market buzz, competition, investor and entrepreneur interest, domain and technology skill, commitment, funding and geography risk, etc., by performing a quantitative analysis of the data sets with reference to configurable thresholds and/or based on predetermined criteria. The system computes an execution risk index using the user-defined parameters, in communication with one or more of the internal and external data sources The system generates a recommendation score based on the measurement indices and the execution risk index for generating decision-based contextual recommendations to arrive at one or more decisions related to the idea.

### CROSS-REFERENCE TO RELATED APPLICATIONS

This application claims priority to the Provisional Patent Application with Ser. No. 201741039471, filed in the Indian Patent Office on Nov. 6, 2017, with the title “SYSTEM AND METHOD FOR ANALYSIS OF IDEAS AND ORGANIZATIONAL INTELLIGENCE”, and subsequently post-dated by 6 Months to May 6, 2018. The content of the Provisional Patent Application is incorporated in its entirety by reference herein.

### BACKGROUND

### Technical Field

The system and the computer-implemented method disclosed herein, in general, relate to analyzing ideas. More particularly, the system and the computer-implemented method disclosed herein relate to quantitatively analyzing an idea. For example, a business idea of an individual or an organization, and generating decision-based contextual recommendations on the idea.

### Description of the Related Art

Developments in modern communication systems have resulted in an age of information. The process of accessing information from multiple different sources and sharing the information is now more possible. Data sources typically store a substantial amount of information related to various topics. The Internet has revolutionized the way information is shared, searched, indexed, and collected. Quality and quantity of information accessible to a decision maker substantially impact decision-making processes in an organization. It is often difficult for a decision maker to identify relevant information to be processed for arriving at particular decisions. The growing volumes and types of data are typically loo large or complex to be processed with conventional data processing application software, thereby making it difficult to identify relevant data to be processed to obtain valuable insights for making decisions. Conventional data management systems typically process and store data only; however, there is a need for a system and a method for providing qualitative results based on a quantitative analysis of the data. The complexity of decision-making increases when the decisions affect an organization. Most organizations focus on building strong relationships within and external to the organization to make optimal decisions. The expansive availability of information over the internet can overwhelm a decision maker who attempts to locate a relevant piece of information, for example, about an organization, a domain, a technology, teams within the organization, competition, the market, geography, etc., to make a decision. There is a need for enhancing a decision maker's ability to acquire, process and use information to make decisions for the organization, among competition, in a particular technology and domain, and in a rapidly changing marketplace.

Organizational intelligence refers to a combination of knowledge, skills, and resources within and outside an organization that aids in identification, selection, organization, and sharing of information for dynamic decision-making. For example, organizational intelligence is an extension of ideas collectively generated and shared among users associated with an organization. There is a growing use of organizational intelligence for making optimal decisions in industry. Decisions are typically made based on a generation of ideas in an organization. In addition to decisions being made by persons who convert the ideas into actions, stakeholders in the organization are also involved in making some of the decisions. Organizations, for example, startups, are typically initiated by individual founders or entrepreneurs to search for, develop, and validate a repeatable and scalable business model. Needs of an organization and in turn ideas to meet those needs typically change with context, for example, geography, department, technology, domain, location, etc. Growing competition with other organizations, the development of information technology, and changes in demography in the workplace and clientele has resulted in a rapid and unpredictable change in the organizational environment.

People with ideas related to an organization, for example, a startup, typically conduct research on their ideas using an internet search engine which would generate a large volume of information which may be unrelated and not useful. An analyst typically performs manual research about an idea, its domain, its technology, investors, entrepreneurs, funding, etc. The analyst may spend numerous days and resources browsing through links, artifacts, websites, etc., and may not know how to interpret the large volumes of information and arrive at a decision about an idea. The assessment of an idea related to an organization, for example, a startup, and the capability of the organization to execute the idea is typically a complex and expensive process that leads to a substantial use of resources. Efforts made by decision makers are typically ineffectual due to competition and a misalignment of key team members that are needed to value early stage technology-based ideas, fund organizations, execute the ideas, etc. Typically, information, for example, the number of deals executed in a specific space, domain, or technology, interest shown by other entrepreneurs and investors in the same space, competition in a particular geography and globally, market elements, social communication about an idea or a technology, funding data, an optimal team for the organization, technology and domain skills of team members, challenges the organization will face against entrenched players, etc., is needed to arrive at a decision about an idea associated with an early stage venture. Decision makers therefore need automated assistance in analyzing an idea that affects an organization, determining the capability of the organization to execute the idea, determining the likelihood of future outcomes resulting from an idea or a decision based on historical, internal and global data, determining growth prospect of the organization based on the idea, determining recommended organizations that implement the same ideas and alternative ideas in alternative domains, and obtaining recommendations and suggestions on decisions and actions to be taken for the organization.

Hence, there is a long-felt need for a system and a computer-implemented method for quantitatively analyzing an idea, for example, a business idea of an individual or an organization, and generating decision-based contextual recommendations on the idea.

### OBJECTS

An object of the system and the computer-implemented method disclosed herein is to quantitatively analyze an idea, for example, a business idea of an individual or an organization, and generate decision-based contextual recommendations on the idea.

Another object of the system and the computer-implemented method disclosed herein is to provide an integrated platform for analyzing ideas related to an organization.

Another object of the system and the computer-implemented method disclosed herein is to generate keywords related to an idea input received from a user device, in communication with a keyword database, and render the generated keywords on a graphical user interface displayed on the user device.

Another object of the system and the computer-implemented method disclosed herein is to extract context from the received idea input and selectively extract data sets associated with the extracted context of the received idea input, from one or more internal data sources and external data sources.

Another object of the system and the computer-implemented method disclosed herein is to compute multiple measurement indices related to an idea defined in the received idea input by performing a quantitative analysis of the selectively extracted data sets with reference to configurable thresholds and/or based on predetermined criteria, where the measurement indices comprise, for example, a market buzz index, a competition index, an investor interest index, an entrepreneur interest index, a domain skill index, a technology skill index, a commitment index, a funding risk index, and a geography risk index.

Another object of the system and the computer-implemented method disclosed herein is to compute an execution risk index that determines capability of execution of the idea, for example, by an individual or an organization, using the user-defined parameters, in communication with one or more of the internal data sources and external data sources.

Another object of the system and the computer-implemented method disclosed herein is to generate a weighted importance matrix and a weighted execution matrix for generating a recommendation score.

Another object of the system and the computer-implemented method disclosed herein is to generate a recommendation score based on the computed measurement indices and the computed execution risk index.

Another object of the system and the computer-implemented method disclosed herein is to generate decision-based contextual recommendations for arriving at one or more decisions related to the idea based on the generated recommendation score.

Another object of the system and the computer-implemented method disclosed herein is to render the generated recommendations and other relevant information on the idea on a graphical user interface displayed on the user device.

Another object of the system and the computer-implemented method disclosed herein is to generate an analytics report comprising a graphical visualization of a description of the idea received from the user device, a description of the quantitative analysts of the received idea input, the generated recommendation score, and the generated decision-based contextual recommendations related to the idea.

Another object of the system and the computer-implemented method disclosed herein is to perform an analysis of a team associated with the organization using the commitment index and at least one of the computed measurement indices comprising, for example, the domain skill index and the technology skill index.

Another object of the system and the computer-implemented method disclosed herein is to compute the commitment index that measures commitment of a team to execute the idea, using user information associated with a user of the user device, member information of team members linked to the user, and information of an organization of the user and the team members.

Another object of the system and the computer-implemented method disclosed herein is to generate and render automated and contextual recommendations and suggestions to multiple users based on an automated analysis of the received idea input.

The objects disclosed above will be realized and achieved at least by the elements, features, and combinations particularly pointed out in the claims. The objects disclosed above have outlined, rather broadly, the features of the system and the computer-implemented method disclosed herein in order that the detailed description that follows may be better understood. The objects disclosed above are not intended to determine the scope of the claimed subject matter and are not to be construed as limiting of the system and the computer-implemented method disclosed herein. Additional objects, features, and advantages of the system and the computer-implemented method disclosed herein are disclosed below. The objects disclosed above, which are believed to be characteristic of the system and the computer-implemented method disclosed herein, both as to its organization and method of operation, together with further objects, features, and advantages, will be better understood and illustrated by the technical features broadly embodied and described in the following description when considered in connection with the accompanying figures.

### SUMMARY

This summary is provided to introduce a selection of concepts in a simplified form that are further disclosed in the detailed description. This summary is not intended to determine the scope of the claimed subject matter.

A system and a computer-implemented method are provided for quantitatively analyzing an idea, for example, a business idea of an individual or an organization, and generating decision-based contextual recommendations on the idea. The system disclosed herein comprises an idea communication module, a context extraction module, a data extraction module, an idea analytics engine, and a decision-based recommendation engine. The idea communication module receives an idea input and user-defined parameters from a user device.

The user-defined parameters comprise, for example, a stage related to the idea such as a startup stage, a funding stage, etc. In an embodiment, the idea communication module receives supplementary search criteria comprising, for example, location associated with the idea input or the organization for analyzing the idea input. In an embodiment, the system disclosed herein further comprises a keyword recommendation module for generating keywords related to the received idea input, in communication with a keyword database, and rendering the generated keywords on a graphical user interface displayed on the user device.

The context extraction module extracts context from the received idea input, for example, domain and technology related to the idea. The data extraction module selectively extracts data sets associated with the extracted context of the received idea input, from at least one of multiple internal data sources and external data sources. The data sets comprise data related to, for example, one of organizational intelligence information, profile information, work history, technology expertise, technical experience, domain experience, efficiency of each team member of an organization, deficiency of each team member of me organization, performance indicators that indicate performance of the organization, professional network data, social media data, search engine data, media content, market data, research data, company data, founding data, funding data, entrepreneurial data, technology data, domain data, geographical data, revenue data, etc., and any combination thereof. The professional network data used for computation of measurement indices comprises, for example, industry, technology skills, location, profile summary, years of experience, designation, company industry, company type, company size, company location, joining date, previous company details, previous industries, skills, etc. The internal data sources and the external data sources comprise, for example, global databases of existing ideas and organizational intelligence, cloud databases, partner databases, research databases, publication databases, web sources, a database of organizations that stores information about organizations related to ideas, an internal database of ideas and organizational intelligence, a related information database, a keyword database, search engine databases, professional network databases, social media databases, etc.

The idea analytics engine computes multiple measurement indices related to an idea defined in the received idea input by performing a quantitative analysis of the selectively extracted data sets with reference to configurable thresholds and/or based on predetermined criteria. The measurement indices comprise, for example, a market buzz index, a competition index, an investor interest index, an entrepreneur interest index, a domain skill index, a technology skill index, a commitment index, a funding risk index, and a geography risk index. The commitment index measures commitment of a team to execute the idea. The idea analytics engine computes the commitment index using user information associated with the user of the user device, member information of team members linked to the user, and information of an organization of the user and the team members. In an embodiment, the idea analytics engine performs an analysis of a team associated with the organization using the commitment index and al least one of the computed measurement indices comprising, for example, the domain skill index and the technology skill index.

The idea analytics engine computes an execution risk index that determines capability of execution of the idea, for example, by an individual or an organization using the user-defined parameters, in communication with one or more of the internal data sources and the external data sources. The decision-based recommendation engine generates a recommendation score based on the computed measurement indices and the computed execution risk index. The decision-based recommendation engine generates decision-based contextual recommendations for arriving at one or more decisions related to the received idea input for the organization based on the generated recommendation score. The decision-based recommendation engine renders the generated decision-based contextual recommendations on a graphical user interface displayed on the user device.

In an embodiment, the system disclosed herein further comprises a report generation module for generating an analytics report comprising a graphical visualization of a description of the idea received from the user device, a description of the quantitative analysis of the received idea input, the generated recommendation score, and the generated decision-based contextual recommendations related to the idea. The generated decision-based contextual recommendations comprise, for example, competition information, learn commitment information, suggested actions, trends associated with the idea, and content related lo the idea such as patent information, research paper information, news, media content, entrepreneurial venture information related to the idea, etc. In an embodiment, the report generation module renders the generated decision-based contextual recommendations and the generated analytics report on a graphical user interface displayed on the user device. In an embodiment, the system disclosed herein further comprises one or more schedulers for tracking organizations locally and globally, and periodically updating multiple internal data sources, in communication with one or more of the external data sources.

In one or more embodiments, related systems comprise circuitry and/or programming for effecting the methods disclosed herein. The circuitry and/or programming can be any combination of hardware, software, and/or firmware configured to effect the methods disclosed herein depending upon the design choices of a system designer. Also, in an embodiment, various structural elements may be employed depending on the design choices of the system designer.

### BRIEF DESCRIPTION OF THE DRAWINGS

The foregoing summary, as well as the following detailed description, is better understood when read in conjunction with the appended drawings. For illustrating the system and the computer-implemented method disclosed herein, exemplary constructions of the system and the computer-implemented method are shown in the drawings. However, the system and the computer-implemented method disclosed herein are not limited to the specific components and methods disclosed herein. The description of a component or a method step referenced by a numeral in a drawing is applicable to the description of that component or method step shown by that same numeral in any subsequent drawing herein.

FIG. 1 exemplarily illustrates a system for quantitatively analyzing an idea and generating decision-based contextual recommendations on the idea.

FIG. 2 illustrates a computer-implemented method for quantitatively analyzing an idea and generating decision-based contextual recommendations on the idea.

FIGS. 3-5 exemplarily illustrate flow diagrams comprising the steps performed by an idea analytics engine of the system for computing a market buzz index related to an idea.

FIGS. 6-7 exemplarily illustrate flow diagrams comprising the steps performed by the idea analytics engine for computing a competition index related to an idea.

FIGS. 8-9 exemplarily illustrate flow diagrams comprising the steps performed by the idea analytics engine for computing an investor interest index related to an idea.

FIGS. 10-11 exemplarily illustrate flow diagrams comprising the steps performed by the idea analytics engine for computing an entrepreneur interest index related to an idea.

FIGS. 12-13 exemplarily illustrate flow diagrams comprising the steps performed by the idea analytics engine for computing a funding risk index related to an idea.

FIGS. 14-15 exemplarily illustrate flow diagrams comprising the steps performed by the idea analytics engine for computing a geography risk index related to an idea.

FIGS. 16-17 exemplarily illustrate flow diagrams comprising the steps performed by the idea analytics engine for computing a commitment index related to an idea.

FIGS. 18-19 exemplarily illustrate flow diagrams comprising the steps performed by the idea analytics engine for computing a domain skill index related to an idea.

FIGS. 20-21 exemplarily illustrate flow diagrams comprising the steps performed by the idea analytics engine for computing a technology skill index related to an idea.

FIG. 22A exemplarily illustrates a flow diagram comprising the steps performed by the system for generating a recommendation score.

FIG. 22B exemplarily illustrates a flow diagram comprising the steps performed by the system for generating a weighted importance matrix to compute an execution risk index.

FIG. 22C exemplarily illustrates a table showing an importance classification of multiple measurement indices related to an idea.

FIG. 22D exemplarily illustrates a table showing a weighted execution matrix used for computing the execution risk index.

FIGS. 22E-22F exemplarily illustrate tables showing assignment of weightages for generating the recommendation score using the execution risk index.

FIG. 23 exemplarily illustrates a flow diagram comprising the steps performed by the idea analytics engine for generating the weighted execution matrix to compute the execution risk index.

FIGS. 24A-24B exemplarily illustrate a flow diagram showing an example of quantitatively analyzing an idea and generating a recommendation score.

FIG. 25 exemplarily illustrates an architectural diagram showing an implementation of the modules of the system, in a computer system, for quantitatively analyzing an idea and generating decision-based contextual recommendations on the idea.

FIGS. 26A-26J exemplarily illustrate screenshots of a graphical user interface provided by the system for quantitatively analyzing an idea and generating decision-based contextual recommendations on the idea.

FIGS. 27A-27B exemplarily illustrate screenshots of a graphical user interface provided by the system, showing exemplary representations of the measurement indices related to an idea, computed by the idea analytics engine.

FIG. 28 exemplarily illustrates a screenshot of a graphical user interface provided by the system, showing an exemplary representation of a comparative market analysis related to ideas, performed by the system.

FIG. 29 exemplarily illustrates a screenshot of a graphical user interface provided by the system for receiving information of an idea for quantitatively analyzing the idea and generating decision-based contextual recommendations on the idea.

FIGS. 30A-30I exemplarily illustrate screenshots of a graphical user interface provided by the system for quantitatively analyzing an idea and generating decision-based contextual recommendations on the idea.

### DETAILED DESCRIPTION OF THE INVENTION

Various aspects of the present disclosure may be embodied as a system, a method, or a non-transitory computer readable storage medium having one or more computer readable program codes stored thereon. Accordingly, various embodiments of the present disclosure may take the form of an entirely hardware embodiment, an entirely software embodiment comprising, for example, microcode, firmware, software, etc., or an embodiment combining software and hardware aspects that may be referred to herein as a “system, a “module”, an “engine”, a “circuit”, or a “unit”.

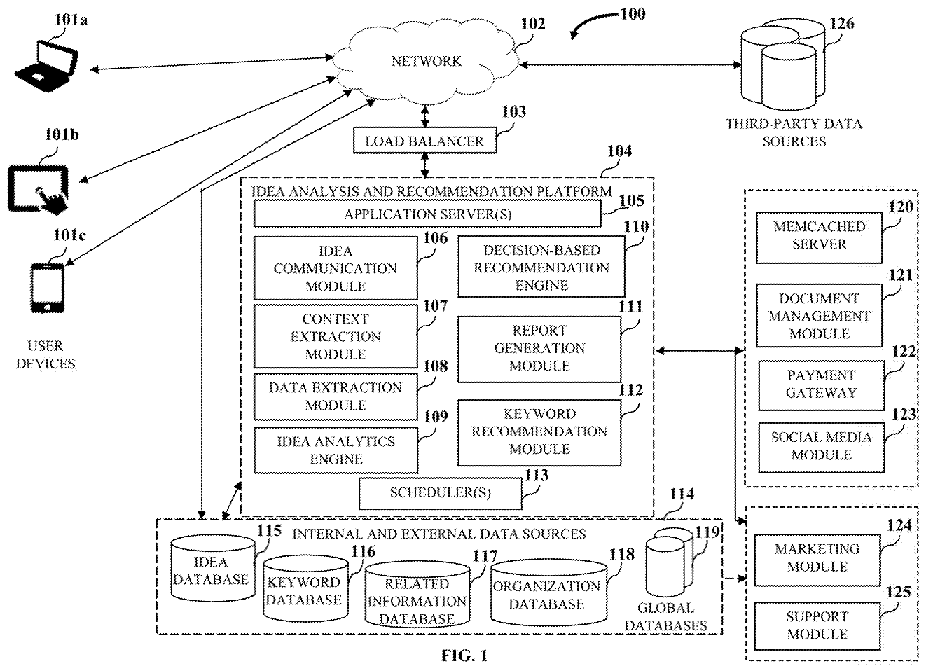

FIG. 1 exemplarily illustrates a system 100 for quantitatively analyzing an idea, for example, a business idea of an individual or an organization, and generating decision-based contextual recommendations on the idea. In an embodiment, the system 100 disclosed herein quantitatively analyzes ideas related to technology based on which an organization can start a business or can execute the ideas in an organizational environment. The organization is, for example, a startup, a company, an educational institution, a medical institution, etc. In an embodiment, the system 100 disclosed herein comprises an idea analysis and recommendation platform (IARP) 104 accessible to multiple user devices, for example, laptops 101a, tablet computing devices 101b, smartphones 101c, personal computers, mobile computers, mobile phones, personal digital assistants, workstations, client devices, network-enabled computing devices, interactive network-enabled communication devices, gaming devices, image capture devices, web browsers, any other suitable computing equipment, etc., through a broad spectrum of devices and technologies via a network 102.

The network 102 is, for example, one of the internet, an intranet, a wired network, a wireless network, a communication network that implements Bluetooth® of Bluetooth Sig, Inc., a network that implements Wi-Fi® of Wi-Fi Alliance Corporation, an ultra-wideband communication network (UWB), a wireless universal serial bus (USB) communication network, a communication network that implements ZigBee® of ZigBee Alliance Corporation, a general packet radio service (GPRS) network, a mobile telecommunication network such as a global system for mobile (GSM) communications network, a code division multiple access (CDMA) network, a third generation (3G) mobile communication network, a fourth generation (4G) mobile communication network, a fifth generation (5G) mobile communication network, a long-term evolution (LTE) mobile communication network, a public telephone network, etc., a local area network, a wide area network, an internet connection network, an infrared communication network, etc., or a network formed from any combination of these networks.

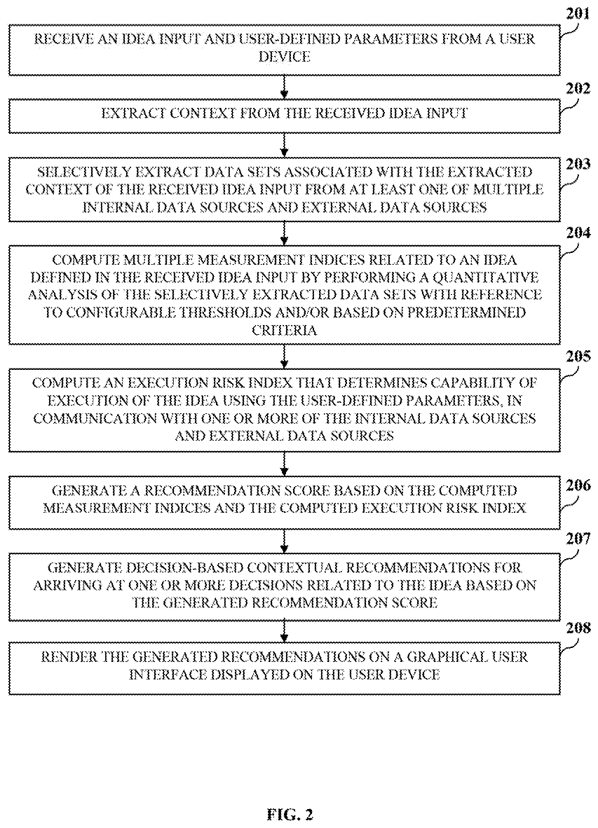

The IARP 104 comprises an idea communication module 106, a context extraction module 107, a data extraction module 108, an idea analytics engine 109, a decision-based recommendation engine 110, and in an embodiment, a report generation module 111, a keyword recommendation module 112, and one or more schedulers 113, the functions of which are disclosed in the detailed description of FIG. 2. In an embodiment, the modules, for example. 106, 107, 108, 109, 110, 111, 112, 113, etc, of the IARP 104 are hosted on one or more application servers 105. The application servers 105 are, for example, Apache Tomcat® servers of the Apache Software foundation that provide a Java hypertext transfer protocol (HTTP) web server environment for executing Java code. In an embodiment, the application servers 105 implement the Java platform, Enterprise Edition (EE) specifications comprising, for example, Java Servlet, JavaServer Pages (JSP), JSP Expression Language (EL), and WebSocket. In another embodiment, the application server 105 executes the Apache HTTP server program, httpd, to execute the modules, for example, 106, 107, 108, 109, 110, 111, 112, 113, etc., of the IARP 104 for quantitatively analyzing an idea and generating decision-based contextual recommendations on the idea. In another embodiment, the application servers 105 are, for example, JBoss® Enterprise servers of Red Hat, Inc. In an embodiment, the IARP 104 deploys additional application servers 105 based on user load, that is, the load created due to multiple users and/or components accessing the IARP 104 concurrently. In an embodiment where there is more than one application server 105, the system 100 disclosed herein comprises a load balancer 103 for distributing and balancing the workload on the IARP 104 among the application servers 105.

In an embodiment, the system 100 disclosed herein is implemented in a cloud computing environment. As used herein, “cloud computing environment” refers to a processing environment comprising configurable computing physical and logical resources, for example, networks, servers, storage media, virtual machines, applications, services, etc., and data distributed over the network 102. The cloud computing environment provides on-demand network access to a shared pool of the configurable computing physical and logical resources. In an embodiment, the IARP 104 that deploys the modules, for example, 106, 107, 108, 109, 110, 111, 112, 113, 120, 121, 122, 123, 124, 125, etc., of the system 100 disclosed herein is a cloud computing-based platform implemented as a service for quantitatively analyzing an idea and generating decision-based contextual recommendations on the idea.

The IARP 104 communicates with multiple internal and external data sources 114, and third-party data sources 126 via the network 102. In an embodiment, the IARP 104 is in direct communication with the internal and external data sources 114. In an embodiment, the internal and external data sources 114 comprise an idea database 115, a keyword database 116, a related information database 117, an organization database 118, global databases 119, etc. The idea database 115 stores ideas received from multiple user devices, for example, 101a, 101b, and 101c, via the network 102. The keyword database 116 stores multiple keywords related to each of the ideas. The related information database 117 stores different types of information, for example, organizational intelligence information, related to each of the stored ideas. In an embodiment, the related information database 117 stores, for example, patents or patent applications, research papers, news items, videos, textual presentations, entrepreneurial ventures, etc., that are related to the idea entered by the user. The organization database 118 stores lists of organizations that implement similar ideas and alternative ideas.

In an embodiment, the idea database 115, the keyword database 116, the related information database 117, and the organization database 118 constitute the internal data sources of the system 100. As used herein, the term “database” refers to any storage area or medium that can be used for storing data and files. The idea database 115, the keyword database 116, the related information database 117, and the organization database 118 can be, for example, any of a structured query language (SQL) data store or a not only SQL (NoSQL) data store such as the Microsoft® SQL Server®, the Oracle® servers, the MySQL® database of MySQL AB Limited Company, the mongoDB® of MongoDB, Inc., the Neo4j graph database of Neo Technology Corporation, the Cassandra database of the Apache Software Foundation, the HBase database of the Apache Software Foundation, etc. In another embodiment, the idea database 115, the keyword database 116, the related information database 117, and the organization database 118 can also be locations on file systems. In an embodiment, the global databases 119 are external data sources that store business intelligence information lo provide business leads, organization information, insights on technological advances and innovations that organizations are using, etc., to businesses and organizations globally. In another embodiment, the idea database 115, the keyword database 116, the related information database 117, the organization database 118, and the global databases 119 can also be configured as cloud-based databases implemented in a cloud computing environment, where computing resources are delivered as a service over the network 102. In an embodiment, the internal and external data sources 114 comprise databases that store global and geography-specific macro and microeconomic parameters.

In an embodiment, the system 100 disclosed herein further comprises a Memcached server 120, a document management module 121, a payment gateway 122, and a social media module 123. The Memcached server 120 is a distributed memory caching system that speeds up the dynamic database-driven IARP 104 by caching data and objects in a random-access memory (RAM) to reduce the number of times the external data sources, the third-party data sources 126, and application programming interfaces (APIs) must be read. The document management module 121 processes, manages, stores, and allows retrieval of documents related to ideas received from the user devices, for example, 101a, 101b, and 101c, via the network 102. The payment gateway 122 facilitates payment transactions initiated by users on the IARP 104. The IARP 104, in communication with the social media module 123, facilitates API integration with social media networks and professional networks to perform the quantitative analysis of an idea and the generation of decision-based contextual recommendations on the idea. The social media module 123 connects the IARP 104 to social media accounts of users registered with the IARP 104.

In another embodiment, the system 100 disclosed herein further comprises a marketing module 124 and a support module 125. The IARP 104, in communication with the marketing module 124, performs a market analysis of the idea related to an organization. The marketing module 124 accesses the internal and external data sources 114 for facilitating the market analysis. The support module 125 executes support functions during extraction of data from the internal and external data sources 114. The support module 125 also executes support functions during communications between the IARP 104 and the Memcached server 120, the document management module 121, the payment gateway 122, and the social media module 123.

In the system 100 disclosed herein, the IARP 104 interfaces with the load balancer 103, the Memcached server 120 and other modules, for example, 121, 122, 123, 124, and 125 implemented on one or more computer systems, the internal and external data sources 114, the third-party data sources 126, and the user devices, for example, 101a, 101b, and 101c, to quantitatively analyze an idea and generate decision-based contextual recommendations on the idea, and therefore more than one specifically programmed computing system is used for quantitatively analyzing the idea and generating decision-based contextual recommendations on the idea.

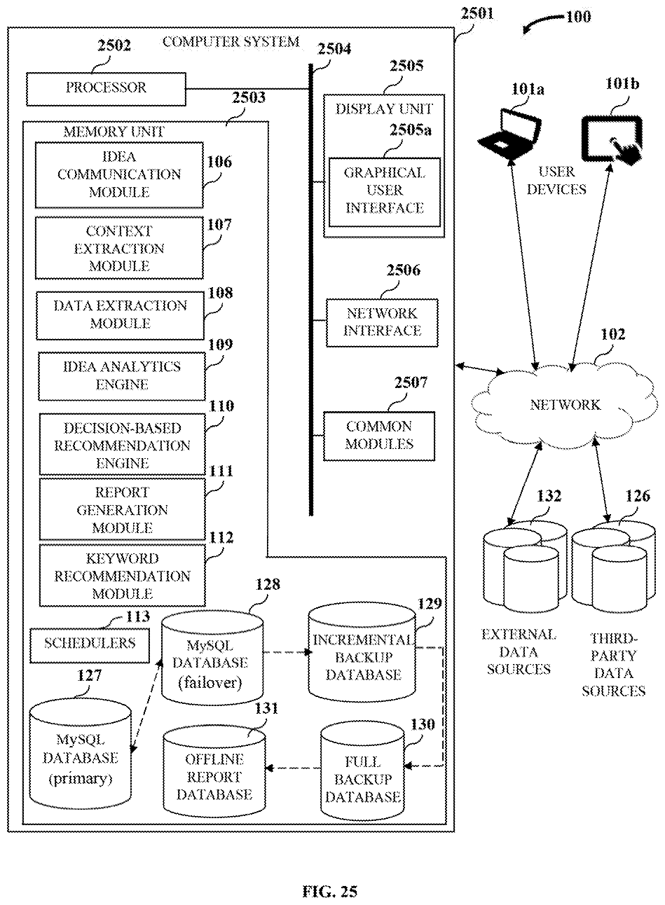

FIG. 2 illustrates a computer-implemented method for quantitatively analyzing an idea and generating decision-based contextual recommendations on the idea. In the computer-implemented method disclosed herein, the idea analysis and recommendation platform (IARP) 104 shown in FIG. 1, renders a graphical user interface (GUI) 2505a shown in FIG. 25, on a user device, for example, 101a, 101b, or 101c shown in FIG. 1, to allow a user to enter an idea, for example, a business idea of an individual or an organization such as a startup, for a quantitative analysis. The idea communication module 106 shown in FIG. 1, receives 201 the idea input and user-defined parameters entered by the user, from the user device 101a, 101b, or 101c. The idea input is of one or more media types comprising, for example, text, audio, video, multimedia, etc., and any combination thereof. The user-defined parameters comprise a stage related to the idea or an organization. For example, the user-defined parameters comprise a startup stage such as an “idea only” stage, a product development stage, a minimum viable product (MVP) ready stage, a customer deployment stage, etc.; a funding stage such as bootstrapped, seed, bridge, series A+, etc. In an embodiment, the idea communication module 106 receives supplementary search criteria comprising a location, for example, a country, associated with the idea and/or the organization, for the quantitative analysis of the idea input. In another embodiment, the keyword recommendation module 112 shown in FIG. 1, generates keywords related to the received idea input, in communication with the keyword database 116 shown in FIG. 1, and renders the generated keywords on the GUI 2505a displayed on the user device 101a, 101b, or 101c. In another embodiment, one or more schedulers 113 shown in FIG. 1, periodically update the keyword database 116 with keywords received from multiple user devices, for example, 101a, 101b, and 101c, and from multiple external data sources.

The idea input, user-defined parameters, and other data entered by the user via the GUI 2505a are transformed, processed and executed by multiple algorithms in the idea analysis and recommendation platform (IARP) 104 shown in FIG. 1, for the quantitative analysis of the idea and generation of decision-based contextual recommendations on the idea as disclosed below. On receiving the idea input and the user-defined parameters, the context extraction module 107 shown in FIG. 1, extracts 202 context from the idea input. The context extraction module 107 is a natural language processing (NLP) engine that interprets the meaning of the idea input in a natural language and extracts the context, for example, idea, technology, domain, country, etc., from the idea input. For example, if a user enters an idea input, “I want to build a virtual reality platform for retailers in India”, the idea communication module 106 receives and transmits the idea input to the context extraction module 107. The context extraction module 107 extracts the context, for example, idea as “virtual reality platform”, the technology as “virtual reality”, the domain as “retail”, and the country as “India” from the received idea input.

The data extraction module 108 shown in FIG. 1, selectively extracts 203 data sets associated with the extracted context of the received idea input, from at least one of multiple internal data sources and external data sources. The internal data sources and the external data sources comprise, for example, global databases 119 of existing ideas and organizational intelligence shown in FIG. 1, cloud databases, partner databases, research databases, publication databases, web sources, a database 118 of organizations that stores information about organizations related to ideas, an internal database 115 of ideas and organizational intelligence, the related information database 117, the keyword database 116, search engine databases, professional network databases, social media databases, etc., as exemplarily illustrated in FIG. 1. The data sets comprise data related to, for example, one of organizational intelligence information, profile information, work history, technology expertise, technical experience, domain experience, efficiency of each team member of the organization, deficiency of each team member of the organization, performance indicators that indicate performance of the organization, professional network data, social media data, search engine data, media content such as videos, market data, research data, company data, founding data, funding data, entrepreneurial data, technology data, domain data, geographical data, revenue data, etc., and any combination thereof.

In an embodiment, one or more schedulers 113 track organizations locally and globally, and periodically update the internal data sources, in communication with one or more of the external data sources. The schedulers 113 are run at preconfigured times to update data of multiple organizations stored in the system 100 shown in FIG. 1, and to add data of new organizations. The data extraction module 108, in communication with the schedulers 113, crawl through numerous websites to identify new information about each organization tracked. The data extraction module 108, in communication with the schedulers 113, searches for content comprising, for example, funding announcements, news, customer acquisition related information, etc., and adds these data sets into the internal database, which is then used to compute measurement indices, an execution risk index, and a recommendation score, and display relevant content on the GUI 2505a when users enter an idea input for analysis on the GUI 2505a. In an embodiment, one or more schedulers 113 are configured to receive information from the idea analytics engine 109 shown in FIG. 1, and contextually identity the information to be shared with each of multiple user devices, for example, 101a, 101b, and 101c, or end-point devices connected to the IARP 104 via the network 102. One or more of the schedulers 113 are configured with preset rules to control, for example, resume or terminate communication with the user devices, for example, 101a, 101b, and 101c.

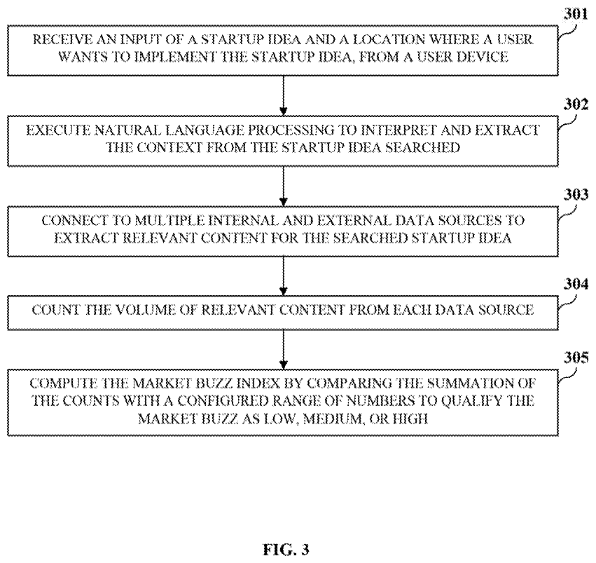

The idea analytics engine 109 is a calculation engine that performs multiple analytical calculations in the IARP 104. The idea analytics engine 109 computes 204 multiple measurement indices related to the idea defined in the received idea input locally and globally by performing a quantitative analysis of the selectively extracted data sets with reference to configurable thresholds and/or based on predetermined criteria as disclosed in the detailed descriptions of FIGS. 3-21. In various embodiments, different weighting methods can be used in the computation of the measurement indices. In an embodiment, the idea analytics engine 109 assigns a weightage, for example, 1, or 2, or 3, to each of the measurement indices, and represents the weightage using a label, for example, “low” for a weightage of 1, “medium” for a weightage of 2, and “high” for a weightage of 3. The measurement indices comprise, for example, a market buzz index, a competition index, an investor interest index, an entrepreneur interest index, a domain skill index, a technology skill index, a commitment index, a funding risk index, and a geography risk index.

As used herein, “market buzz index” refers to a measure that indicates communication, for example, social communications, professional discussions in academic research papers, etc., related to the idea in a configurable period of time, for example, the last 12 months. Also, as used herein, “competition index” refers to a measure that indicates competition related to the idea from other entrepreneurs or similar organizations that execute similar ideas. Also, as used herein, “investor interest index” refers to a measure of the interest shown by investors based on the number of deals executed in a configurable period of time, for example, the last 12 months, in a particular space that would be of interest to an early stage venture. Also, as used herein, “entrepreneur interest index” refers to a measure of the interest shown by other entrepreneurs in a particular space in a configurable period of time, for example, the last 24 months.

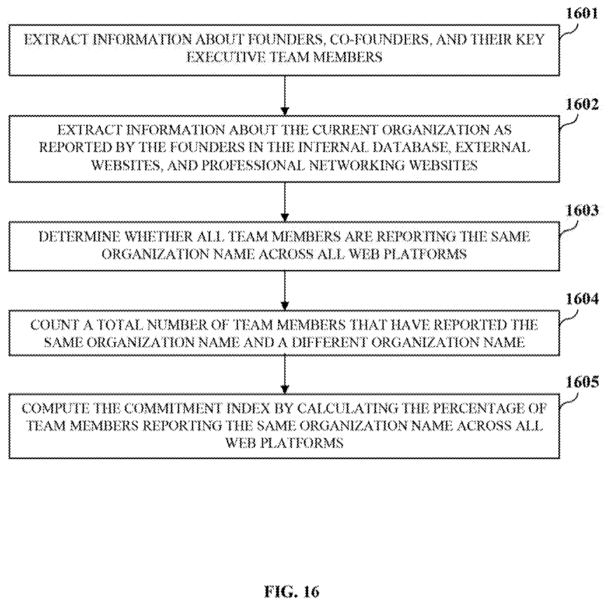

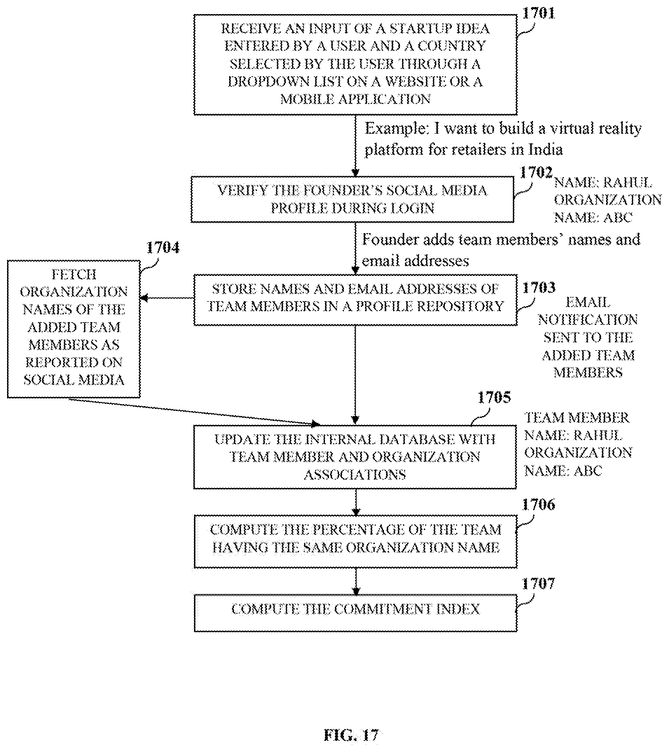

Also, as used herein, “domain skill index” refers to a measure that indicates domain experience and domain skills of members of a team to optimally execute an idea. Also, as used herein, “technology skill index” refers to a measure that indicates technology skills and experience of members of a team in a particular technology to optimally execute an idea. Also, as used herein, “funding risk index” refers to a measure that indicates the risk associated with an impact on an idea's funding from higher funding costs or a lack of availability of funds based on funding data and valuation data of similar organizations. Also, as used herein, “geography risk index” refers to a measure that indicates the risk associated with an impact of executing an idea in a particular geography based on revenue data, funding data, and operating status of similar organizations. Also, as used herein, “commitment index” refers to a measure that indicates a combination of skills, for example, domain skills, technology skills, sales skills, etc., of members of a team to optimally execute an idea. The commitment index measures commitment of a team lo execute the idea. The idea analytics engine 109 computes the commitment index using user information associated with a user of the user device, for example, 101a, 101b, or 101c, member information of team members linked to the user, and information of an organization of the user and the team members as disclosed in the detailed descriptions of FIGS. 16-17. The idea analytics engine 109 performs an analysis of a team associated with the organization using the commitment index and at least one of the computed measurement indices, for example, the domain skill index and the technology skill index.

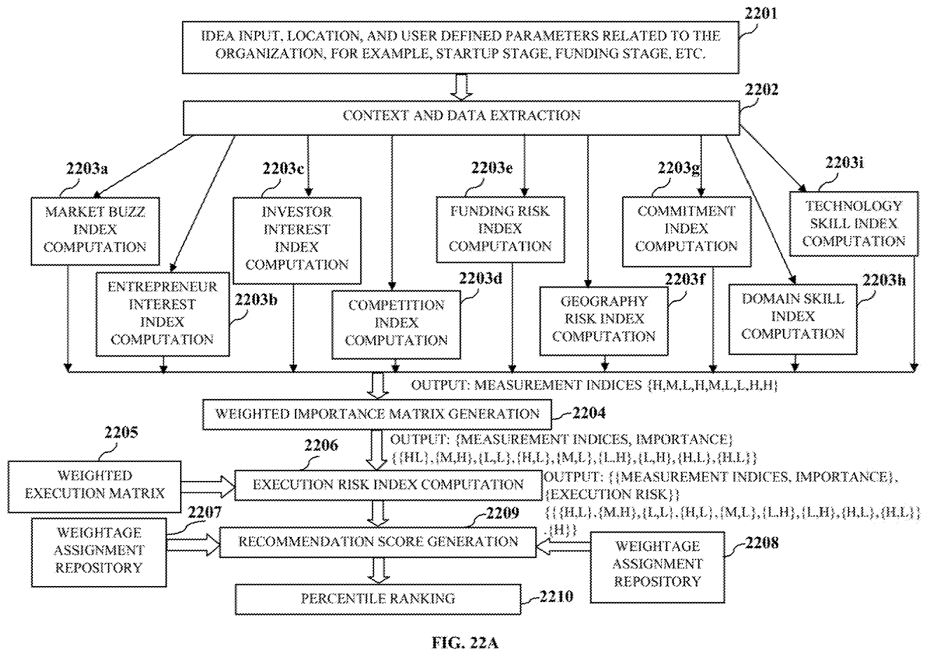

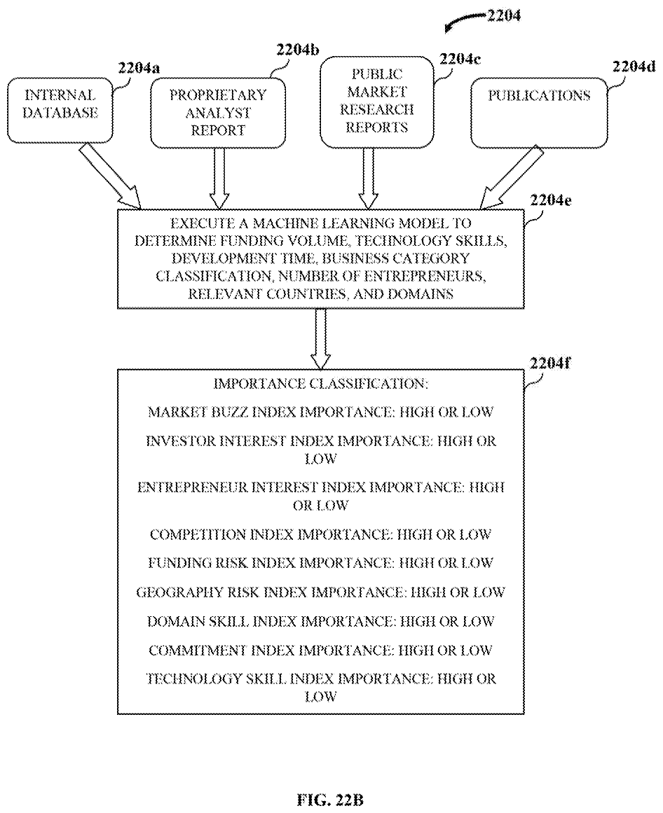

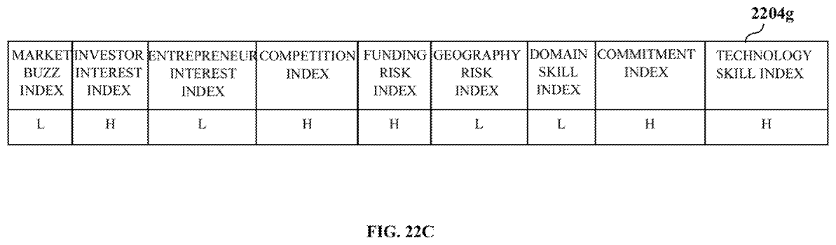

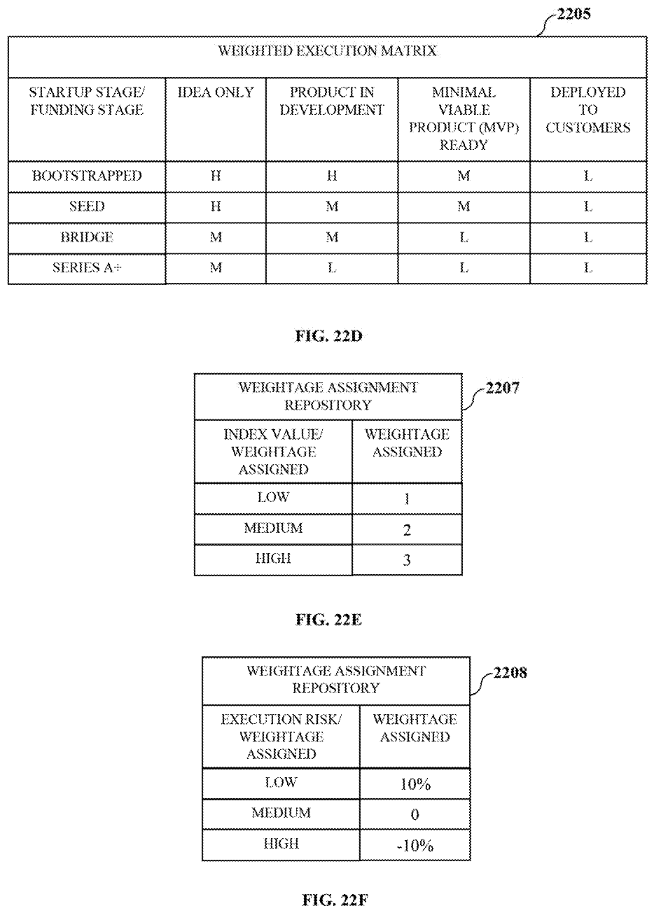

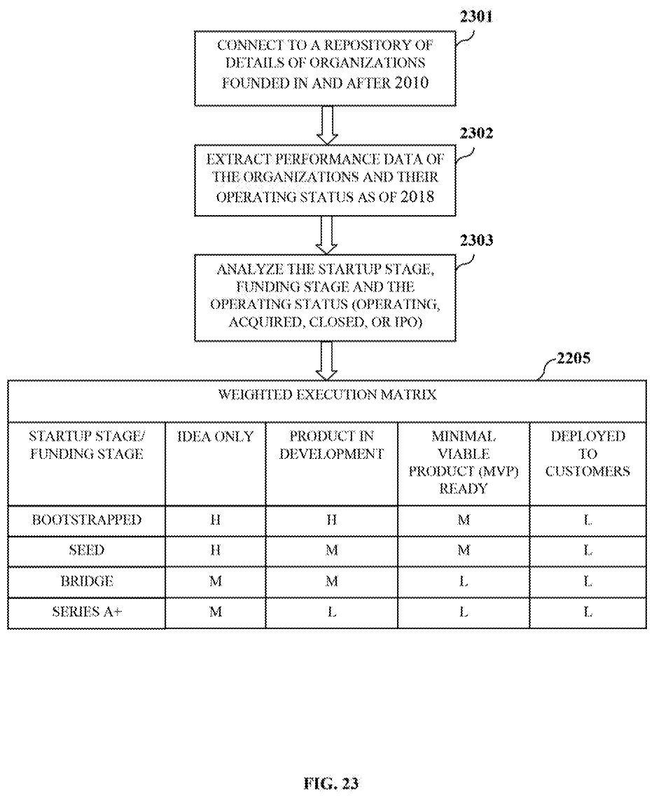

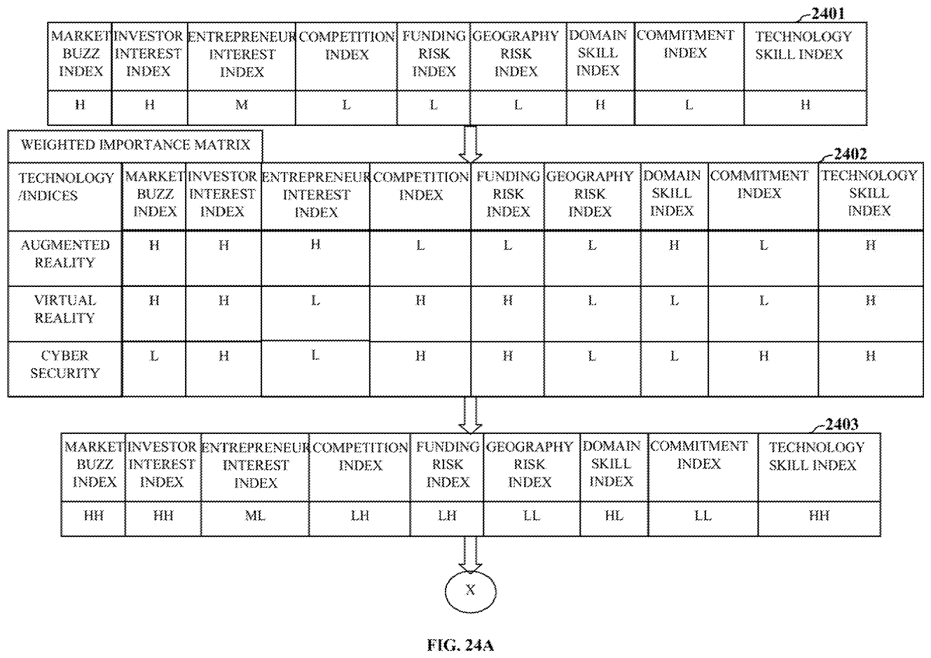

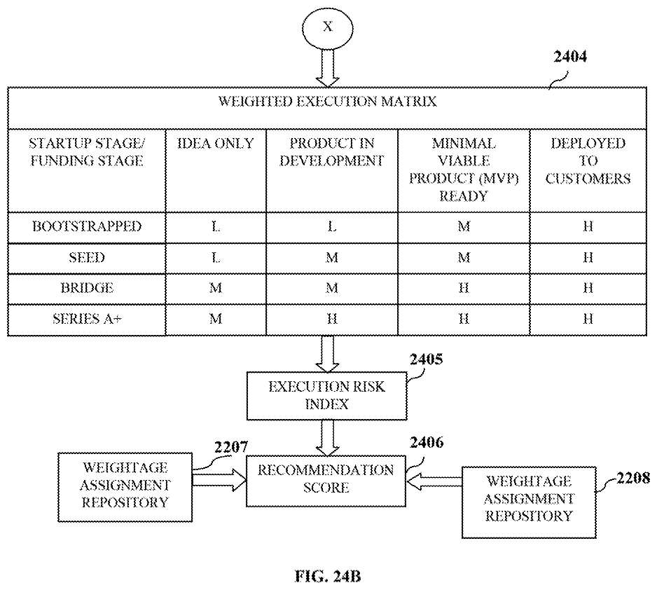

The idea analytics engine 109 computes 205 an execution risk index that determines capability of execution of the idea, for example, by an individual or an organization, using the user-defined parameters, in communication with one or more of the internal data sources and external data sources as disclosed in the detailed descriptions of FIGS. 22A-22F. The decision-based recommendation engine 110 shown in FIG. 1, generates a recommendation score 206 based on the computed execution risk index as disclosed in the detailed descriptions of FIGS. 22A-22F. In various embodiments, different weighting and scoring methods can be used in the generation of the recommendation score. The recommendation score is a measure that indicates a combination of multiple parameters comprising, for example, a space where an organization operates, skills of members of a team, geography risk, follow-on funding possibility, etc. A high recommendation score indicates a positive recommendation. In an embodiment, to generate the recommendation score, the idea analytics engine 109 supplements weightages assigned to the computed measurement indices based on a weighted importance matrix and computes the execution risk index based on a weighted execution matrix using the user-defined parameters. The decision-based recommendation engine 110 then generates the recommendation score by combining predetermined weightages assigned to the computed measurement indices with the supplemented weightages and a predetermined weightage assigned to the computed execution risk index as disclosed in the detailed description of FIGS. 22A-22F. FIG. 23, and FIGS. 24A-24B. The idea analytics engine 109 generates the weighted importance matrix as disclosed in the detailed descriptions of FIGS. 22B-22C, and the weighted execution matrix as disclosed in the detailed description of FIG. 23, by executing a machine learning model on selective data sets extracted from at least one of the internal data sources and the external data sources based on the extracted context of the received idea input and/or the user-defined parameters. The decision-based recommendation engine 110 generates 207 decision-based contextual recommendations for arriving at one or more decisions related to the idea based on the generated recommendation score. As used herein, “decision-based contextual recommendation” refers to a recommendation and/or a suggestion provided to a user about an idea based on the context and quantitative analysis of the idea, which allows the user to make or arrive at a decision related to the idea. The generated decision-based contextual recommendations for the organization comprise, for example, competition information, team commitment information, suggested actions, trends associated with the idea, and content related to the idea. The content comprises, for example, patent information, research paper information, news, media content, and entrepreneurial venture information related to the idea.

In an embodiment, the generated decision-based contextual recommendations also provide information, for example, on the likelihood of future outcomes resulting from an idea or a decision based on historical, internal and global data, growth prospect of the organization based on the idea, recommended organizations that implement the same ideas and alternative ideas in alternative domains, and suggestions on decisions and actions to be taken for the organization. The generated decision-based contextual recommendations further comprise, for example, projected contributions of team members to the organization, quality of their contribution, and a projected result of the organizational intelligence. The generated decision-based contextual recommendations also provide, for example, information on the domain, the technology, top spaces where to invest money, when to invest, how much to invest, stakes, investment assistance, the types of innovation, acquisition information, technology use, top startups rated by venture capitalists, risks, etc. The decision-based recommendation engine 110 accesses preconfigured websites to search for relevant content and identifies, for example, relevant patents, research papers, presentations, news, and videos related to the idea. The decision-based recommendation engine 110 ranks the search results, for example, using the context of the idea input and frequency of keywords used. The decision-based recommendation engine 110 displays, for example, the top ranked results to users via the GUI 2505a.

The decision-based recommendation engine 110 renders 208 the generated decision-based contextual recommendations on the GUI 2505a displayed on the user device 101a, 101b, or 101c. For example, if a startup idea is in a space crowded with too many other entrepreneurs, the decision-based recommendation engine 110 recommends a rethinking of the positioning of the startup against the other entrepreneurs and displays the generated recommendation on the GUI 2505a. In another example, although the entrepreneur interest index for an idea related to biodegradable plastic is “medium”, if the market buzz index, the investor interest index, and the competition index are “low”, the decision-based recommendation engine 110 generates a recommendation to rethink the idea related to biodegradable plastic in more detail and displays the generated recommendation on the GUI 2595a in another example, if the market buzz index, the investor interest index, the entrepreneur interest index, and the competition index are “high” for an idea related to artificial intelligence, the decision-based recommendation engine 110 generates a recommendation to proceed with the idea but to try a different approach due to the competition and displays the generated recommendation on the GUI 2505a. The decision-based recommendation engine 110 also displays content, for example, a list of organizations such as startups in the same industry space, patents, research papers, videos, presentations, news, etc., related to the idea on the GUI 2505a.

In an embodiment, the report generation module 111 shown in FIG. 1, performs automated report generation and generates an analytics report comprising, for example, a graphical visualization of a description of the idea received from the user device 101a, 101b, or 101c, a description of the quantitative analysis of the received idea input, the generated recommendation score, and the generated decision-based contextual recommendations related to the idea. In an embodiment, the report generation module 111 generates the analytics report is a portable document format (PDF). The report generation module 111 renders the generated analytics report on the GUI 2505a displayed on the user device 101a, 101b, or 101c. When the measurement indices, the execution risk, and the recommendation score are computed, the report generation module 111 identifies and ranks relevant content for display in the analytics report in a short time, for example, about 15 seconds to about 20 seconds. A user may download the analytics report to the user device 101a, 101b, or 101c, from the IARP 104 via the GUI 2505a.

In an embodiment, the idea analytics engine 109 operates as an artificial intelligence engine that analyzes organizational intelligence information related to an idea and/or an organization and provides a predictive suggestion on the performance of the organization. The analyses performed by the idea analytics engine 109 comprises, for example, analyses of the performance of the members of the organization, competition analysis, comparisons with best practices, parameterized analysis, and interest expressed by third-party stakeholders. The inputs for the analyses are received from the user devices, for example, 101a, 101b, and 101c, via the GUI 2505a and obtained, for example, from a global Internet search. The results of the analyses are rendered in the form of reports in a natural language, along with visualizations and preset ranking parameters. The report generation module 111 transmits the reports to multiple users, which allows the users in decision-making processes. The decision-based contextual recommendations are contextual to the type of user, for example, investor, founder, team member, etc., for whom the analytics report is generated.

FIGS. 3-5 exemplarily illustrate flow diagrams comprising the steps performed by the idea analytics engine 109 of the system 100 shown m FIG. 1, for computing a market buzz index related to an idea. The idea analytics engine 109 calculates market communication, also referred to as “market buzz”, for an idea searched by a user. Consider an example where a user enters a startup idea and selects a country where the user wants to implement the startup idea.

As exemplarily illustrated in FIG. 3, the idea communication module 106 shown in FIG. 1, receives 301 the input of the startup idea and the location from the user device, for example, 101a, 101b, or 101c shown in FIG. 1, via the graphical user interface (GUI) 2505a shown in FIG. 25. The context extraction module 107 shown in FIG. 1, executes 302 natural language processing to interpret and extract the context from the startup idea searched. The data extraction module 108 shown in FIG. 1, connects 303 to multiple internal and external data sources, for example, proprietary databases available in the cloud, partner databases through APIs, public content available on the internet through multiple search engine APIs, social media platforms such as Facebook® of Facebook, Inc., Twitter® of Twitter, Inc., Linkedin® of Linkedin Corporation, YouTube® of Google LLC, etc., to extract relevant content for the searched startup idea. The idea analytics engine 109 perform a count 304 of the volume of the extracted relevant content from each data source and computes 305 the market buzz index by comparing the summation of the counts with a configurable threshold, for example, a configured range of numbers, to qualify the market buzz index, for example, as low, medium, or high.

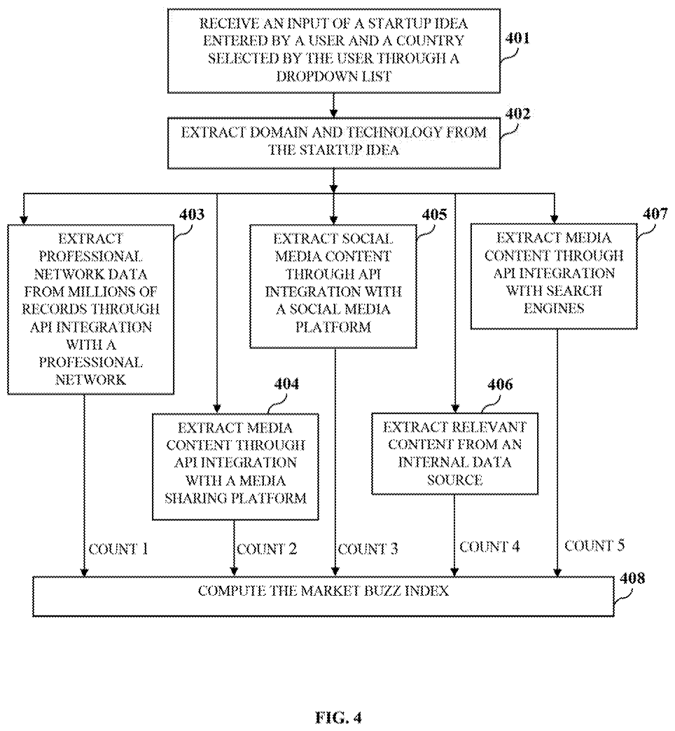

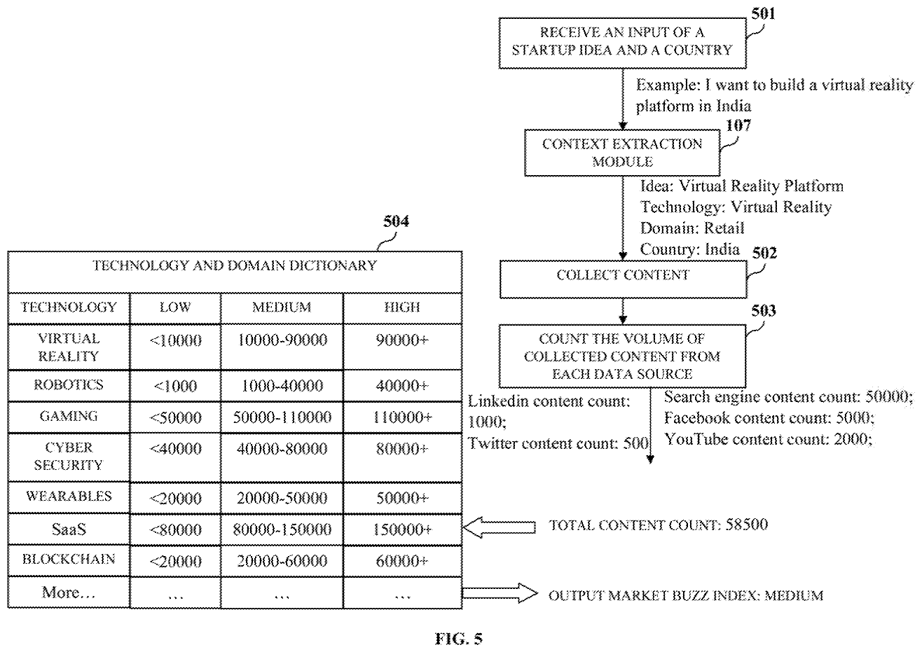

As exemplarily illustrated in FIG. 4, the idea communication module 106 shown in FIG. 1, receives 401 the input of the startup idea entered by a user and a country selected by the user through a dropdown list displayed on the graphical user interface (GUI) 2505a shown in FIG. 25, which is rendered on a website or a mobile application deployed on a user device, for example, 101a, 101b, or 101c shown in FIG. 1. The context extraction module 107 shown in FIG. 1, executes natural language processing to extract 402 the context, for example, domain and technology, from the startup idea searched. In this example, the data extraction module 108 shown in FIG. 1, connects to multiple internal and external data sources, for example, a professional network, a media sharing platform, a social media platform, an internal data source such as an internal proprietary database, public content available on the internet through multiple search engine APIs, etc., to extract relevant content for the searched startup idea. For example, the data extraction module 108 extracts 403 professional network data from numerous records through an API integration with the Linkedin® professional network. The professional network data comprises, for example, industry, technology skills, location, profile summary, years of experience, designation, company industry, company type, company size, company location, joining date, previous company details, previous industries and skills, number of posts relevant to the idea input, etc. Similarly, the data extraction module 108 extracts 404 media content, for example, videos, through an API integration with the YouTube media sharing platform. The data extraction module 108 extracts 405 social media content, for example, through an API integration with the Facebook® social media platform. The data extraction module 108 extracts 406 other relevant content from an internal database, for example, a MySQL® database 127 shown in FIG. 25, that stores startup details, news, etc., and further extracts 407 media content through an API integration with search engines, for example, the Google® search engine of Google LLC, the Bing® search engine of Microsoft Corporation, the Yahoo!® search engine of Yahoo! Inc., etc. The idea analytics engine 109 performs a count of the extracted content from each data source, for example, count 1, count 2, count 3, count 4, and count 5 as exemplarily illustrated in FIG. 4, and computes 408 the market buzz index by comparing the count with a configurable threshold. For example, the idea analytics engine 109 performs a summation of count 1, count 2, count 3, count 4, and count 5, and compares the summation with a configurable threshold as disclosed in the detailed description of FIG. 5, to qualify the market buzz index, for example, as low, medium, or high.

Consider an example where a user enters an idea input “I want to build a virtual reality platform for retailers in India” and selects a country, for example, India, on a graphical user interface (GUI) 2505a shown in FIG. 25. As exemplarily illustrated in FIG. 5, the idea communication module 106 shown in FIG. 1, receives 501 the input of the startup idea and the country selected by the user via the GUI 2505a and transmits the input to the context extraction module 107. The context extraction module 107 executes natural language processing to extract the context, for example, the idea as “virtual reality platform”, the technology as “virtual reality”, the domain as “retail”, and the country as “India”, from the startup idea input. The data extraction module 108 shown in FIG. 1, collects 502 content relevant to the startup idea as disclosed in the detailed descriptions of FIGS. 3-4. The idea analytics engine 109 performs a count 503 of the volume of the collected content from each data source and renders, for example, the following results; Linkedin® content count—1000; Twitter® content count—500; Google® search engine content count—50000; Facebook® content count—5000; and YouTube® content count—2000. The idea analytics engine 109 performs a summation of the individual counts and renders the summation, for example, as 58500. The idea analytics engine 109 computes the market buzz index by comparing the summation with a configurable threshold stored in a technology and domain dictionary 504. In an embodiment, the idea analysis and recommendation platform (IARP) 104 shown in FIG. 1, periodically updates and stores the technology and domain dictionary 504 in an internal database. The technology and domain dictionary 504 comprises thresholds for multiple technologies based on which the market buzz index can be computed. As exemplarily illustrated in FIG. 5, for the “virtual reality” technology, if the summation is less than 10000, the idea analytics engine 109 assigns a weightage of “1” to the marker buzz index and qualities the market buzz index as “low”. Similarly, for the “virtual reality” technology, if the summation is between 10000 and 90000, the idea analytics engine 109 assigns a weightage of “2” to the market buzz index and qualities the market buzz index as “medium”, and if the summation is more than 90000, the idea analytics engine 109 assigns a weightage of “3” to the market buzz index and qualifies the market buzz index as “high”. In the above example, since the summation 58500 for the user's idea related to “virtual reality” is between 10000 and 90000 as listed in the technology and domain dictionary 504, the idea analytics engine 109 assigns a weightage of “2” to the market buzz index for the user's idea and qualifies the market buzz index related to “virtual reality” as “medium” as exemplarily illustrated in FIG. 5.

The thresholds for reporting the market buzz index as “low”, “medium”, or “high” are configurable in the HARP 104. For example, 30% of the final summation is the threshold for reporting the market buzz index as “low”; 31% to 80% of the final summation is the threshold for reporting the market buzz index as “medium”; and 81% to 100% of the final summation is the threshold for reporting the market buzz index as “high”.

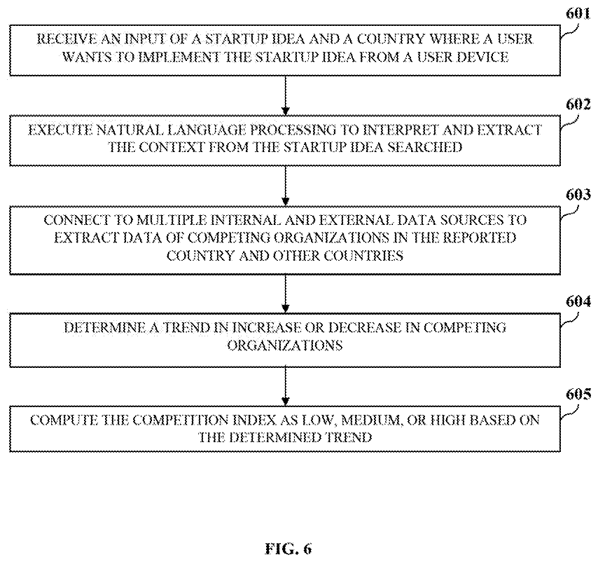

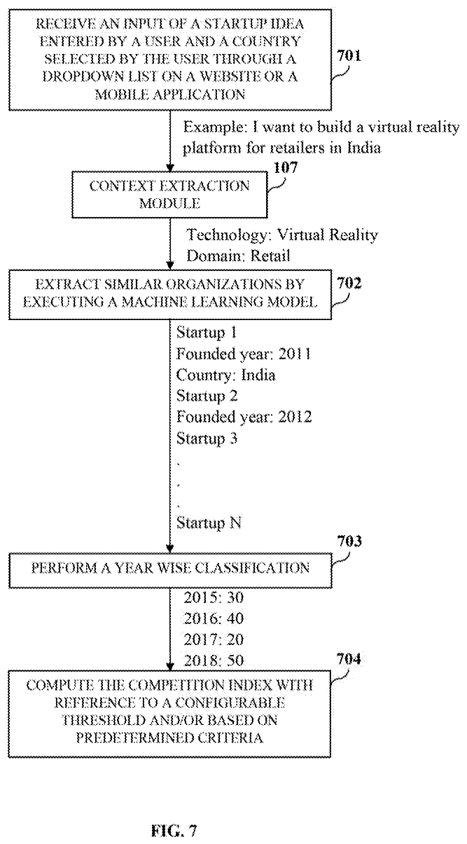

FIGS. 6-7 exemplarily illustrate flow diagrams comprising the steps performed by the idea analytics engine 109 shown in FIG. 1, for computing a competition index related to an idea. The idea analysis and recommendation platform (IARP) 104 shown in FIG. 1, tracks and stores data of, for example, more than 650000 organizations such as startups, globally, in an interns) database and automatically identifies the competition. The IARP 104 crawls, for example, the websites of these organizations, their social media webpages, search engine results related to these organizations, etc., and collects and stores the crawled information into the internal database for automated competition identification. Consider an example where a user enters a startup idea and selects a country where the user wants to implement the startup idea.

As exemplarily illustrated in FIG. 6, the idea communication module 106 shown in FIG. 1, receives 601 the input of the startup idea and the country from the user device, for example, 101a, 101b, or 101c shown in FIG. 1, via the graphical user interface (GUI) 2505a shown in FIG. 25. The context extraction module 107 shown in FIG. 1, executes 602 natural language processing to interpret and extract the context from the startup idea searched. The data extraction module 108 shown in FIG. 1, connects 603 to multiple internal and external data sources to extract data of competing organizations, for example, companies or startups, in the reported country or other countries. The data extraction module 108 collects startup information comprising, for example, startup name, founded year, location, total funding raised, funding round, investor names, news about the startups, their customers, etc. The idea analytics engine 109 determines 604 a trend in increase or decrease in competing organizations and computes 605 the competition index as low, medium, or high, based on the determined trend

If a large number of organizations are working on the similar startup idea entered by the user via the GUI 2505a, then the idea analytics engine 109 computes and reports the competition index as high. If a small number of organizations are working on the similar startup idea entered by the user via the GUI 2505a, then the idea analytics engine 109 computes and reports the competition index as medium. If few organizations are working on the similar startup idea entered by the user via the GUI 2505a, then the idea analytics engine 109 computes and reports the competition index as low. The thresholds for reporting the competition index as low, medium, or high are configurable in the IARP 104 as disclosed in the detailed description of FIG. 7.

Consider an example where a user enters a startup idea input “I want lo build a virtual reality platform for retailers in India” and selects a country, for example, India, through a dropdown list displayed on the graphical user interface (GUI) 2505a shown in FIG. 25, which is rendered on a website or a mobile application deployed on a user device, for example, 101a, 101b, or 101c shown in FIG. 1. As exemplarily illustrated in FIG. 7, the idea communication module 106 shown in FIG. 1, receives 701 the input of the startup idea entered by the user and the country selected by the user and transmits the input to the context extraction module 107. The context extraction module 107 executes natural language processing to extract the context, for example, the technology as “virtual reality” and the domain as “retail” from the startup idea input. The data extraction module 108 shown in FIG. 1, executes a machine learning model and extracts 702 data on similar organizations from one or more internal and external data sources. The IARP 104 shown in FIG. 1, trains the machine learning model on data of, for example, about 650000 startups globally. The data extraction module 108 extracts, for example, names of the startups, founded years of the startups, country of operation, etc., from one or more internal and external data sources. In an embodiment, the idea analytics engine 109 shown in FIG. 1, performs 703 a year wise classification and outputs results, for example, 30 startups were operating in the virtual reality technology space in the year 2015; 40 startups were operating in the virtual reality technology space in the year 2016; 20 startups were operating the in the virtual reality technology space in the year 2017; and 50 startups in the virtual reality technology space in the year 2018.

In an embodiment, the idea analytics engine 109 shown in FIG. 1, computes 704 the competition index with reference to a configurable threshold, for example, set as 10. If the number of startups operating in the current year is less than the configured threshold, the idea analytics engine 109 computes the competition index as “low”. In another embodiment, the idea analytics engine 109 computes 704 the competition index based on predetermined criteria. For example, the idea analytics engine 109 compares the number of startups operating in the current year with the configured threshold and determines whether the number of startups operating in the previous year is less than, equal to, or greater than the number of startups operating in the current year for the selected country. If the number of startups operating in the current year is greater than the number of startups operating in the previous year, the idea analytics engine 109 computes the competition index as “high”. If the number of startups operating in the current year is equal to the number of startups operating in the previous year, the idea analytics engine 109 computes the competition index as “medium”. If the number of startups operating in the current year is less than the number of startups operating in the previous year, the idea analytics engine 109 computes the competition index as “low”.

In another embodiment, the idea analytics engine 109 computes 704 the competition index with reference to the configured threshold and based on predetermined criteria. From the above results, for example, since the number of startups operating in the year 2018 is “50” which is greater than the threshold of 10, and since the number of startups operating in the year 2017 is “20” which is less than “50” for the selected country, India, the idea analytics engine 109 computes the competition index as “high”. That is, the idea analytics engine 109 assigns a weightage of, for example, “3” to the competition index related to the startup idea of “virtual reality” and qualifies the competition index as “high”.

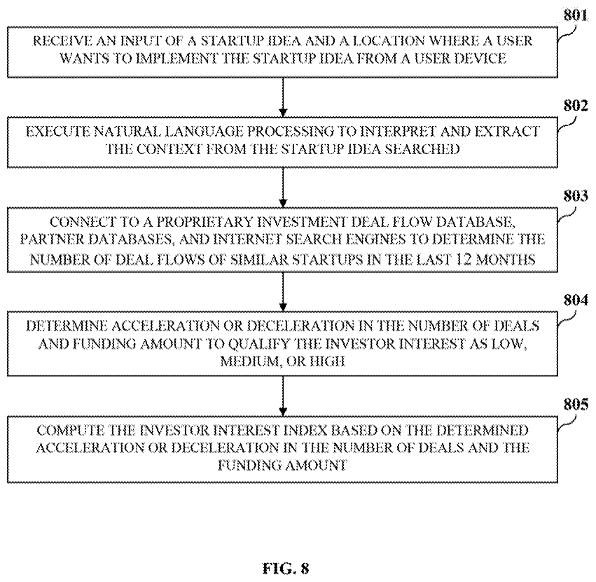

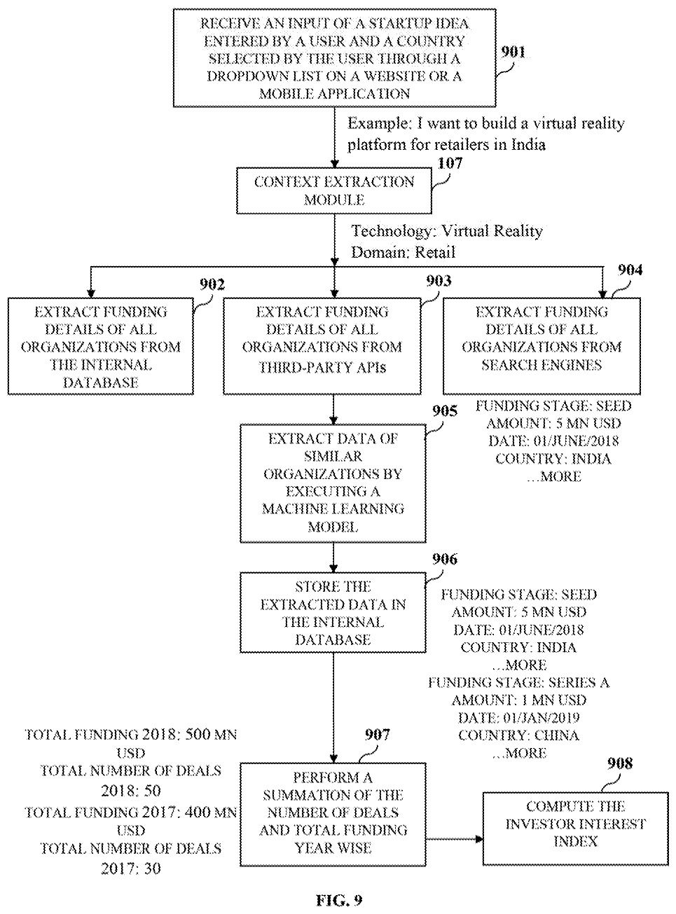

FIGS. 8-9 exemplarily illustrate flow diagrams comprising the steps performed by the idea analytics engine 109 shown in FIG. 1, for computing an investor interest index related to an idea. Consider an example where a user enters a startup idea and selects a location where the user wants to implement the startup idea, on the graphical user interface (GUI) 2505a shown in FIG. 25.

As exemplarily illustrated in FIG. 8, the idea communication module 106 shown in FIG. 1, receives 801 the input of the startup idea entered by the user and the selected location from a user device, for example, 101a, 101b, or 101c shown in FIG. 1, via the GUI 2505a. The context extraction module 107 shown in FIG. 1, executes natural language processing to interpret and extract 802 the context, for example, domain and technology, from the startup idea searched. In this example, the data extraction module 108 shown in FIG. 1, connects 803 to multiple internal and external data sources, for example, a proprietary investment deal flow database, partner databases, and internet search engine databases to determine the number of deal flows of similar startups, for example, in the last 12 months. The idea analytics engine 109 shown in FIG. 1, determines 804 acceleration or deceleration in the number of deals and funding amount to qualify the investor interest index as “low”, “medium”, or “high”. The idea analytics engine 109 computes 805 the investor interest index based on the determined acceleration or deceleration in the number of deals and the funding amount. The range for total number of deals and the amount of investment done are configurable in the idea analysis and recommendation platform (CARP) 104 shown in FIG. 1.

Consider an example where a user enters a startup idea input “I want to build a virtual reality platform for retailers in India” and selects a country, for example, India, through a dropdown list displayed on the graphical user interface (GUI) 2505a shown in FIG. 25, which is tendered on a website or a mobile application deployed on a user device, for example, 101a, 101b, or 101c shown in FIG. 1. As exemplarily illustrated in FIG. 9, the idea communication module 106 shown in FIG. 1, receives 901 the input of the startup idea entered by the user and the country selected by the user and transmits the input to the context extraction module 107. The context extraction module 107 executes natural language processing to extract the context, for example, the technology as “virtual reality” and the domain as “retail” from the startup idea input. The data extraction module 108 shown in FIG. 1, executes a machine learning model and extracts data on organizations from one or more internal and external data sources. For example, the data extraction module 108 extracts 902, 903, and 904 funding details of all organizations from the internal MySQL® database 127 shown in FIG. 25, the crunchbase® database of Crunchbase, Inc., via third-party APIs, and search engines. The data extraction module 108 extracts, for example, the funding stage, the funding amount, date, country, etc., from the internal and external data sources as exemplarily illustrated in FIG. 9. In an embodiment, the data extraction module 108 extracts, for example, competing company name, founded year, location, total funding raised, funding round, investor names, news about an organization, their customers, number of relevant deals, total amount of funding, number of new entrepreneurs, competing companies' revenue, follow-on funding raised, their operating status such as active, acquired, or closed, etc., from third-party data sources 126 shown in FIG. 1. The data extraction module 108 then executes a machine learning model to extract 905 data of similar organizations related to the startup idea as exemplarily illustrated in FIG. 9, and stores 906 the extracted data in the internal database.

In an embodiment, the idea analytics engine 109 shown in FIG. 1, performs 907 a summation of the number of deals and total funding year wise and outputs the results, for example, as follows: the total funding in the year 2018—500 million USD and the total number of deals in the year 2018—50; and the total funding in the year 2017—400 million USD and the total number of deals in the year 2017—30. The idea analytics engine 109 computes 908 the investor interest index based on predetermined criteria. For example, the idea analytics engine 109 determines whether the total funding and the total number of deals in the current year in the selected country is less than, equal to, or greater than that of the previous year in the selected country. If the total funding and the total number of deals in the current year are greater than that of the previous year, the idea analytics engine 109 computes the investor interest index as “high”. If the total funding and the total number of deals in the current year are equal to that of the previous year, the idea analytics engine 109 computes the investor interest index as “medium”. If the total funding and the total number of deals in the current year are less than that of the previous year, the idea analytics engine 109 computes the investor interest index as “low”.

From the above results, since the total funding, 500 million USD, and the total number of deals, 50, in the year 2018 are greater than that of the year 2017 as exemplarily illustrated in FIG. 9, the idea analytics engine 109 computes the investor interest index as “high”. That is, the idea analytics engine 109 assigns a weightage of, for example, “3” to the investor interest index related to the startup idea of “virtual reality” and qualifies the investor interest index as “high”.

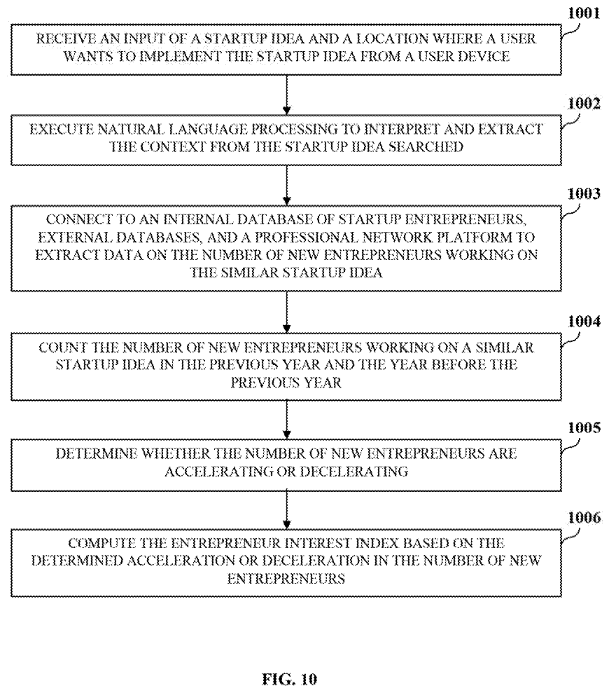

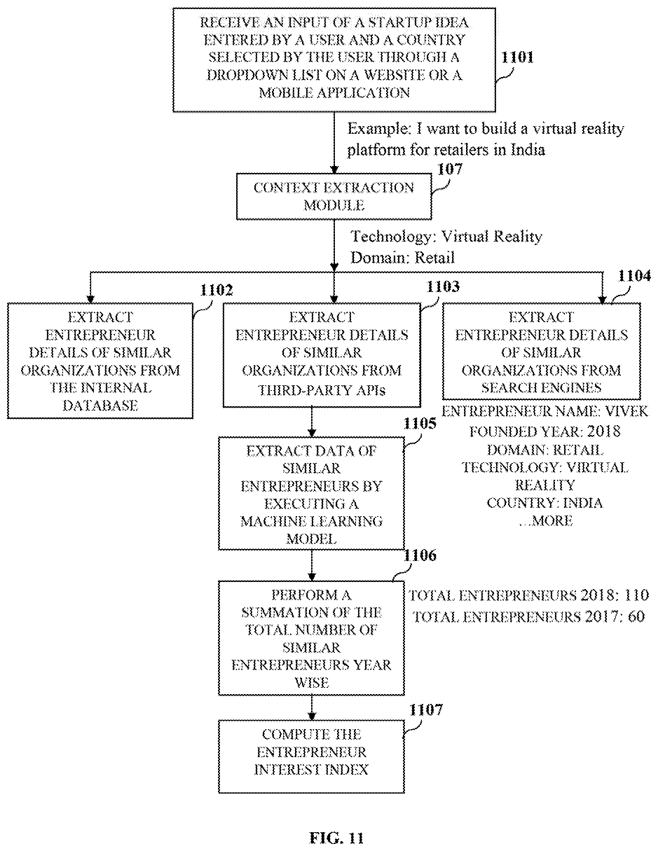

FIGS. 10-11 exemplarily illustrate flow diagrams comprising the steps performed by the idea analytics engine 109 shown in FIG. 1, for computing an entrepreneur interest index related to an idea. Consider an example where a user enters a startup idea and selects a location where the user wants to implement the startup idea, on the graphical user interface (GUI) 2505a shown in FIG. 25.

As exemplarily illustrated in FIG. 10, the idea communication module 106 shown in FIG. 1, receives 1001 the input of the startup idea entered by the user and the selected location from a user device, for example, 101a, 101b, or 101c shown in FIG. 1. The context extraction module 107 shown in FIG. 1, executes natural language processing to interpret and extract 1002 the context, for example, domain and technology, from the startup idea searched. In this example, the data extraction module 108 shown in FIG. 1, connects 1003 to multiple internal and external data sources, for example, an internal database of startup entrepreneurs or founders, external databases, and a professional network platform to extract data on the number of new entrepreneurs working on the same or similar startup idea. The idea analytics engine 109 shown in FIG. 1, counts 1004 the number of new entrepreneurs working on the same or similar startup idea in the previous year and the year before the previous year, in an embodiment, the idea analytics engine 109 counts 1004 the number of new entrepreneurs working on the same or similar startup idea in the current year and the previous year. The idea analytics engine 109 determines 1005 whether the number of new entrepreneurs are accelerating or decelerating to qualify the entrepreneur interest index as “low”, “medium”, or “high”.

The idea analytics engine 109 computes 1006 the entrepreneur interest index based on (he determined acceleration or deceleration in the number of new entrepreneurs. For example, if the acceleration in the number of new entrepreneurs is high, the idea analytics engine 109 computes the entrepreneur interest index as “high”. If there is no acceleration in the number of new entrepreneurs, the idea analytics engine 109 computes the entrepreneur interest index as “medium”. If the acceleration is low or there is a deceleration in the number of new entrepreneurs, the idea analytics engine 109 computes the entrepreneur interest index as “low”. The thresholds for reporting the entrepreneur interest index as “low”, “medium”, or “high” are configurable in the idea analysis and recommendation platform (IARP) 104 shown in FIG. 1, as disclosed in the detailed description of FIG. 11.

Consider an example where a user enters a startup idea input “I want to build a virtual reality platform for retailers in India” and selects a country, for example, India, through a dropdown list displayed on the graphical user interface (GUI) 2505a shown in FIG. 25, which is rendered on a website or a mobile application deployed on a user device, for example, 101a, 101b, or 101c shown in FIG. 1. As exemplarily illustrated in FIG. 11, the idea communication module 106 shown in FIG. 1, receives 1101 the input of the startup idea entered by the user and the country selected by the user via the GUI 2505a and transmits the input to the context extraction module 107. The context extraction module 107 executes natural language processing to extract the context, for example, the technology as “virtual reality” and the domain as “retail” from the startup idea input. The data extraction module 108 shown in FIG. 1, executes a machine learning model and extracts data on entrepreneurs from one or more internal and external data sources. For example, the data extraction module 108 extracts 1102, 1103, and 1104 entrepreneur details of organizations similar to the user's startup from the internal MySQL® database 127 shown in FIG. 25, the crunchbase® database of Crunchbase, Inc., via third-party APIs, and search engines. The data extraction module 108 extracts, for example, the entrepreneur's name, the founded year, the domain, technology, country, etc., from the internal and external data sources as exemplarily illustrated in FIG. 11. The data extraction module 108 then executes a machine learning model to extract 1105 data of similar entrepreneurs related to the user's startup idea input, and in an embodiment, stores the extracted data in the internal MySQL® database 127.

In an embodiment, the idea analytics engine 109 shown in FIG. 1, performs 1106 a summation of the total number of similar entrepreneurs, year wise, and outputs the results, for example, as follows; the total number of similar entrepreneurs in the year 2018—110 and the total number of similar entrepreneurs in the year 2017—60. The idea analytics engine 109 computes 1107 the entrepreneur interest index based on predetermined criteria. For example, if the increase in the total number of entrepreneurs in the current year in comparison to the previous year is greater than 25%, then the idea analytics engine 109 computes the entrepreneur interest index as “high”. If the increase in the total number of entrepreneurs in the current year in comparison to the previous year is greater than 0% but less than 25%, then the idea analytics engine 109 computes the entrepreneur interest index as “medium”. If the total number of entrepreneurs in the current year has decreased in comparison to the previous year, then the idea analytics engine 109 computes the entrepreneur interest index as “low”.

From the above results, since the percentage increase in the total number of similar entrepreneurs in the year 2018 in comparison to the year 2017 is greater than 25%, the idea analytics engine 109 computes the entrepreneur interest index as “high”. That is, the idea analytics engine 109 assigns a weightage of, for example, “3” to the entrepreneur interest index related to the startup idea of “virtual reality” and qualifies the entrepreneur interest index as “high”.

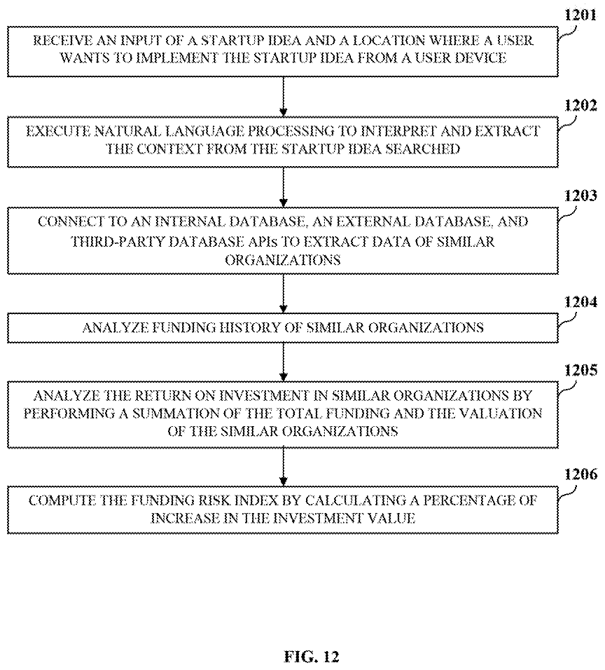

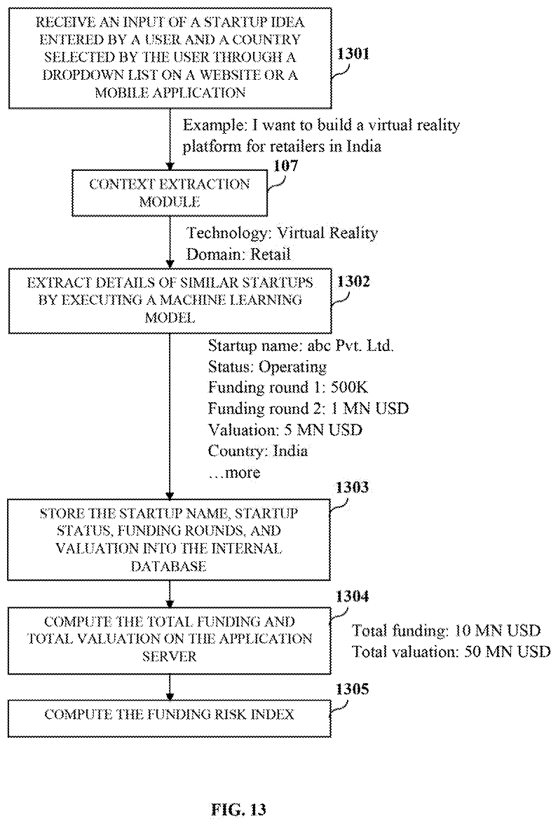

FIGS. 12-13 exemplarily illustrate flow diagrams comprising the steps performed by the idea analytics engine 109 shown in FIG. 1, for computing a funding risk index related to an idea. Consider an example where a user enters a startup idea and selects a location where the user wants to implement the startup idea, on the graphical user interface (GUI) 2505a shown in FIG. 25.

As exemplarily illustrated in FIG. 12, the idea communication module 106 shown in FIG. 1, receives 1201 the input of the startup idea entered by the user and the selected location from a user device, for example, 101a, 101b, or 101c shown in FIG. 1, via the GUI 2505a. The context extraction module 107 shown in FIG. 1, executes natural language processing to interpret and extract 1202 the context, for example, domain and technology, from the startup idea searched. In this example, the data extraction module 108 shown in FIG. 1, connects 1203 to multiple internal and external data sources, for example, an internal database, an external database, and third-party database APIs to extract data of organizations similar to the startup proposed by the user in the startup idea input. The data extraction module 108 executes a machine learning model to extract the data of similar organizations. The idea analytics engine 109 shown in FIG. 1, analyzes 1204 funding history of the similar organizations. Furthermore, the idea analytics engine 109 analyzes 1205 the return on investment in the similar organizations by performing a stimulation of the total funding and the valuation of the similar organizations. If similar organizations have launched initial public offerings (IPOs), then the idea analytics engine 109 determines their market capital and adds the market capital to their market valuation. If any of the similar organizations was acquired, then the idea analytics engine 109 determines their acquisition valuation and adds their acquisition valuation to the market valuation. The idea analytics engine 109 then adds total funding received and total known valuation of the similar organizations. Based on these calculations, the idea analytics engine 109 computes 1206 the funding risk index by calculating a percentage of increase in the investment value to qualify the funding risk index as low, medium, or high. If the return on investment is a high multiple of the investment value, then the idea analytics engine 109 computes the funding risk index as “low”. If there is a small increase in the investment value, then the idea analytics engine 109 computes the funding risk index as “medium”, and if the current valuation is less than the investment amount, then the idea analytics engine 109 computes the funding risk index as “high”. The thresholds for reporting the funding risk index as “low”, “medium”, or “high” are configurable in the idea analysis and recommendation platform (IARP) 104 shown in FIG. 1. In an embodiment, the idea analytics engine 109 compares the total funding across the similar organizations with the total valuation and determines whether the total funding is less than, equal to, or greater than the total valuation.

Consider an example where a user enters a startup idea input “I want to build a virtual reality platform for retailers in India” and selects a country, for example, India, through a dropdown list displayed on the graphical user interface (GUI) 2505a shown in FIG. 25, which is rendered on a website or a mobile application deployed on a user device, for example, 101a, 101b, or 101c shown in FIG. 1. As exemplarily illustrated in FIG. 13, the idea communication module 106 shown in FIG. 1, receives 1301 the input of the startup idea entered by the user and the country selected by the user and transmits the input to the context extraction module 107. The context extraction module 107 executes natural language processing to extract the context, for example, the technology as “virtual reality” and the domain as “retail” from the startup idea input. The data extraction module 108 shown in FIG. 1, executes a machine learning model and extracts 1302 details of similar startups from one or more internal and external data sources. The data extraction module 108 extracts, for example, the names of the startups, operating status, funding rounds, valuation, countries of operation, etc., from the internal and external data sources as exemplarily illustrated in FIG. 13. The data extraction module 108 then stores 1303 the extracted details into the internal database.

The idea analytics engine 109 shown in FIG. 1, computes 1304 the total funding and the total valuation on the application server 105 shown in FIG. 1. For example, the idea analytics engine 109 computes the total funding as 10 million USD and the total valuation as 50 million USD. The idea analytics engine 109 computes 1305 the funding risk index based on predetermined criteria. For example, if the total funding across the similar startups is greater than the total valuation, then the idea analytics engine 109 computes the funding risk index as “high”. If the total funding across the similar startups is equal to the total valuation, then the idea analytics engine 109 computes the funding risk index as “medium”. If the total funding across the similar startups is less than the total valuation, then the idea analytics engine 109 computes the funding risk index as “low”.

From the above results, since the total funding across the similar startups, that is, 10 million USD is less than the total valuation, that is, 50 million USD, the idea analytics engine 109 computes the funding risk index as “low”. That is, the idea analytics engine 109 assigns a weightage of, for example, “1” to the funding risk index related to the startup idea of “virtual reality” and qualifies the funding risk index as “low”.

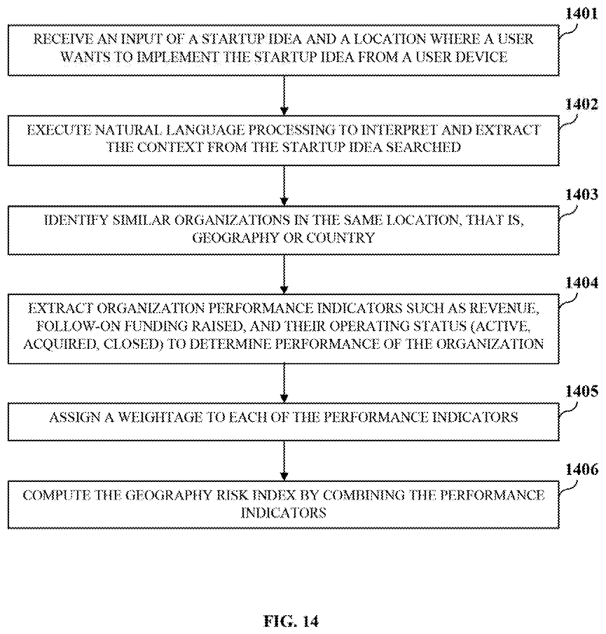

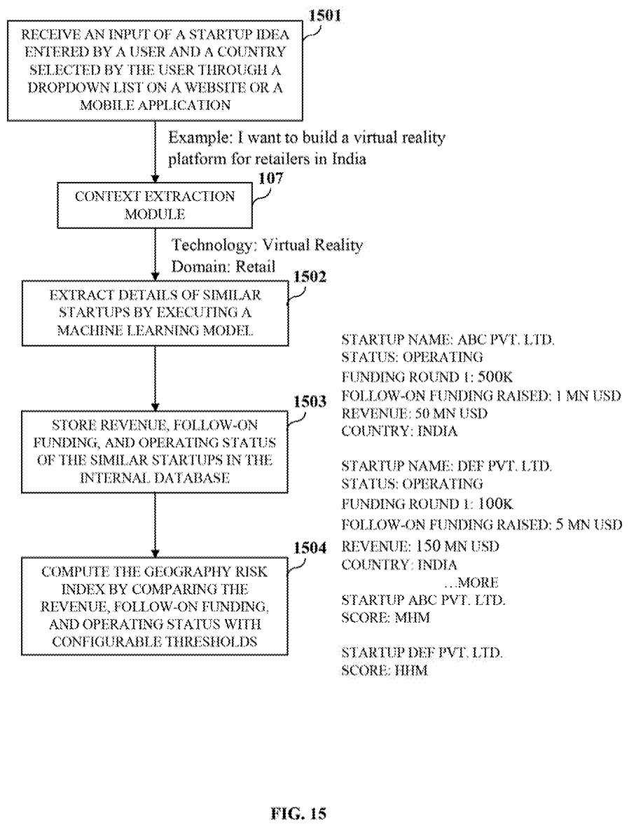

FIGS. 14-15 exemplarily illustrate flow diagrams comprising the steps performed by the idea analytics engine 109 shown in FIG. 1, for computing a geography risk index related to an idea input. Consider an example where a user enters a startup idea and selects a location where the user wants to implement the startup idea, on the graphical user interface (GUI) 2505a shown in FIG. 25.

As exemplarily illustrated in FIG. 14, the idea communication module 106 shown in FIG. 1, receives 1401 the input of the startup idea entered by the user and the selected location from a user device, for example, 101a, 101b, or 101c shown in FIG. 1, via the GUI 2505a. The context extraction module 107 shown in FIG. 1, executes natural language processing lo interpret and extract 1402 the context, for example, domain and technology, from the startup idea searched. The data extraction module 108 shown in FIG. 1, connects to multiple internal and external data sources to identify 1403 similar organizations in the same location, that is, geography or country. The data extraction module 108 extracts 1404 organization performance indicators comprising, for example, revenue, follow-on funding raised, and the operating status such as active, acquired, or closed, to determine performance of each organization. The idea analytics engine 109 shown in FIG. 1, assigns 1405 a weightage to each of the performance indicators. The idea analytics engine 109 then computes 1406 the geography risk index as low, medium, or high, by combining the performance indicators as disclosed in the detailed description of FIG. 15. The values of revenue, operating status, and follow-on funding raised for reporting the geography risk index as “low”, “medium”, or “high” are configurable in the idea analysis and recommendation platform (IARP) 104 shown in FIG. 1.

Consider an example where a user enters a startup idea input “I want to build a virtual reality platform for retailers in India” and selects a country, for example, India, through a dropdown list displayed on the graphical user interface (GUI) 2505a shown in FIG. 25, which is rendered on a website or a mobile application deployed on a user device, for example, 101a, 101b, or 101c shown in FIG. 1. As exemplarily illustrated in FIG. 15, the idea communication module 106 shown in FIG. 1, receives 1501 the input of the startup idea entered by the user and the country selected by the user via the GUI 2505a and transmits the input to the context extraction module 107. The context extraction module 107 executes natural language processing to extract the context, for example, the technology as “virtual reality” and the domain as “retail” from the startup idea input. The data extraction module 108 shown in FIG. 1, executes a machine learning model and extracts 1502 details of similar startups from one or more internal and external data sources. The data extraction module 108 stores 1503, for example, revenue, follow-on funding, and operating status of the similar startups in the internal MySQL® database 127 shown in FIG. 25, as exemplarily illustrated in FIG. 15.

The idea analytics engine 109 shown in FIG. 1, computes 1504 the geography risk index by comparing the revenue, the follow-on funding, and the operating status with configurable thresholds as follows. The idea analytics engine 109 generates an array of weightages assigned to the performance indicators, for example, revenue, follow-on funding, and the operating status of each of the similar startups to compute the geography risk index. For example, for each startup: If revenue is greater than 100 million USD, then the idea analytics engine 109 assigns a weightage of, for example, 3, represented by “H” for high, to the revenue value of the array. If revenue is between 10 million USD and 100 million USD, then the idea analytics engine 109 assigns a weightage of, for example, 2, represented by “M” for medium, to the revenue value of the array. If revenue is less than 10 million USD, then the idea analytics engine 109 assigns a weightage of, for example, 1, represented by “L” for low, to the revenue value of the array. Similarly, if follow-on funding in the current funding round is greater than that of the previous funding round, then the idea analytics engine 109 assigns a weightage of, for example, 3, represented by “H” for high, to the follow-on funding value of the array. If follow-on funding in the current funding round is equal to that of the previous funding round, then the idea analytics engine 109 assigns a weightage of, for example, 2, represented by “M” for medium, to the follow-on funding value of the array. If follow-on funding in the current funding round is less than that of the previous funding round, then the idea analytics engine 109 assigns a weightage of, for example, 1, represented by “L” for low, to the follow-on funding value of the array. Similarly, if the operating status of the startup is “initial public offering (IPO)”, then the idea analytics engine 109 assigns a weightage of, for example, 3, represented by “H” for high, to the operating status value of the array. If the operating status of the startup is “operating”, then the idea analytics engine 109 assigns a weightage of, for example, 2, represented by “M” for medium, to the operating status value of the array. If the operating status of the startup is “closed”, then the idea analytics engine 109 assigns a weightage of, for example, 1, represented by “L” for low, to the operating status value of the array.

From the results exemplarily illustrated in FIG. 15, output from the data extraction module 108, the idea analytics engine 109 generates the array “MHM” for the startup named “ABC Pvt. Ltd.” and the array “HHM” for the startup named “DEF Pvt. Ltd”. The idea analytics engine 109 then computes the geography risk index with reference to a configurable threshold and predetermined criteria based on the generated array. For example, if more than 70% of the similar startups are assigned the “HHH” array, then the idea analytics engine 109 computes the geography risk index as “low”. If more than 70% of the similar startups are assigned the “MHM” array or the “MHH” array, or the “HHM” array, then the idea analytics engine 109 computes the geography risk index as “medium”, else (he idea analytics engine 109 computes the geography risk index as “high”. In the example shown in FIG. 15, since 100% of the similar startups are assigned the “MHM” array or the “HHM” array, the idea analytics engine 109 assigns a weightage of, for example, “2” to the geography risk index related to the startup idea of “virtual reality” and qualifies the geography risk index as “medium”.

FIGS. 16-17 exemplarily illustrate flow diagrams comprising the steps performed by the idea analytics engine 109 shown in FIG. 1, for computing a commitment index related to an idea. The commitment index measures commitment of a team to execute the idea received from a user device, for example, 101a, 101b, or 101c shown in FIG. 1. Professional network platforms, for example, Linkedin®, provide insights on a professional journey of founders and their team members. The idea analytics engine 109 uses the professional network data to report team insights. The commitment index indicates, for example, whether the team members have domain skills and/or technology skills to work on an idea in a particular space, whether the team members are committed to the business, whether the organization has the right resources to execute the idea, and whether the founder or the team members have the ability to execute the idea.

The data extraction module 108 shown in FIG. 1, extracts 1601 information about founders, co-founders, and their key executive key members from multiple internal and external data sources. The data extraction module 108 also extracts 1602 information about the current organization as reported by the founders in the internal database, external websites, and professional networking websites, for example, the LinkedIn® professional networking website. The idea analytics engine 109 shown in FIG. 1, determines 1603 whether all team members of an organization are reporting the same organization name across multiple web platforms. The idea analytics engine 109 performs a count 1604 of the total number of team members that have reported the same organization name and a different organization name. The idea analytics engine 109 computes 1605 the commitment index as low, medium, or high, by calculating the percentage of the team members reporting the same organization name across multiple web platforms. The range of percentage for reporting the commitment index as “low”, “medium”, or “high”, is configurable in the idea analysis and recommendation platform (IARP) 104 shown in FIG. 1, as disclosed in the detailed description of FIG. 17.

Consider an example where a user enters a startup idea input “I want to build a virtual reality platform for retailers in India” and selects a country, for example, India, through a dropdown list displayed on the graphical user interface (GUI) 2505a shown in FIG. 25, which is rendered on a website or a mobile application deployed on a user device, for example, 101a, 101b, or 101c shown in FIG. 1. As exemplarily illustrated in FIG. 17, the idea communication module 106 shown in FIG. 1, receives 1701 the input of the startup idea entered by the user and the country selected by the user and transmits the input to the context extraction module 107. When the user, for example, a founder named Vivek, logs into the IARP 104 shown in FIG. 1, the idea analytics engine 109 shown in FIG. 1, verifies 1702 the founder's social media profile comprising, for example, the founder's name, the organization name, etc. In an example, me idea analytics engine 109 verifies the founder's name as “Vivek” and the founder's organization name as “ABC”. The IARP 104 allows the user to add names and electronic mail (email) addresses of team members in the organization via the GUI 2505a. In an example, the user adds a team member named “Rahul” via the GUI 2505a. The IARP 104 sends an email notification to the added team members. The data extraction module 108 shown in FIG. 1, stores 1703 the names and email addresses of the team members in a profile repository. The data extraction module 108 then fetches 1704 the organization names of the added team members as reported on a social media or professional network platform, for example, the Linkedin® professional networking website, and updates 1705 the internal database with team member and organization associations. In the above example, the data extraction module 108 fetches the organization name “ABC” of the added team member named “Rahul” as reported on Rahul's Linkedin profile, and updates the internal database with the team member and organization associations.

The idea analytics engine 109 computes 1706 the percentage of the team displaying the same organization name in their professional network profiles. The idea analytics engine 109 computes 1707 the commitment index based on the computed percentage. For example, if 100% of the team members who belong to the same organization, display the same organization name in their professional network profiles, the idea analytics engine 109 assigns a weightage of, for example, “3”, to the commitment index, and qualifies the commitment index as “high”. If about 60% to about 90% of the team members who belong to the same organization, display the same organization name in their professional network profiles, the idea analytics engine 109 assigns a weightage of, for example, “2”, to the commitment index, and qualifies the commitment index as “medium”. If less than 60% of the team members who belong to the same organization, display the same organization name in their professional network profiles, the idea analytics engine 109 assigns a weightage of, for example, “1”, to the commitment index and qualifies the commitment index as “low”. In the above example, since 100% of the two-member team belongs to the same organization “ABC”, the idea analytics engine 109 assigns a weightage of, for example, “3”, to the commitment index, and qualifies the commitment index as “high”.

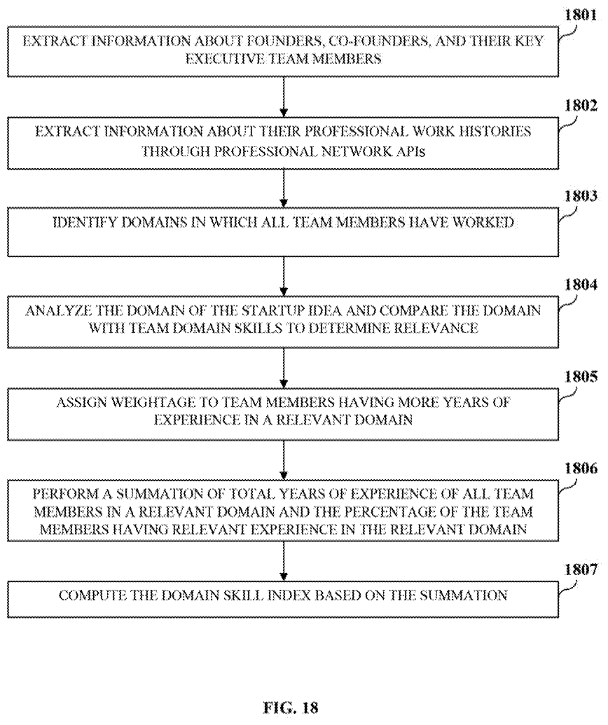

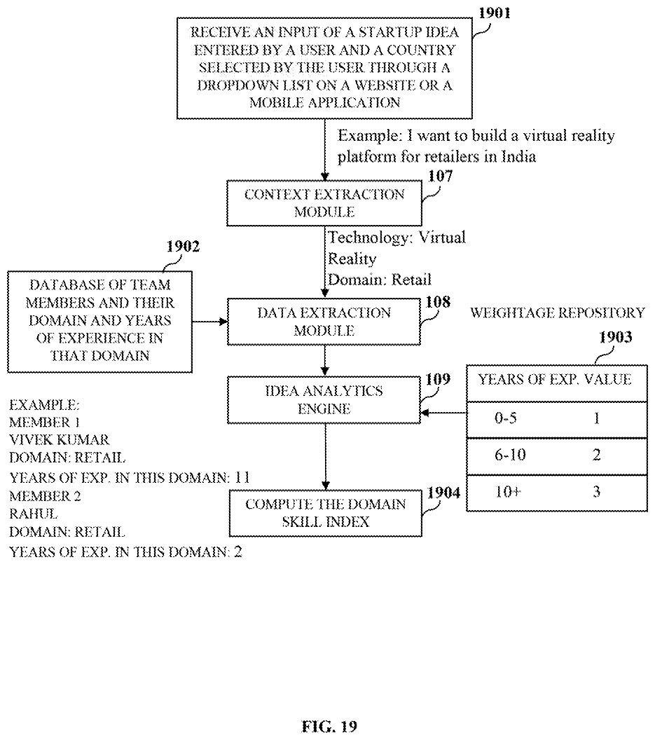

FIGS. 18-19 exemplarily illustrate flow diagrams comprising the steps perforated by the idea analytics engine 109 shown in FIG. 1, for computing a domain skill index related to an idea. The data extraction module 108 shown in FIG. 1, extracts 1801 information about founders, co-founders, and their key executive team members from one or more internal and external data sources. The data extraction module 108 also extracts 1802 information about the professional work histories of the founders, the co-founders, and their key executive team members through professional network APIs. The idea analytics engine 109 identifies 1803 domains in which all team members have worked. The idea analytics engine 109 analyzes 1804 the domain of the startup idea entered by a user via the graphical user interface (GUI) 2505a shown in FIG. 25, and compares the domain with team domain skills to determine relevance. The idea analytics engine 109 assigns 1805 weightage to the team members having move years of experience in a relevant domain. The idea analytics engine 109 performs 1806 a summation of total years of experience of all team members in a relevant domain and the percentage of the team members having relevant experience in the relevant domain. The idea analytics engine 109 computes 1807 the domain skill index as low, medium, or high, based on the summation. The range of total number of years and the percentage of the team members having relevant experience in a domain of the startup are configurable in the idea analysis and recommendation platform (IARP) 104 shown in FIG. 1, to qualify the domain skill index as low, medium, or high.

Consider an example where a user enters a startup idea input “I want to build a virtual reality platform for retailers in India” and selects a country, for example, India, through a dropdown list displayed on the GUI 2505a, which is rendered on a website or a mobile application deployed on a user device, for example, 101a, 101b, or 101c shown in FIG. 1. As exemplarily illustrated in FIG. 19, the idea communication module 106 shown in FIG. 1, receives 1901 the input of the startup idea entered by the user and the country selected by the user and transmits the input to the context extraction module 107. The context extraction module 107 executes natural language processing to extract the context, for example, the technology as “virtual reality” and the domain as “retail” from the startup idea input. The data extraction module 108 executes a machine learning model and extracts information about team members and their domain and years of experience in that domain from a database 1902. For example, the data extraction module 108 extracts information of member 1 as “Vivek Kumar” having “11” years of experience in the “retail” domain, and information of member 2 as “Rahul” having “2” years of experience in the “retail” domain. The data extraction module 108 transmits the extracted information to the idea analytics engine 109. The idea analytics engine 109, in communication with a weightage repository 1903, assigns weightage to team members having more years of experience in a relevant domain. In the above example, the idea analytics engine 109, in communication with the weightage repository 1903, assigns a weightage of “3” to member 1 having 11 years of experience in the retail domain, and assigns a weightage of “1” to member 2 having 2 years of experience in the retail domain.

The idea analytics engine 109 then computes 1904 the domain skill index, for example, as follows: If 100% of the team members have relevant domain experience and the total number of years of relevant domain experience value across all (earn members is greater than a configurable threshold, for example, 10, then the idea analytics engine 109 computes the domain skill index as “high”; if 51% to 99% of the team members have relevant domain experience and the total number of years of relevant domain experience value across all team members is greater than a configurable threshold, for example, 10, then the idea analytics engine 109 computes the domain skill index as “medium”; else the idea analytics engine 109 computes the domain skill index as “low”. In the above example, the idea analytics engine 109 identifies the domain of member 1 and member 2 as “retail” and determines the value of the number of years of relevant domain experience of both team member as 3+1=4 based on the assigned weightages. The idea analytics engine 109, therefore, computes the domain skill index as “low”.

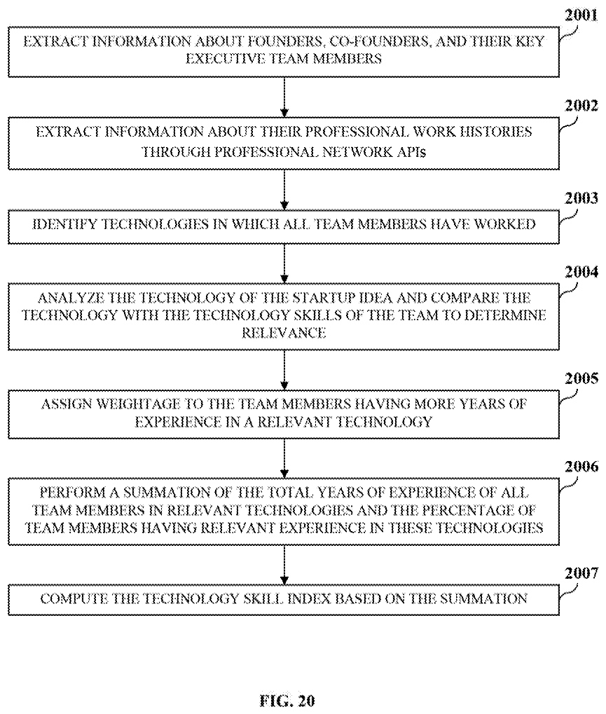

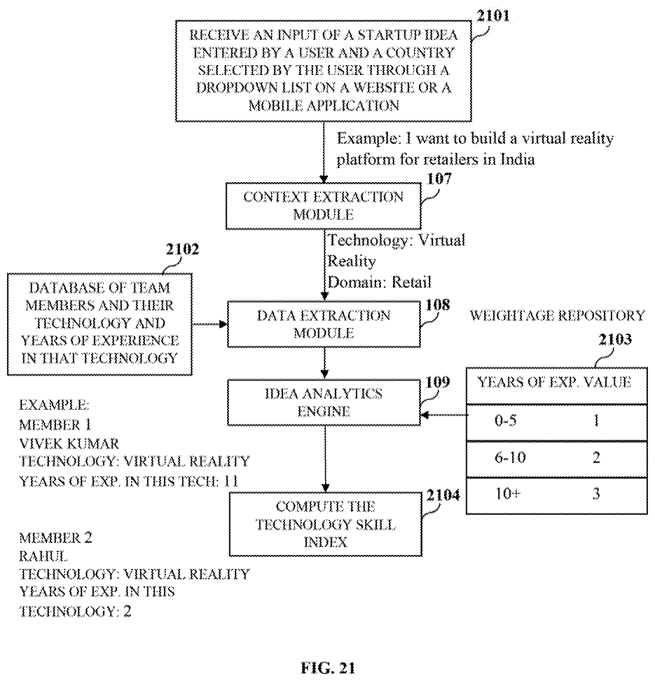

FIGS. 20-21 exemplarily illustrate flow diagrams comprising the steps performed by the idea analytics engine 109 shown in FIG. 1, for computing a technology skill index related to an idea. The data extraction module 108 extracts 2001 information about founders, co-founders, and their key executive team members from one or more internal and external data sources. The data extraction module 108 also extracts 2002 information about the professional work histories of the founders, the co-founders, and their key executive team members through professional network APIs. The idea analytics engine 109 identifies 2003 technologies in which all team members have worked. The idea analytics engine 109 analyzes 2004 the technology of the startup idea entered by a user via the graphical user interface (GUI) 2505a shown in FIG. 25. and compares the technology with the technology skills of the team to determine relevance. The idea analytics engine 109 assigns 2005 weightage to the team members having more years of experience in a relevant technology. The idea analytics engine 109 performs 2006 a summation of the total years of experience of all team members in relevant technologies and the percentage of the team members having relevant experience in the relevant technologies. The idea analytics engine 109 computes 2007 the technology skill index as low, medium, or high, based on the summation. The ranges of the total number of years and the percentage of the team members having relevant experience in a technology of the startup are configurable in the idea analysis and recommendation platform (IARP) 104 shown in FIG. 1, to qualify the technology skill index as low, medium, or high.

Consider an example where a user enters a startup idea input “I want to build a virtual reality platform for retailers in India” and selects a country, for example, India, through a dropdown list displayed on the GUI 2505a shown in FIG. 25, which is rendered on a WebSite or a mobile application deployed on a user device, for example, 101a, 101b, or 101c shown in FIG. 1. As exemplarily illustrated in FIG. 21, the idea communication module 106 shown in FIG. 1, receives 2101 the input of the startup idea entered by the user and the country selected by the user via the GUI 2505a and transmits the input to the context extraction module 107. The context extraction module 107 executes natural language processing to extract the context, for example, the technology as “virtual reality” and the domain as “retail” from the startup idea input. The data extraction module 108 executes a machine learning model and extracts information about team members and their technology and years of experience in that technology from a database 2102. For example, the data extraction module 108 extracts information of member 1 as “Vivek Kumar” having “11” years of experience in the “virtual reality” technology, and information of member 2 as “Rahul” having “2” years of experience in the “virtual reality” technology. The data extraction module 108 transmits the extracted information to the idea analytics engine 109. The idea analytics engine 109, in communication with a weightage repository 2103, assigns weightage to team members having more years of experience in a relevant technology. In the above example, the idea analytics engine 109, in communication with the weightage repository 2103, assigns a weightage of “3” to member 1 having 11 years of experience in the virtual reality technology, and assigns a weightage of “1” to member 2 having 2 years of experience in the virtual reality technology.

The idea analytics engine 109 computes the technology strength of each team member as number of years of experience in a relevant technology multiplied by the weightage. For example, the idea analytics engine 109 computes the technology strength of member 1 as 11*3=33 and of member 2 as 2*1=2. The idea analytics engine 109 computes the total technology strength of the team, for example, as 33+2=35. The idea analytics engine 109 then computes 2104 the technology skill index, for example, as follows: If 100% of the team members have relevant technology experience and the total technology strength is greater than a configurable threshold, for example, 10, then the idea analytics engine 109 computes the technology skill index as “high”; if 51% to 99% of the learn members have relevant technology experience and the total technology strength across all team members is greater than a configurable threshold, for example, 10, then the idea analytics engine 109 computes the technology skill index as “medium”; else the idea analytics engine 109 computes the technology skill index as “low”. In the above example, the idea analytics engine 109 identifies the technology of member 1 and member 2 as “virtual reality” and determines the total technology strength as “35” which is greater than 10. The idea analytics engine 109, therefore, computes the technology skill index as “high”.

FIG. 22A exemplarily illustrates a flow diagram comprising the steps performed by the system 100 shown in FIG. 1, for generating a recommendation score. Consider an example where a user logs into the idea analysis and recommendation platform (IARP) 104 shown in FIG. 1, via the graphical user interface (GUI) 2505a shown in FIG. 25, which is rendered on a website or a mobile application deployed on a user device, for example, 101a, 101b, or 101c shown in FIG. 1, and enters a startup idea input, user-defined parameters, and selects a country through a dropdown list displayed on the GUI 2505a. The IARP 104 receives 2201 the idea input, location, and the user-defined parameters related to a startup, for example, a startup stage, a funding stage, etc., and performs context and data extraction 2202 as disclosed in the detailed description of FIG. 2. The idea analytics engine 109 of the IARP 104 shown in FIG. 1, then computes multiple measurement indices related to the idea defined in the received idea input. For example, the idea analytics engine 109 performs a market buzz index computation 2203a, an entrepreneur interest index computation 2203b, an investor interest index computation 2203c, a competition index computation 2203d, a funding risk index compulation 2203e, a geography risk index computation 2203f, a commitment index computation 2203g, a domain skill index computation 2203h, and a technology skill index computation 2203i as disclosed in the detailed descriptions of FIGS. 3-21. Consider an example where the idea analytics engine 109 outputs the measurement indices, namely, the market buzz index, the entrepreneur interest index, the investor interest index, the competition index, the funding risk index, the geography risk index, the commitment index, the domain skill index, and the technology skill index as a first array, for example, {H,M,L,H,M,L,L,H,H} respectively, where “H” represents “high” with a weight of “3”, “M” represents “medium” with a weight of “2”, and “L” represents “low” with a weight of “1”.

The idea analytics engine 109 then performs a weighted importance matrix generation 2204 as disclosed in the detailed description of FIG. 22B, to generate a second array of measurement indices and importance, for example, as {{HL}, {M,H}, {L,L}, {H,L}, {M,L}, {L,H}, {L,H}, {H,L}, {H,L}}. The idea analytics engine 109 then generates a weighted execution matrix 2205 exemplarily illustrated in FIG. 22D and as disclosed in the detailed description of FIG. 23, and uses the generated weighted execution matrix 2205 to perform an execution risk index computation 2206 based on the user-defined parameters comprising, for example, the startup stage and the funding stage. After the execution risk index computation 2206, the idea analytics engine 109 outputs a third array of measurement indices, importance, and the execution risk, for example, as {{{HL}, {M,H}, {L,L}, {H,L}, {M,L}, {L,H}, {L,H}, {H,L}, {H,L}}, {H}}. The idea analytics engine 109 feeds the third array output to the decision-based recommendation engine 110 of the IARP 104 shown in FIG. 1. The decision-based recommendation engine 110 then performs recommendation score generation 2209 using the computed execution risk index and weightage assignment repositories 2207 and 2208 exemplarily illustrated in FIGS. 22E-22F respectively. The decision-based recommendation engine 110 generates the recommendation score based on the weightages assigned and increases or decreases the recommendation score based on the execution risk. The decision-based recommendation engine 110 then performs a percentile ranking 2210 of all the startup ideas researched. For example, if the startup idea is in the top 10 percentile, the decision-based recommendation engine 110 generates a “high” recommendation for the startup idea. If the startup idea is in the 11th to 60th percentile, the decision-based recommendation engine 110 generates a “medium” recommendation for the startup idea. If the startup idea is in the 61st to 100th percentile, the decision-based recommendation engine 110 generates a “low” recommendation for the startup idea.

FIG. 22B exemplarily illustrates a flow diagram comprising the steps performed by the system 100 shown in FIG. 1, for generating 2204 a weighted importance matrix to compute the execution risk index. Domain and technology play different roles during analysis of an idea, for example, a business idea. The idea analytics engine 109 shown in FIG. 1, analyzes data collected, for example, from analysts and market surveys to assign an importance classification such as low, medium, or high to the measurement indices for all domains and technologies. For example, market buzz has a low importance for a quantum computing technology based on a proprietary analyst's report because quantum computing is a business to business (B2B) technology and market buzz does not play an important role in its development or deployment in the B2B market. In another example, market buzz has a high importance for a wearable technology because a large amount of market buzz means consumers are aware and talking about the wearable technology and if market buzz is high, then adoption of the wearable technology will be easier among consumers.

The data extraction module 108 shown in FIG. 1, extracts data from an internal database 2204a, a proprietary analyst report 2204b, public market research reports 2204c, and publications 2204d, and executes 2204e, a machine learning model to determine, for example, funding volume, technology skills, development time, business category classification, number of entrepreneurs, relevant countries, and domains from the extracted data. The idea analytics engine 109 then performs an importance classification 2204f using the funding volume, the technology skills, the development time, the business category classification, the number of entrepreneurs, the relevant countries, and the domains, to classify the importance of each of the measurement indices as high or low. As exemplarily illustrated in FIG. 22A, the idea analytics engine 109 performs a quantitative analysis of the funding volume, the technology skills, the development time, the business category classification, the number of entrepreneurs, the relevant countries, and the domains, and classifies the importance of the market buzz index as “low”, the entrepreneur interest index as “high”, the investor interest index as “low”, the competition index as “low”, the funding risk index as “low”, the geography risk index as “high”, the commitment index as “high”, the domain skill index as “low”, and the technology skill index as “low”, to generate the second array of measurement indices and importance, for example, as follows: {{HL}, {M,H}, {L,L}, {H,L}, {M,L}, {L,H}, {H,L}, {H,L}}

FIG. 22C exemplarily illustrates a table 2204g showing an importance classification of multiple measurement indices related to an idea. Consider an example where a user enters a startup idea input “I want to build a cyber security platform” on the graphical user interface (GUI) 2505a shown in FIG. 25, which is rendered on a website or a mobile application deployed on a user device, for example, 101a, 101b, or 101c shown in FIG. 1. The data extraction module 108 shown in FIG. 1, extracts data from an internal database 2204a, a proprietary analyst report 2204b, public market research reports 2204c, and publications 2204d as exemplarily illustrated in FIG. 22B, and executes a machine learning model to determine, for example, that funding, competition, team commitment, and technology skills are important features for the cybersecurity technology, while market buzz, entrepreneur interest, geography risk, and domain skills are less important features for the cybersecurity technology. The idea analytics engine 109 shown in FIG. 1, then performs an importance classification to classify the importance of each of the measurement indices as high or low. As exemplarily illustrated in FIG. 22C, for the cybersecurity technology, the idea analytics engine 109 classifies the market buzz index as “low”, the investor interest index as “high”, the entrepreneur interest index as “low”, the competition index as “high”, the funding risk index as “high”, the geography risk index as “low”, the domain skill index as “low”, the commitment index as “high”, and (he technology skill index as “high”.

FIG. 22D exemplarily illustrates a table showing a weighted execution matrix 2205 used for computing the execution risk index. The weighted execution matrix 2205 plots the startup stages, for example, an “idea only” stage, a “product in development” stage, a “minimal viable product (MVP)” stage, and a “deployed to customers” stage, against the funding stages, for example, a “bootstrapped” stage, a “seed” stage, a “bridge” stage, and a “series A30 ” stage, and determines the execution risk for different combinations of the startup stages and the funding stages as disclosed in the detailed description of FIG. 23, for generating the weighted execution matrix 2205.

FIGS. 22E-22F exemplarily illustrate assignment of weightages from weightage assignment repositories 2207 and 2208 for generating the recommendation score using the execution risk index. FIG. 22E exemplarily illustrates the weightage assignment repository 2207 showing the weightages assigned to the computed measurement indices, where a weightage of “1” represents “low”, a weightage of “2” represents “medium”, and a weightage of “3” represents “high”. FIG. 22F exemplarily illustrates the weightage assignment repository 2208 showing the weightages assigned to the computed execution risk. The decision-based recommendation engine 110 shown in FIG. 1, increases the recommendation score by 10% if the execution risk is “low” and decreases the recommendation score by 10% if the execution risk is “high”. The decision-based recommendation engine 110 retains the same recommendation score if the execution risk is “medium”.

FIG. 23 exemplarily illustrates a flow diagram comprising the steps performed by the idea analytics engine 109 shown in FIG. 1, for generating the weighted execution matrix 2205 to compute the execution risk index. The data extraction module 108 shown in FIG. 1, connects 2301 to the organization database 118 of the system 100 shown in FIG. 1, containing a repository of details of multiple organizations founded in and after a particular year, for example, the year 2010, and extracts 2302 performance data of the organizations and their operating status as of the current year, for example, the year 2018. The idea analytics engine 109 analyzes 2303 the startup stage, the funding stage, and their operating status, for example, operating, or acquired, or closed, or initial public offering (IPO). The idea analytics engine 109 generates the weighted execution matrix 2205 exemplarily illustrated in FIG. 23, based on the analysis. In an example, for a particular startup stage and funding stage input by the user on the graphical user interface (GUI) 2505a shown in FIG. 25, if the operating status of more than 70% of the organizations is “closed”, then the execution risk index is deemed as high. If the operating status of 30% to 70% of the organizations is “closed”, then the execution risk index is deemed as medium. If the operating status of less than 30% of the organizations is “closed”, then the execution risk index is deemed as low.

FIGS. 24A-24B exemplarily illustrate a flow diagram showing an example of quantitatively analyzing an idea and generating a recommendation score 2406. Consider an example where a user logs into the idea analysis and recommendation platform (IARP) 104 shown in FIG. 1, via the graphical user interface (GUI) 2505a shown in FIG. 25, which is rendered on a website or a mobile application deployed on a user device, for example, 101a, 101b, or 101c shown in FIG. 1, and enters a startup idea input, for example, “I want to build a virtual reality platform for retailers in India”, a startup stage, for example, “Deployed to customers”, and a funding stage, for example, “Seed”, and selects a country through a dropdown list displayed on the GUI 2505a. The idea communication module 106 shown in FIG. 1, receives the startup idea input, the startup stage, the funding stage, and the selected country via the GUI 2505a. The context extraction module 107 executes natural language processing to extract the context, for example, the technology as “virtual reality” and the domain as “retail” from the startup idea input. The data extraction module 108 selectively extracts data sets associated with the extracted context of the startup idea input from at least one of the internal and external data sources 114 shown in FIG. 1. The idea analytics engine 109 shown in FIG. 1, then computes multiple measurement indices related to the startup idea as disclosed in the detailed descriptions of FIGS. 3-21. As exemplarily illustrated in FIG. 24A, the idea analytics engine 109 outputs the measurement indices, namely, the market buzz index, the investor interest index, the entrepreneur interest index, the competition index, the funding risk index, the geography risk index, the domain skill index, the commitment index, and the technology skill index as a first array 2401, for example, {H,H,M,L,L,L,H,L,H} respectively, where “H” represents “high”, “M” represents “medium”, and “L” represents “low”.

The idea analytics engine 109 then generates a weighted importance matrix 2402 as exemplarily illustrated in FIG. 24A and as disclosed in the detailed description of FIG. 22B. As exemplarily illustrated in FIG. 24A, the weighted importance matrix 2402 comprises weightages assigned to the measurement indices for multiple technologies, for example, augmented reality, virtual reality, cybersecurity, etc. In this example, for a startup idea in the virtual reality technology, the weighted importance matrix 2402 comprises the weightages {H,H,L,H,H,L,L,L,H}, assigned to the market buzz index, the investor interest index, the entrepreneur interest index, the competition index, the funding risk index, the geography risk index, the domain skill index, the commitment index, and the technology skill index respectively. The idea analytics engine 109 supplements the weightages assigned to the computed measurement indices based on the weighted importance matrix 2402. To define importance of each of the computed measurement indices, the idea analytics engine 109 applies the weighted importance matrix 2402 to the computed measurement indices to generate a second array 2403 of measurement indices and importance, for example, as {{HH}, {H,H}, {M,L}, {L,H}, {L,H}, {L,L}, {H,L}, {L,L}, {H,H}} as exemplarily illustrated in FIG. 24A. The idea analytics engine 109 then generates a weighted execution matrix 2404 exemplarily illustrated in FIG. 24B and as disclosed in the detailed description of FIG. 23, and uses the generated weighted execution matrix 2404 to compute an execution risk index 2405 based on the startup stage and the funding stage. As the user entered the startup stage as “deployed to customers” and the funding stage as “seed” on the GUI 2505a, the idea analytics engine 109 supplements the second array 2403 with the execution risk “H” as identified from the weighted execution matrix 2404. The idea analytics engine 109, thereby, outputs a third array of measurement indices, importance, and the execution risk, for example, as {{{HH}, {H,H}, {M,L}, {L,H}, {L,H}, {L,L}, {H,L}, {L,L}, {H,H}}, {H}}. The idea analytics engine 109 feeds the third array output to the decision-based recommendation engine 110 shown in FIG. 1.

The decision-based recommendation engine 110 generates a recommendation score 2406 using the computed execution risk index 2405 and the weightage assignment repositories 2207 and 2208 exemplarily illustrated in FIGS. 22E-22F respectively. In an embodiment, the decision-based recommendation engine 110 generates the recommendation score 2406 by combining predetermined weightages assigned to the computed measurement indices with the supplemented weightages obtained from the weight age assignment repository 2207 and a predetermined weightage assigned to the computed execution risk index 2405 obtained from the weightage assignment repository 2208. The decision-based recommendation engine 110 generates the recommendation score 2406 based on the weightages assigned and increases or decreases the recommendation score 2406 based on the execution risk index 2405. In an example, the decision-based recommendation engine 110 generates the recommendation score 2406 as follows. The decision-based recommendation engine 110 assigns the weightages obtained from the weightage assignment repository 2207 to the second array 2403 {{HH}, {H,H}, {M,L}, {L,H}, {L,H}, {L,L}, {H,L}, {L,L}, {H,H}}, combines or multiples the weightages, and performs a summation, that is, 3*3+3*3+2*1+1*3+1*3+1*1+3*1+1*1+3*3=9+9+2+3+3+1+3+1+9=40. Since the execution risk index 2405 is high, the decision-based recommendation engine 110 looks up the weightage assignment repository 2208 and decreases the recommendation score 2406 by 10%. The decision-based recommendation engine 110 therefore generates the recommendation score 2406 as 40−40*10/100=36. In an embodiment, if the recommendation score 2406 is in the top 10 percentile of all startup ideas pitched, the decision-based recommendation engine 110 generates a “high” recommendation for the startup idea. If the recommendation score 2406 is in the 11th to 60th percentile of all startup ideas pitched, the decision-based recommendation engine 110 generates a “medium” recommendation for the startup idea. If the recommendation score 2406 is in the 61st to 100th percentile of all startup ideas pitched, the decision-based recommendation engine 110 generates a “low” recommendation for the startup idea.

The IARP 104 shown in FIG. 1, implements one or more specific computer programs for quantitatively analyzing an idea, for example, a business idea of an individual or an organization, and generating decision-based contextual recommendations on the idea. The computer-implemented method disclosed herein improves the functionality of a computer and provides an improvement in data analytics related to quantitatively analyzing an idea and generating decision-based contextual recommendations on the idea as follows: On implementing the method disclosed herein, the idea analytics engine 109 of the IARP 104 shown in FIG. 1, computes multiple measurement indices related to the idea by performing a quantitative analysis of multiple data sets selectively extracted from one or more internal and external data sources 114, with reference to configurable thresholds and/or based on predetermined criteria. Moreover, the idea analytics engine 109 computes the execution risk index that determines capability of execution of the idea using the user-defined parameters, in communication with one or more of the internal data sources and external data sources. The idea analytics engine 109 supplements weightages assigned to the computed measurement indices based on the weighted importance matrix 2402 shown in FIG. 24A, and computes the execution risk index based on the weighted execution matrix, for example, 2205 shown in FIG. 22D or 2404 shown in FIG. 24B, using the user-defined parameters. Then, the decision-based recommendation engine 110 shown in FIG. 1, through the use of separate and autonomous computer programs, generates a recommendation score based on the computed measurement indices and the computed execution risk index for generating decision-based contextual recommendations to arrive at one or more decisions related to the idea. The decision-based recommendation engine HO generates the recommendation score by combining predetermined weightages assigned to the computed measurement indices with the supplemented weightages and a predetermined weightage assigned to the computed execution risk index.

The focus of the system 100 and the computer-implemented method disclosed herein is on an improvement to data analytics technology and computer functionalities for quantitatively analyzing an idea and generating decision-based contextual recommendations on the idea, and not on tasks for which a generic computer is used in its ordinary capacity. Rather, the system 100 and the computer-implemented method disclosed herein are directed to a specific improvement to the way the processors in the system 100 operate, embodied in, for example, extracting context from an idea input; selectively extracting data sets associated with the extracted context of the idea input, from one or more internal data sources and external data sources; computing multiple measurement indices comprising, for example, a market buzz index, a competition index, an investor interest index, an entrepreneur interest index, a domain skill index, a technology skill index, a commitment index, a funding risk index, and a geography risk index, related to the idea; computing an execution risk index that determines capability of execution of the idea using the user-defined parameters, in communication with one or more of the internal data sources and the external data sources; and generating a recommendation score based on the computed measurement indices and the computed execution risk index for generating decision-based contextual recommendations to arrive at one or more decisions related to the idea.

In the computer-implemented method disclosed herein, the design and the flow of data and interactions between the IARP 104 and the multiple internal and external data sources are deliberate, designed, and directed. The interactions between the IARP MM and the internal and external data sources allow the IARP 104 to quantitatively analyze an idea and generate decision-based contextual recommendations on the idea. The steps performed by the IARP 104 disclosed above require eight or more separate computer programs and subprograms, the execution of which cannot be performed by a person using a generic computer with a generic program. The steps performed by the IARP 104 disclosed above are tangible, provide useful results, and are not abstract. The hardware and software implementation of the system 100 disclosed herein comprising the IARP 104 and one or more processors is an improvement in computer related and data analytics technology.

FIG. 25 exemplarily illustrates an architectural diagram showing an implementation of the modules, for example, 106, 107, 108, 109, 110, 111, 112, 113, 127, 128, 120, 130, 131, etc., of the system 100, in a computer system 2501, for quantitatively analyzing an idea, for example, a business idea of an individual or an organization, and generating decision-based contextual recommendations on the idea. The system 100 disclosed herein comprises a non-transitory computer readable storage medium, for example, a memory unit 2503, for storing computer program instructions defined by the modules, for example, 106, 107, 108, 109, 110, 111, 112, 113, 127, 128, 129, 130, 131. etc., of the system 100, and at least one processor 2502 communicatively coupled to the non-transitory computer readable storage medium for executing the computer program instructions defined by the modules, for example, 106, 107, 108, 109, 110, 111, 112, 113, 127, 128, 129, 130, 131. etc., of the system 100. As used herein, “non-transitory computer-readable storage medium” refers to all computer-readable media, for example, non-volatile media, volatile media, and transmission media, except for a transitory, propagating signal. Non-volatile media comprise, for example, solid stale drives, optical discs or magnetic disks, and other persistent memory volatile media including a dynamic random-access memory (DRAM), which typically constitute a main memory. Volatile media comprise, for example, a register memory, a processor cache, a random-access memory (RAM), etc. Transmission media comprise, for example, coaxial cables, copper wire, fiber optic cables, modems, etc., including wires that constitute a system bus coupled to the processor 2502. The computer system 2501 is an electronic device, for example, one or more of a personal computer, a tablet computing device, a mobile computer, a portable computing device, a network-enabled computing device, an interactive network-enabled communication device, a server, a workstation, any other suitable computing equipment, combinations of multiple pieces of computing equipment, etc.

The computer system 2501 is programmable using a high-level computer programming language. In an embodiment, the IARP 104 shown in FIG. 1, is implemented on the computer system 2501 using programmed and purposeful hardware. The computer system 2501 communicates with one or more user devices, for example, 101a and 101b, external data sources 132, and third-party data sources 126, via the network 102, for example, a short-range network or a long-range network as disclosed in the detailed description of FIG. 1.

The memory unit 2503 is used for storing program instructions, applications, and data. The memory unit 2503 is, for example, a random-access memory (RAM) or another type of dynamic storage device that stores information and instructions for execution by the processor 2502. The memory unit 2503 also stores temporary variables and other intermediate information used during execution of the instructions by the processor 2502. The computer system 2501 further comprises a read only memory (ROM) or another type of static storage device that stores static information and instructions for the processor 2502. In an embodiment, the idea communication module 106, the context extraction module 107, the data extraction module 108, the idea analytics engine 109, the decision-based recommendation engine 110, the report generation module 111, the keyword recommendation module 112, the schedulers 113, an internal MySQL® primary database 127, an internal MySQL® failover database 128, an incremental backup database 129, a full backup database 130, and an offline report database 131 are stored in the memory unit 2503 of the computer system 2501. In an embodiment, the computer system 2501 connects to third-party data sources 126 or servers that provide metadata for updating the databases in the computer system 2501.

The processor 2502 is configured to execute the computer program instructions defined by the IARP 104. The processor 2502 refers to any one or more microprocessors, central processing unit (CPU) devices, finite state machines, computers, microcontrollers, digital signal processors, logic, a logic device, an user circuit, an application specific integrated circuit (ASIC), a field-programmable gate array (FPGA), a chip, etc., or any combination thereof, capable of executing computer programs or a series of commands, instructions, or state transitions. In an embodiment, the processor 2502 is implemented as a processor set comprising, for example, a programmed microprocessor and a math or graphics co-processor. The processor 2502 is selected, for example, from the Intel® processors such as the Itanium microprocessor, the Pentium® processors, the Intel® Core i5 processor, the Intel® Core i7 processor, etc., Advanced Micro Devices (AMD®) processors such as the Athlon® processor, UltraSPARC® processors, microSPARC® processors, hp® processors, International Business Machines (IBM®) processors such as the PowerPC® microprocessor, the MIPS® reduced instruction set computer (RISC) processor of MIPS Technologies, Inc., RISC based computer processors of ARM Holdings, Motorola® processors, Qualomm® processors, etc. The IARP 104 disclosed herein is not limited to employing a processor 2502. In an embodiment, the IARP 104 employs a controller or a microcontroller. The processor 2502 executes the modules, for example, 106, 107, 108, 109, 110, 111, 112, 113, 127, 128, 129, 130, 131, etc., of the IARP 104.

As exemplarily illustrated in FIG. 25, the computer system 2501 further comprises a data bus 2504, a display unit 2505, a network interface 2506, and common modules 2507. The data bus 2504 permits communications between the modules, for example, 2502, 2503, 2505, 2506, 2507, etc., of the computer system 2501. The display unit 2505, via graphical user interface (GUI) 2505a, displays information, display interfaces, user interface elements such as checkboxes, input text fields, etc., for example, for allowing a user to enter an idea input, select a location, enter user-defined parameters, etc., for quantitatively analyzing an idea and generating decision-based contextual recommendations on the idea. The computer system 2501 renders the GUI 2505a on the display unit 2505 for receiving idea inputs, location and other supplementary search criteria, user-defined parameters, descriptions of the ideas, etc., from multiple users for quantitatively analyzing an idea and generating decision-based contextual recommendations on the idea. The GUI 2505a comprises, for example, an online web interface, a web based downloadable application interface, a mobile based downloadable application interface, etc. The display unit 2505 displays the GUI 2505a.

The network interface 2506 enables connection of the computer system 2501 to the network 102. In an embodiment, the network interface 2506 is provided as an interface card also referred to as a line card. The network interface 2506 is, for example, one or more of an infrared interface, an interface implementing Wi-Fi® of Wi-Fi Alliance Corporation, a universal serial bus interface, a Fire Wire® interface of Apple Inc., an Ethernet interface, a frame relay interface, a cable interface, a digital subscriber line interface, a token ring interface, a peripheral controller interconnect interface, a local area network interface, a wide area network interface, interfaces using serial protocols, interfaces using parallel protocols, Ethernet communication interfaces, asynchronous transfer mode interfaces, a high speed serial interface, a fiber distributed data interface, interfaces based on transmission control protocol/internet protocol, interfaces based on wireless communications technology such as satellite technology, radio frequency technology, near field communication, etc. The common modules 2507 comprise, for example, input/output (I/O) controllers, input devices, output devices, fixed media drives such as hard drives, removable media drives for receiving removable media, etc. Computer applications and programs are used for operating the IARF 104. The programs are loaded onto a fixed media drive and into the memory unit 2503 of the computer system 2501 via the removable media drive. In an embodiment, the computer applications and programs are loaded into the memory unit 2503 directly via the network 102. The functions of the idea communication module 106, the context extraction module 107, the data extraction module 108, the idea analytics engine 109, the decision-based recommendation engine 110, the report generation module 111, the keyword recommendation module 112, and the schedulers 113 are disclosed in the detailed descriptions of FIGS. 1-23.

In an embodiment, the internal MySQL® primary database 127 stores multiple ideas, keywords related to the ideas, organizational intelligence information related to the idea, detailed information of organizations, related information, organization information, news, the technology and domain dictionary 504 shown in FIG. 5, investor information, entrepreneur information, user information, team member information, related professional network information, social media information, etc. In an embodiment, the information stored in the internal MySQL® primary database 127 is distributed across multiple databases, for example, the idea database 115, the keyword database 116, the related information database 117, the organization database 118, etc., exemplarily illustrated in FIG. 1. The internal MySQL® failover database 128 operates in a backup mode and performs the functions of the internal MySQL® primary database 127 when the internal MySQL® primary database 127 becomes unavailable due to a system failure or a scheduled downtime. The incremental backup database 129 stores incremental data during periodic incremental backups of the internal MySQL® primary database 127 performed by the IARP 104. The full backup database 130 backs up the data stored by the IARP 104. The offline report database 131 stores the analytics reports generated by the report generation module 111 in an offline mode. The analytics reports are accessible to user devices, for example, 101a and 101b, in an offline mode when the computer system 2501 is not connected to the network 102.

The modules, for example, 106, 107, 108, 109, 110, 111, 112, 113, 127, 128, 129, 130, 131, etc., of the IARP 104 are disclosed above as software implemented on the processor 2502. In an embodiment, the modules, for example, 106, 107, 108, 109, 110, 111, 112, 113, 127, 128, 129, 130, 131, etc., of the IARP 104 are implemented completely in hardware. In another embodiment, the modules, for example, the idea communication module 106, the context extraction module 107, the data extraction module 108, the idea analytics engine 109, the decision-based recommendation engine 110, the report generation module 111, the keyword recommendation module 112, and the schedulers 113 of the IARP 104 are implemented by logic circuits to carry out their respective functions disclosed above. In another embodiment, the IARP 104 is also implemented as a combination of hardware and software including multiple processors that are used to implement the modules, for example, 106, 107, 108, 109, 110, 111, 112, 113, 127, 128, 129, 130, 131, etc., of the IARP 104.

The processor 2502 executes an operating system selected, for example, from the Linux® operating system, the Unix® operating system, any version of the Microsoft® Windows® operating system, the Mac OS of Apple Inc., the IBM® OS/2, VxWorks® of Wind River Systems, Inc., QNX Neutrino® developed by QNX Software Systems Ltd., the Palm OS®, the Solaris operating system developed by Sun Microsystems, Inc., the Android® operating system of Google LLC, the Windows Phone® operating system of Microsoft Corporation, the BlackBerry® operating system of BlackBerry Limited, the iOS operating system of Apple Inc., the Symbian™ operating system of Symbian Foundation Limited, etc. The computer system 2501 employs the operating system for performing multiple tasks. The operating system is responsible for management and coordination of activities and sharing of resources of the computer system 2501. The operating system further manages security of the computer system 2501, peripheral devices connected to the computer system 2501, and network connections. The operating system employed on the computer system 2501 recognizes, for example, inputs provided by the user of the computer system 2501 using one of the input devices, the output devices, files, and directories stored locally on the fixed media drive. The operating system on the computer system 2501 executes different programs using the processor 2502. The processor 2502 and the operating system together define a computer platform for which application programs in high level programming languages are written.

The processor 2502 retrieves instructions defined by the idea communication module 106, the context extraction module 107, the data extraction module 108, the idea analytics engine 109, the decision-based recommendation engine 110, the report generation module 111, the keyword recommendation module 112, and the schedulers 113 of the IARP 104, for performing respective functions disclosed in the detailed descriptions of FIGS. 2-23. The processor 2502 retrieves instructions for executing the modules, for example, 106, 107, 108, 109, 110, 111, 112, 113, 127, 128, 129, 130, 131, etc., from the memory unit 2503. A program counter determines the location of the instructions in the memory unit 2503. The program counter stores a number that identifies the current position in the program of each of the modules, for example, 106, 107, 108, 109, 110, 111, 112, 113, 127, 128, 129, 130, 131, etc. The instructions fetched by the processor 2502 from the memory unit 2503 after being processed are decoded. The instructions are stored in an instruction register in the processor 2502. After processing and decoding, the processor 2502 executes the instructions, thereby performing one or more processes defined by those instructions.

At the time of execution, the instructions stored in the instruction register are examined to determine the operations to be performed. The processor 2502 then performs the specified operations. The operations comprise arithmetic operations and logic operations. The operating system performs multiple routines for performing a number of tasks required to assign the input devices, the output devices, and the memory unit 2503 for execution of the modules, for example, 106, 107, 108, 109, 110, in 112, 113, 127, 128, 129, 130, 131, etc. The tasks performed by the operating system comprise, for example, assigning memory to the modules, for example, 106, 107, 108, 109, 110, 111, 112, 113, 127, 128, 129, 130, 131, etc., and to data used by the IARP 104, moving data between the memory unit 2503 and disk units, and handling input/output operations. The operating system performs the tasks on request by the operations and after performing the tasks, the operating system transfers the execution control back to the processor 2502. The processor 2502 continues the execution to obtain one or more outputs.

For purposes of illustration, the detailed description refers to the modules 106, 107, 108, 109, 110, 111, 112, 113, 127, 128, 129, 130, 131, etc., of the IARP 104 being run locally as a single computer system 2501; however the scope of the system 100 and the computer-implemented method disclosed herein is not limited to the modules 106, 107, 108, 109, 110, 111, 112, 113, 127, 128, 129, 130, 131, etc., of the IARP 104 being run locally on the computer system 2501 via the operating system and the processor 2502, but may be extended to run remotely over the network 102 by employing a web browser and a remote server, a mobile phone, or other electronic devices. In an embodiment, one or more portions of the IARP 104 are distributed across one or more computer systems (not shown) coupled to the network 102.

The non-transitory computer-readable storage medium disclosed herein stores computer program codes comprising instructions executable by at least one processor 2502 for quantitatively analyzing an idea and generating decision-based contextual recommendations on the idea. The computer program codes implement the processes of various embodiments disclosed above and perform additional steps that may be required and contemplated for quantitatively analyzing an idea and generating decision-based contextual recommendations on the idea. When the computer executable instructions are executed by the processor 2502, the computer executable instructions cause the processor 2502 to perform the steps of the computer-implemented method for quantitatively analyzing an idea and generating decision-based contextual recommendations on the idea as disclosed in the detailed descriptions of FIGS. 2-23. In an embodiment, a single piece of computer program code comprising computer executable instructions performs one or more steps of the computer-implemented method disclosed in the detailed descriptions of FIGS. 2-23. The processor 2502 of the computer system 2501 retrieves these computer executable instructions and executes them.

A module, or an engine, or a unit as used herein refers to any combination of hardware, software, and/or firmware. As an example, a module, or an engine, or a unit may include hardware, such as a microcontroller, associated with a non-transitory computer-readable storage medium to store code adapted to be executed by the microcontroller. Therefore, references to a module, or an engine, or a unit, in one embodiment, refers to the hardware, which is specifically configured to recognize and/or execute the code to be held on a non-transitory computer-readable storage medium. Furthermore, in another embodiment, use of a module, or an engine, or a unit refers to the non-transitory computer-readable storage medium including the code, which is specifically adapted to be executed by the microcontroller to perform predetermined operations. In another embodiment, the term “module” or “engine” or “unit” refers to the combination of the microcontroller and the non-transitory computer-readable storage medium. Often module or engine boundaries that are illustrated as separate commonly vary and potentially overlap. For example, a module or an engine or a unit may share hardware, software, firmware, or a combination thereof, while potentially retaining some independent hardware, software, or firmware. In various embodiments, a module or an engine or a unit includes any suitable logic.

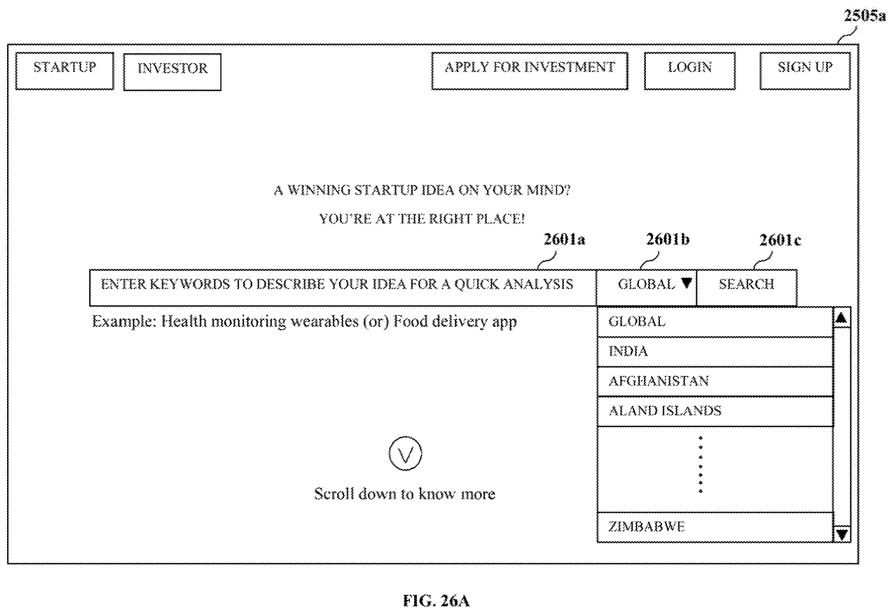

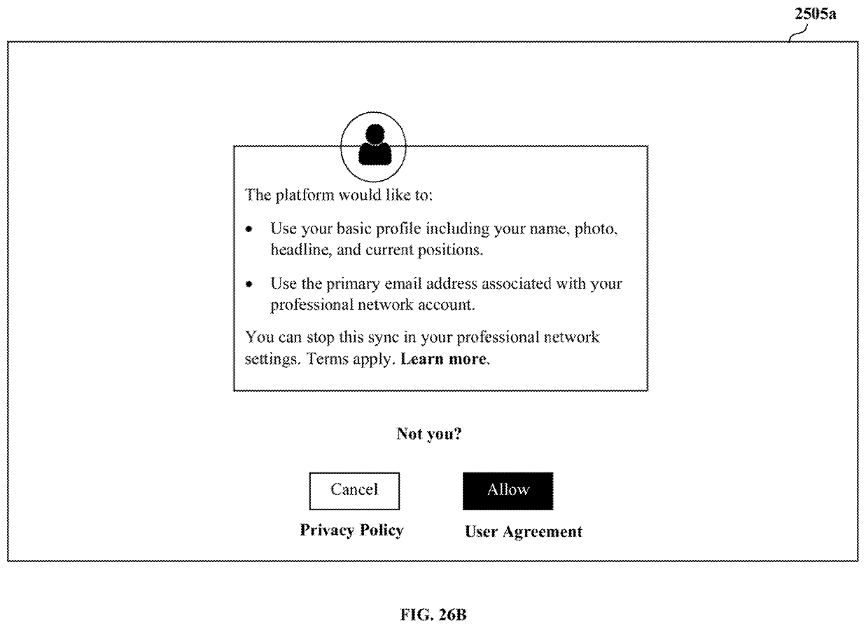

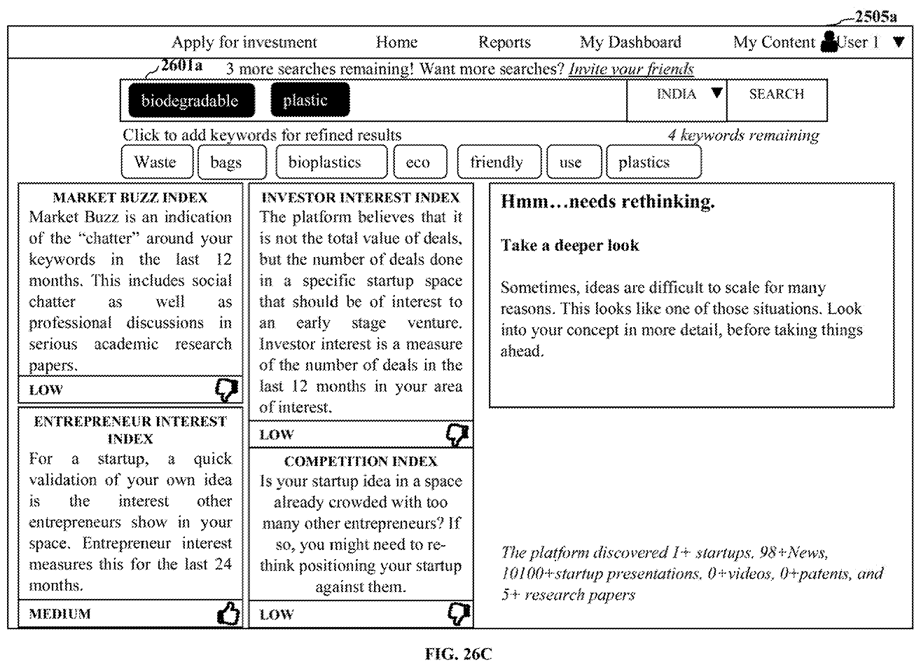

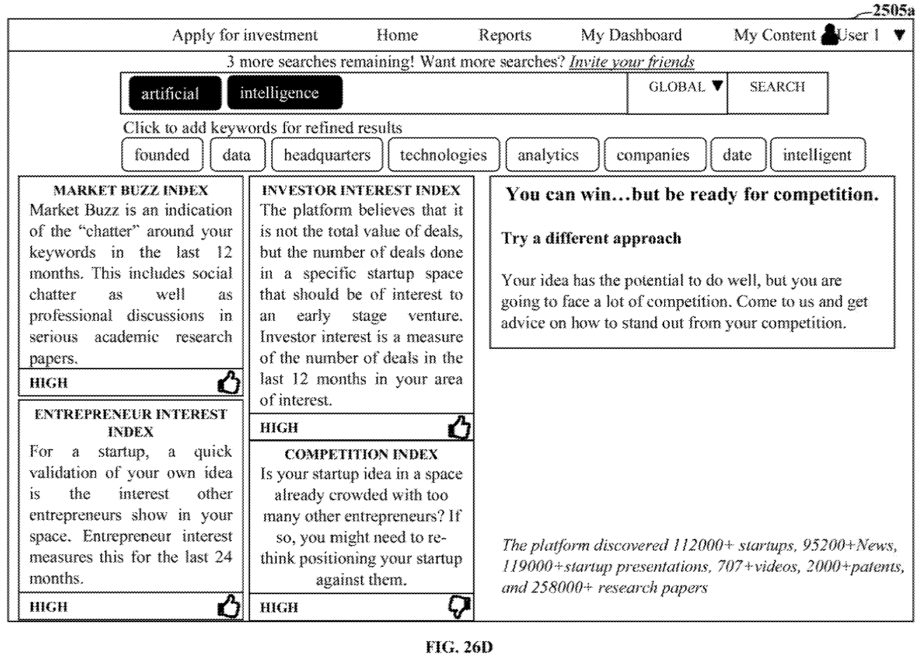

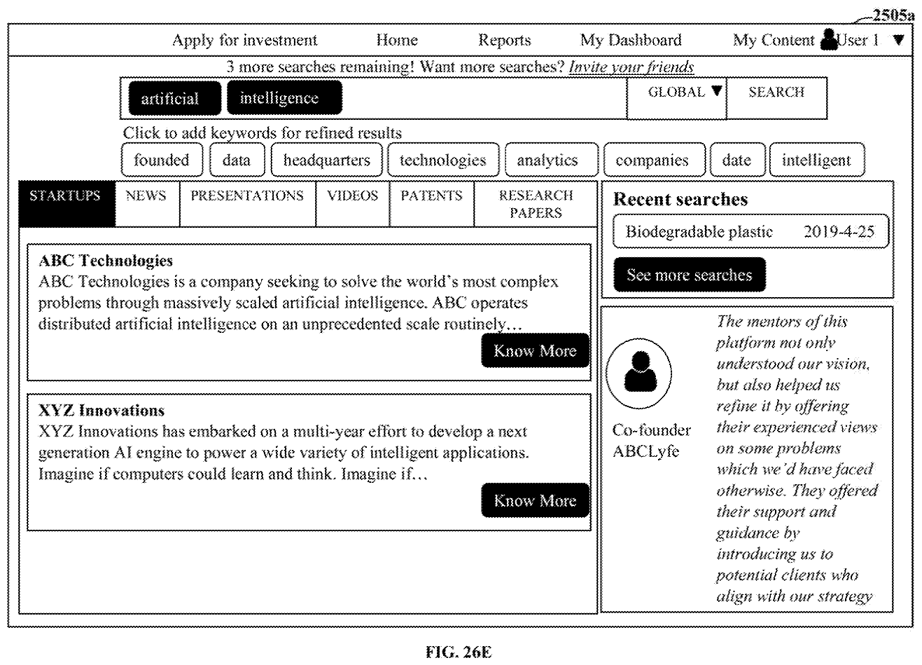

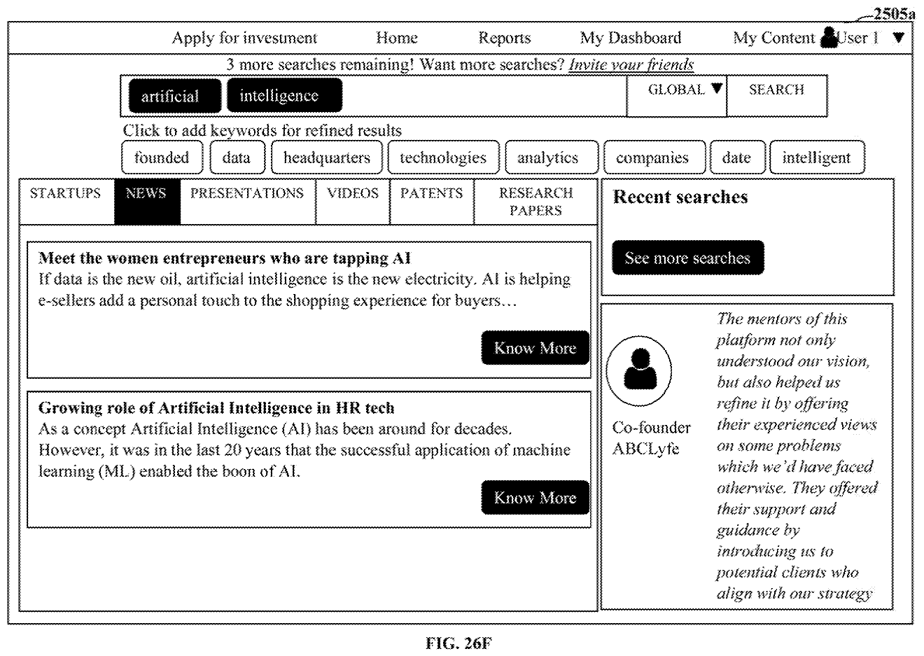

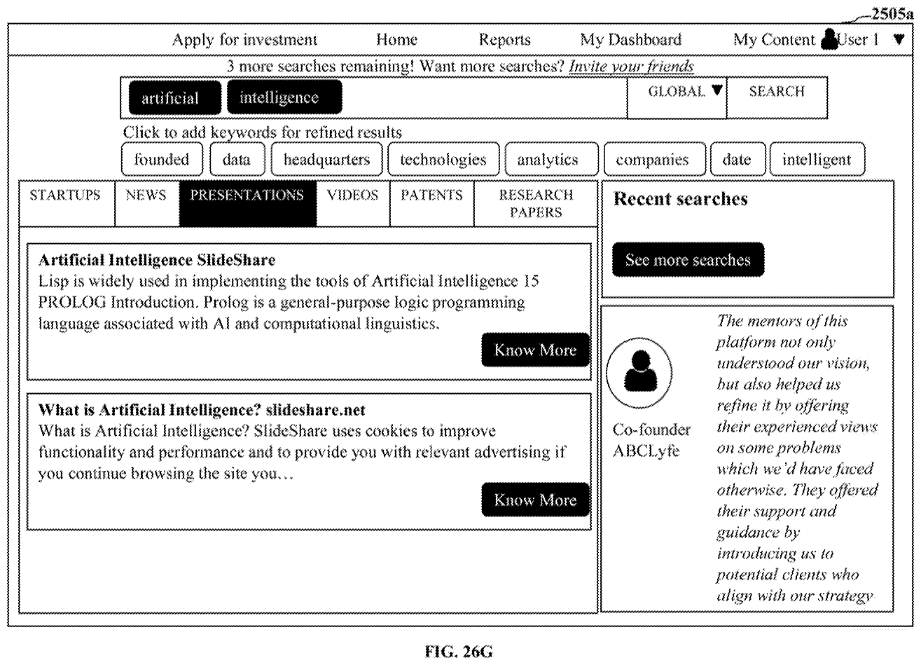

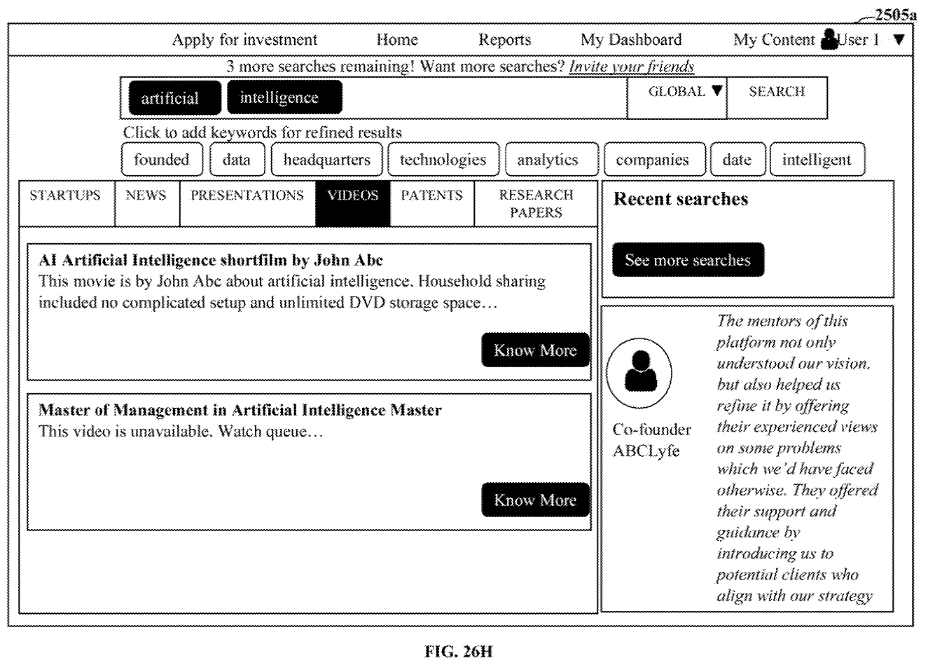

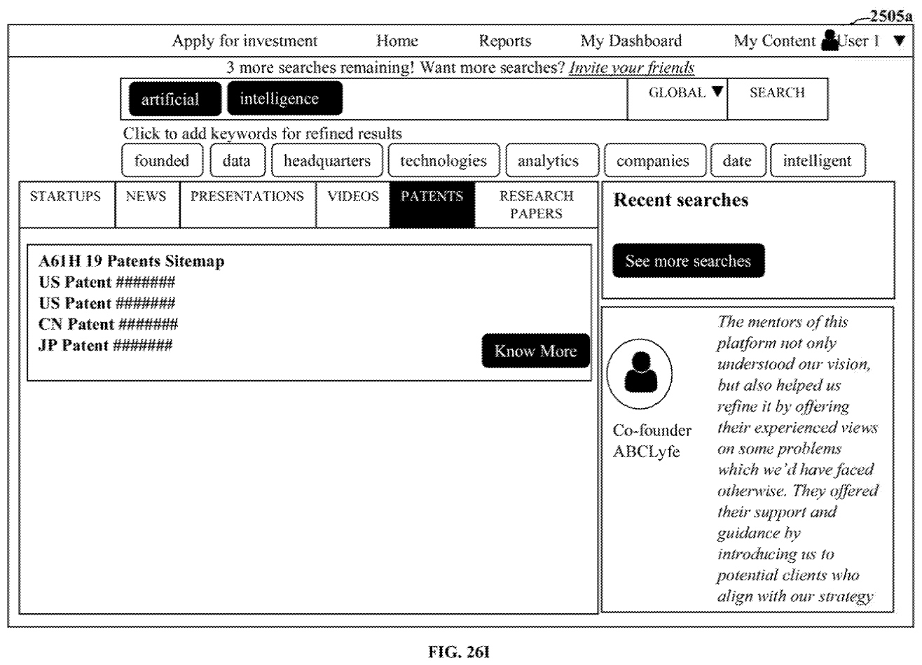

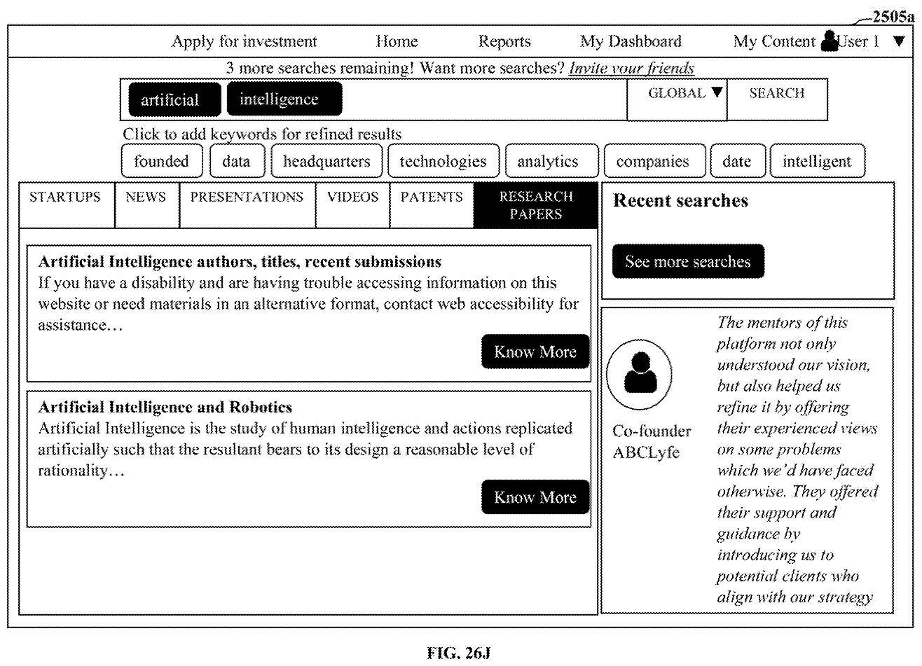

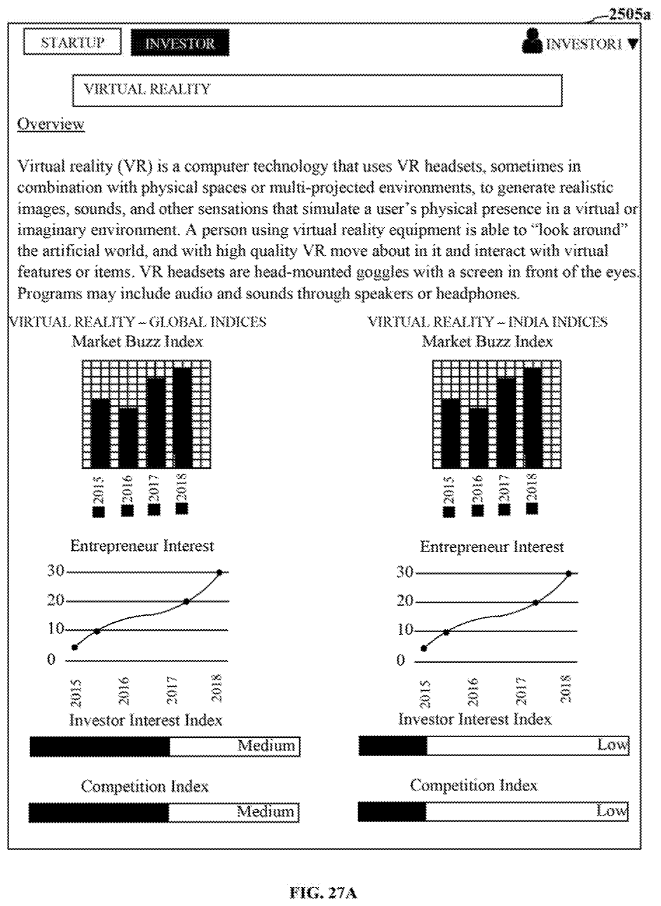

FIGS. 26A-26J exemplarily illustrate screenshots of a graphical user interface (GUI) 2505a provided by the system 100 shown in FIG. 1 and FIG. 25, for quantitatively analyzing an idea and generating decision-based contextual recommendations on the idea. When a user, for example, a startup founder, an investor, etc., accesses the idea analysis and recommendation platform (IARP) 104 shown in FIG. 1, the IARP 104 displays the GUI 2505a exemplarily illustrated in FIG. 26A. The IARP 104 provides a user interface element, for example, a text field 2601a on the GUI 2505a for allowing the user to enter keywords to describe an idea, for example, a startup idea or a business idea, for a quantitative analysis to be performed. The IARP 104 also provides a dropdown list 2601b on the GUI 2505a for allowing the user to select a location where the user wants to implement the idea. The user may select a particular country or request for a global analysis to be performed through the dropdown list 2601b. The user may then click on a search button 2601c provided on the GUI 2505a to initiate the search. In an embodiment, the IARP 104 provides a limited analytics report to users who are not registered with the IARP 104, by computing a predefined number of measurement indices, for example, a market buzz index, a competition index, an investor interest index, and an entrepreneur interest index related to the idea. The IARP 104 provides a detailed, analytics report to registered users of the IARP 104 by computing multiple measurement indices and generating decision-based contextual recommendations. Users may signup or log into the IARP 104 via the GUI 2505a exemplarily illustrated in FIG. 26B, using their professional network credentials, for example, Linkedin® credentials. In an embodiment, the IARP 104 prompts the users to provide information comprising, for example, name of organization, type of organization, type of industry, incorporation type, type of business, their difference amongst competitors, product information, summary of the organization, founded year, uniform resource locator (URL) of the organization's website, investor information, focus area, preferred startup, preferred market, team size, market size, risks, financial information, investment amount, preferred location, etc., on the GUI 2505a during registration.

After logging into the IARP 104 via the GUI 2505a, the user may then enter their ideas in a text field 2601a provided on the GUI 2505a Consider an example where a user enters an idea input by entering the keywords “biodegradable plastic” in the text field 2601a provided on the GUI 2505a as exemplarily illustrated in FIG. 26C. The keyword recommendation module 112 shown in FIG. 1, generates keywords related to the idea input, in communication with the keyword database 116 shown in FIG. 1, and renders the generated keywords on the GUI 2505a. For example, for the idea input “biodegradable plastic”, the keyword recommendation module 112 generates and displays the keywords “waste”, “bags”, “bioplastics”, etc, on the GUI 2505a as exemplarily illustrated in FIG. 26C. The idea analytics engine 109 shown in FIG. 1, computes the measurement indices, for example, the market buzz index, the competition index, the investor interest index, and the entrepreneur interest index related to “biodegradable plastic” based on a quantitative analysis of data sets selectively extracted from internal and external data sources, with reference to configurable thresholds and/or based on predetermined criteria. The data extraction module 108 extracts, for example, about 1 startup, about 98 news items, about 10100 startup presentations, 0 videos, 0 patents, and 5 research papers related to “biodegradable plastic”, based on which the idea analytics engine 109 computes the market buzz index as low, the competition index as low, the investor interest index as low, and the entrepreneur interest index as medium. The IARP 104 displays the computed measurement indices on the GUI 2505a as exemplarily illustrated in FIG. 26C. Using user-defined parameters such as startup stage and funding stage, the idea analytics engine 109 computes the execution risk index for biodegradable plastic as high. The decision-based recommendation engine HO shown in FIG. 1, generates a low recommendation score based on the computed measurement indices and the execution risk index and generates a decision-based contextual recommendation. The decision-based recommendation engine 110 displays the decision-based contextual recommendation requesting the user to rethink and redevelop the idea to proceed, on the GUI 2505a as exemplarily illustrated in FIG. 26C.

In another example, the user enters an idea input by entering the keywords “artificial intelligence” in the text field 2601a provided on the GUI 2505a as exemplarily illustrated in FIG. 26D. The keyword recommendation module 112 generates keywords related to the idea input, in communication with the keyword database 116 shown in FIG. 1, and renders the generated keywords on the GUI 2505a. For example, for the idea input “artificial intelligence”, the keyword recommendation module 112 generates and displays the keywords “analytics”, “founded”, “companies”, etc., on the GUI 2505a as exemplarily illustrated in FIG. 26D. The idea analytics engine 109 computes the measurement indices, for example, the market buzz index, the competition index, the investor interest index, and the entrepreneur interest index related to “artificial intelligence” based on a quantitative analysis of data sets selectively extracted from internal and external data sources, with reference to configurable thresholds and/or based on predetermined criteria. The data extraction module 108 extracts, for example, 112000+ startups, about 95200+ news items, 119000+ startup presentations, 707+ videos, 2000+ patents, and 258000+ research papers related to “artificial intelligence”, based on which the idea analytics engine 109 computes the market buzz index as high, the competition index as high, the investor interest index as high, and the entrepreneur interest index as high. The IARP 104 displays the computed measurement indices on the GUI 2505a as exemplarily illustrated in FIG. 26D. Using the user-defined parameters such as startup stage and funding stage, the idea analytics engine 109 computes the execution risk index for artificial intelligence as low. The decision-based recommendation engine 110 shown in FIG. 1, generates a high recommendation score based on the computed measurement indices and the execution risk index and generates a positive decision-based contextual recommendation. The decision-based recommendation engine 110 displays the positive decision-based contextual recommendation requesting the user to be ready for competition and providing advice on how to stand out from the competition, on the GUI 2505a as exemplarily illustrated in FIG. 26D.

The IARP 104 also displays the extracted information, for example, information on the startups, news items, presentations, videos, patents, research papers, etc., on the GUI 2505a as exemplarily illustrated in FIGS. 26E-26J. Furthermore, in an embodiment, the IARP 104 displays the recent searches performed by the user and testimonials on the GUI 2505a.

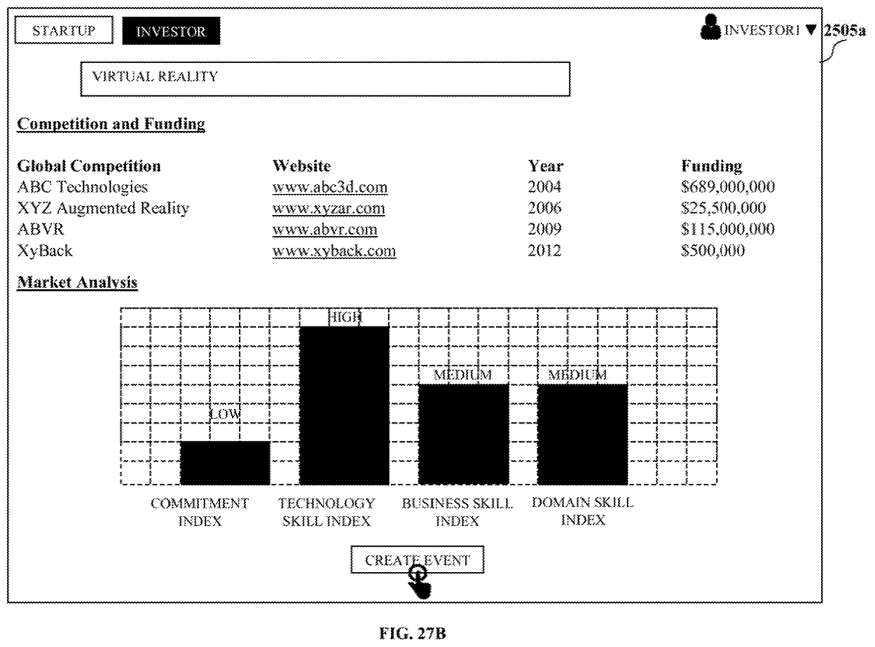

FIGS. 27A-27B exemplarily illustrate screenshots of the graphical user interface (GUI) 2505a provided by the system 100 shown in FIG. 1 and FIG. 25, showing exemplary representations of the measurement indices related to an idea computed by the idea analytics engine 109 shown in FIG 1 and FIG. 25. In an embodiment, the idea analysis and recommendation platform (IARP) 104 displays the computed measurement indices, for example, as bar graphs, line graphs, etc., on the GUI 2505a as exemplarily illustrated in FIGS. 27A-27B. The IARP 104 also displays results of a market analysis performed for a particular technology, for example, virtual reality, funding information, competition information, etc., on the GUI 2505a as exemplarily illustrated in FIG. 27B.

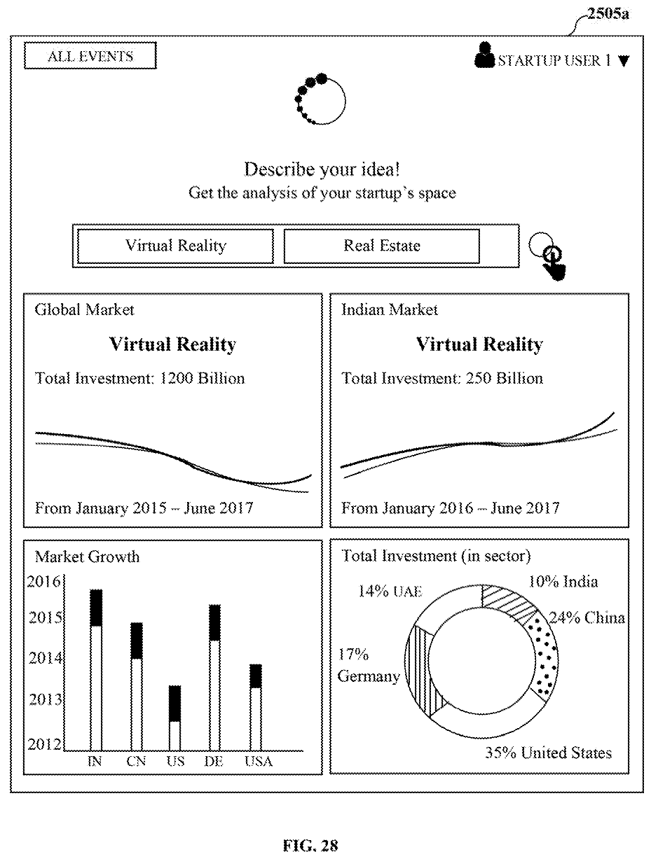

FIG. 28 exemplarily illustrates a screenshot of the graphical user interface (GUI) 2505a provided by the system 100 shown in FIG. 1 and FIG. 25, showing an exemplary representation of a comparative market analysis related to ideas, for example, virtual reality, real estate, etc., performed by the system 100. In an embodiment, the system 100 provides an idea sharing platform to allow users to share multiple ideas. The idea analysis and recommendation platform (IARP) 104 analyzes the shared ideas in communication with a database of current organizations and renders a shortlist of recommended organizations that implement the same ideas and alternative ideas in alternative domains based on user preferences. In an embodiment, the IARP 104 renders statistics of the quantitative analysis on a dashboard.

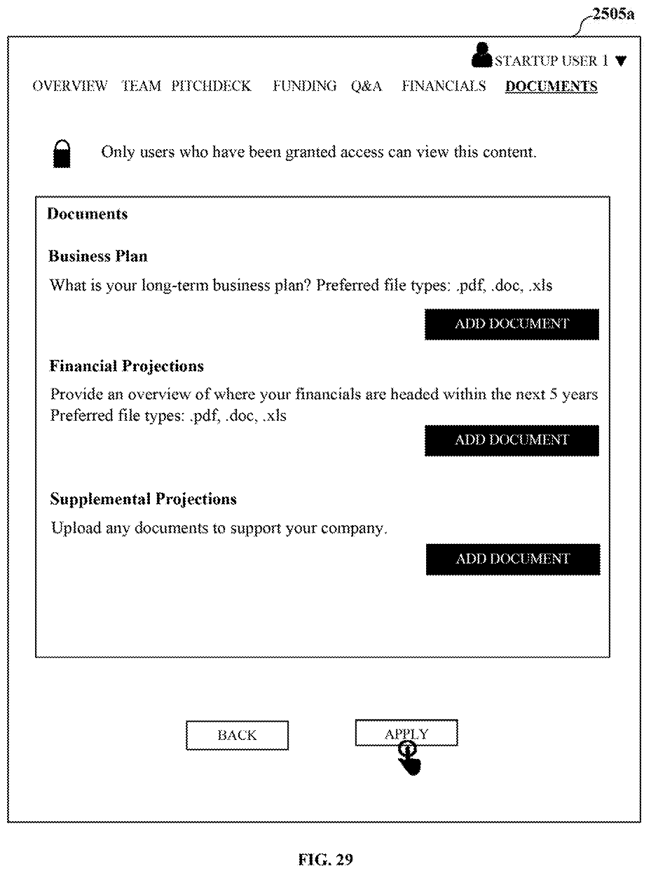

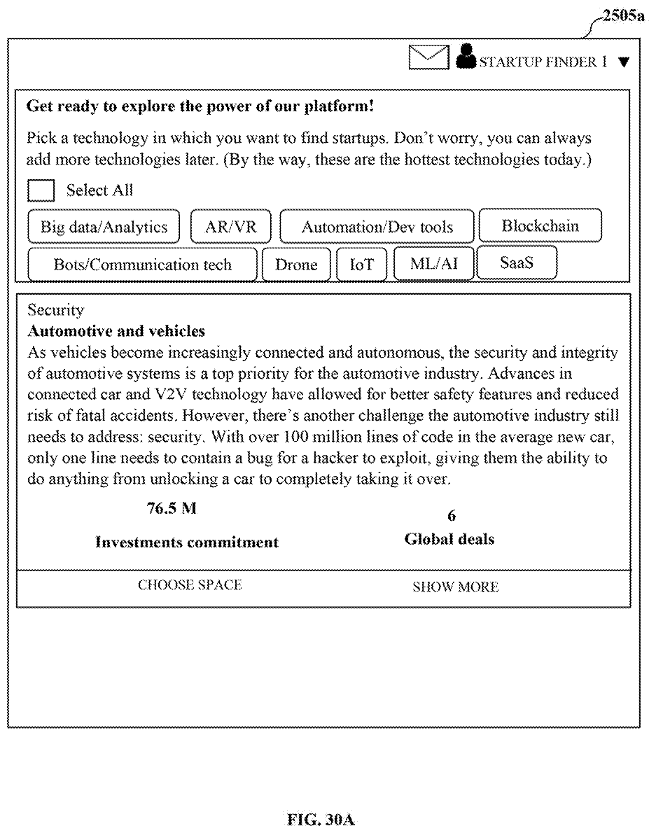

FIG. 29 exemplarily illustrates a screenshot of the graphical user interface (GUI) 2505a provided by the system 100 shown in FIG. 1 and FIG 25, for receiving information of an idea for quantitatively analyzing the idea and generating decision-based contextual recommendations on the idea. The idea analysis and recommendation platform (IARP) 104 shown in FIG. 1, allows a user to submit documents related lo their ideas via the GUI 2505a as exemplarily illustrated in FIG. 29. The user may submit documents containing, for example, business plans, financial projections, supplemental projections, etc., to the IARP 104 via the GUI 2505a. The IARP 104 stores the submitted documents in the internal database for performing the quantitative analysis of the ideas and generating decision-based contextual recommendations on the ideas.

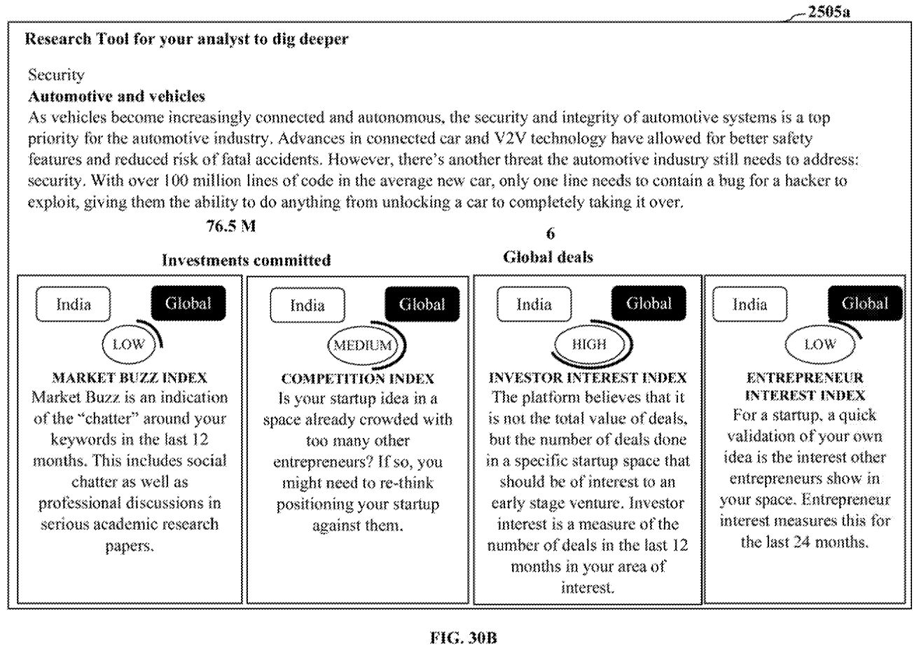

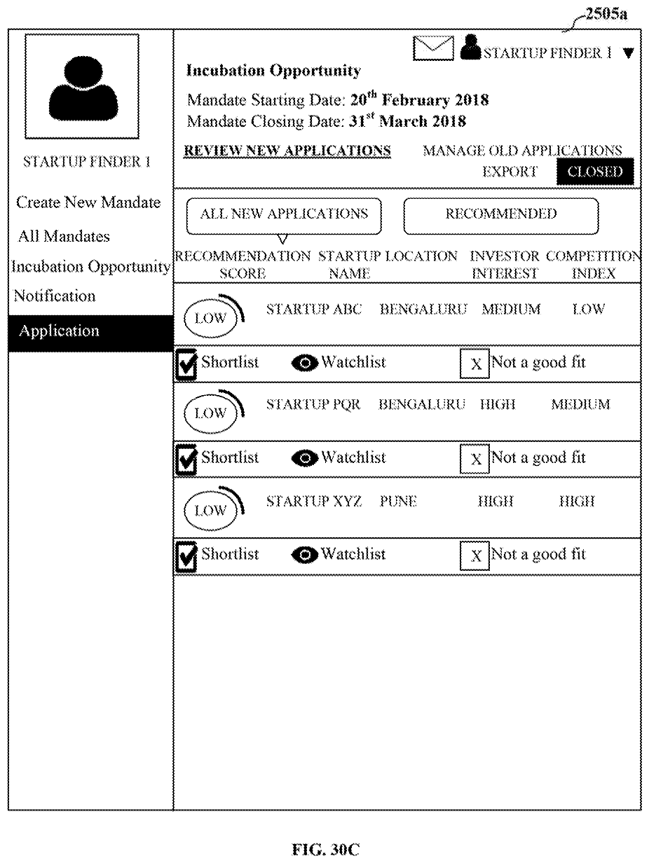

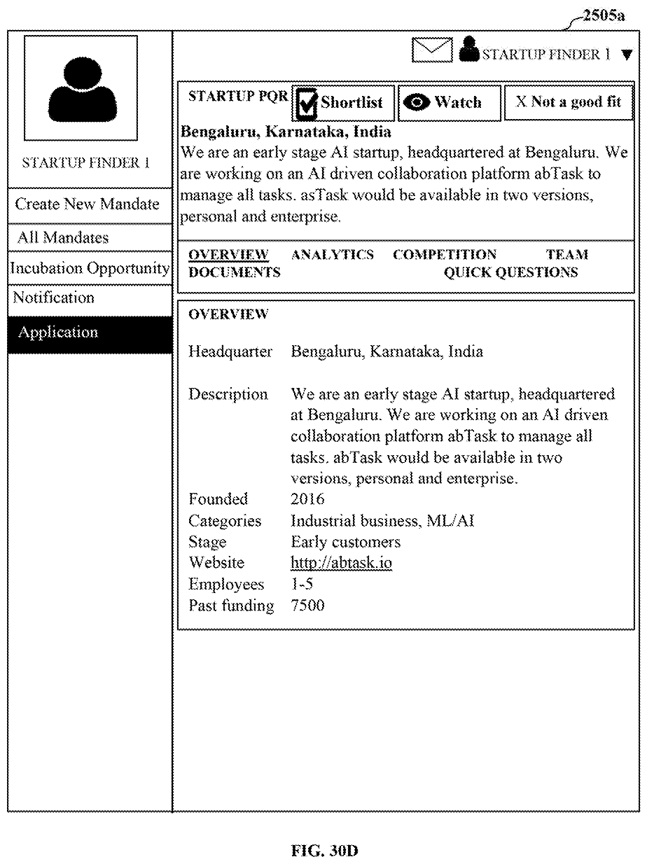

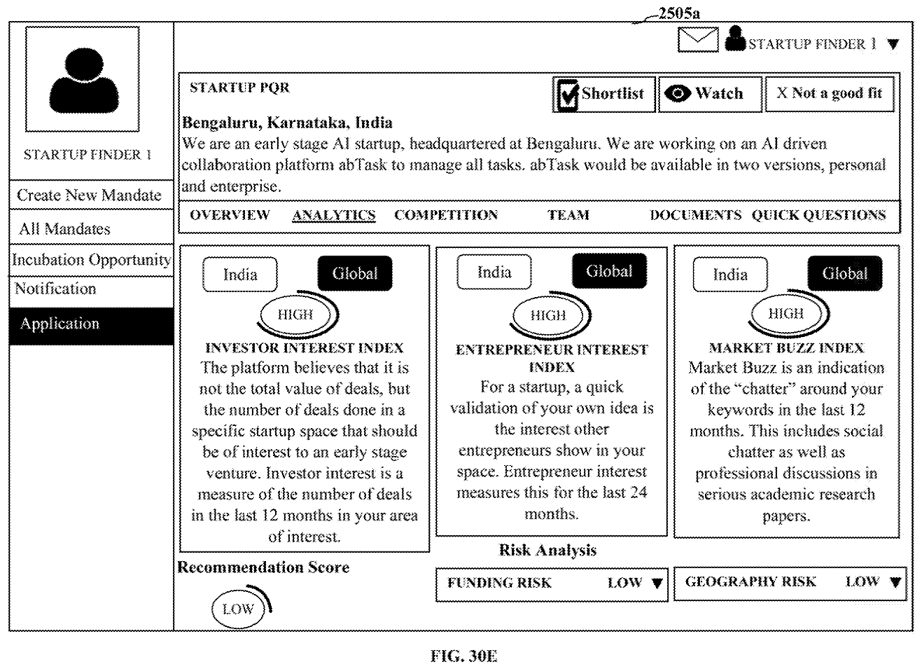

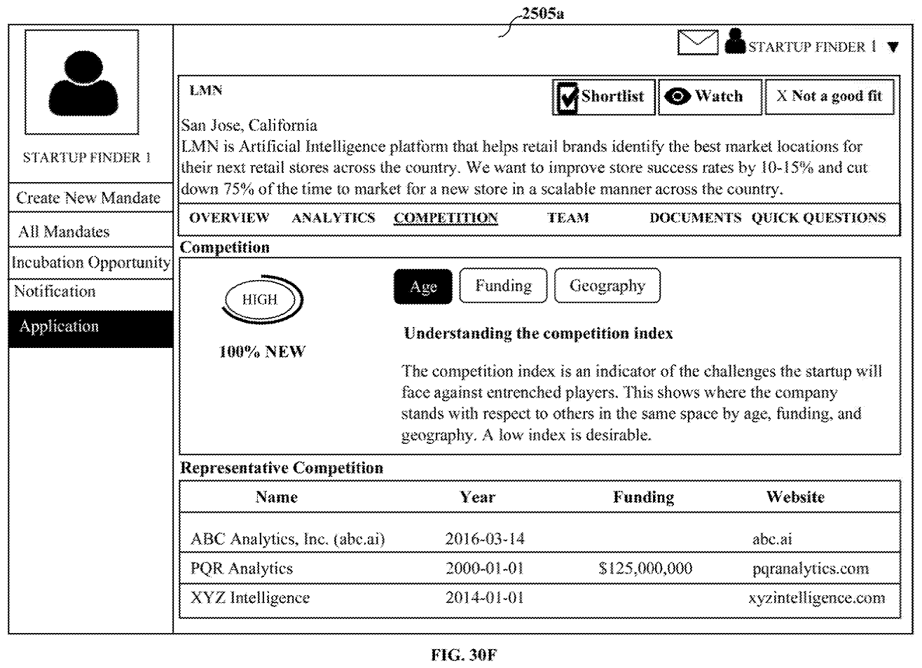

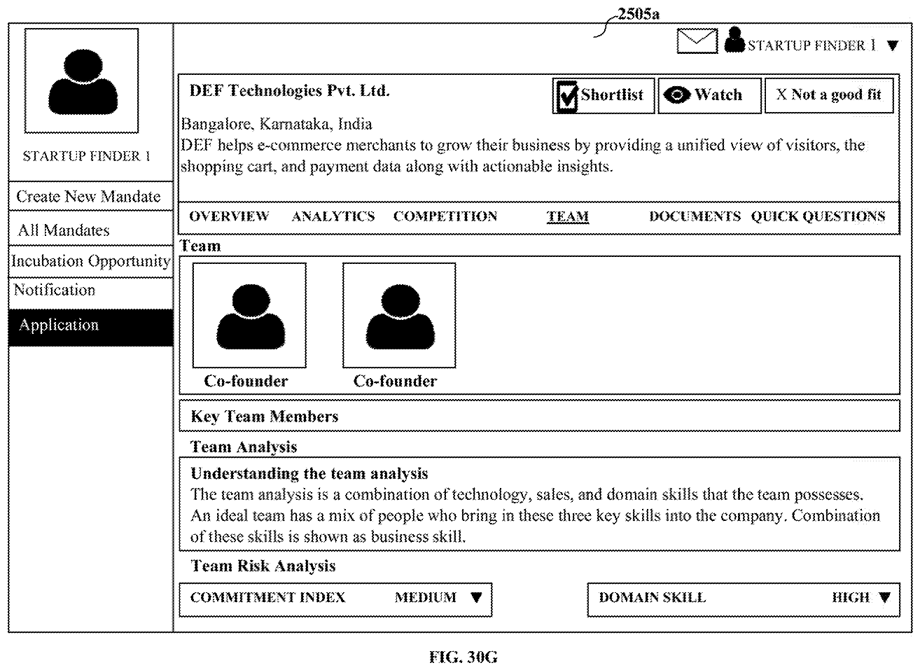

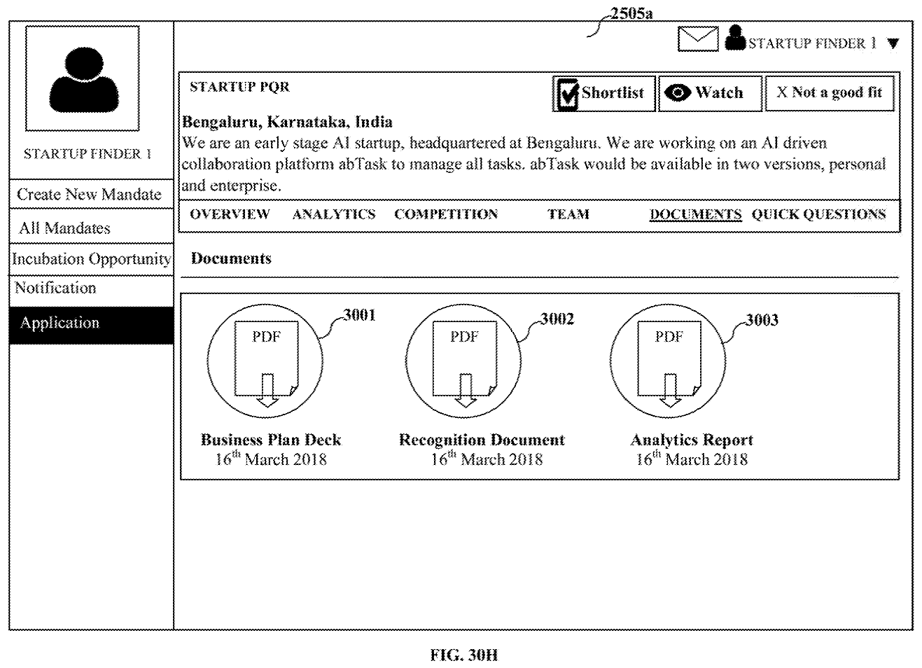

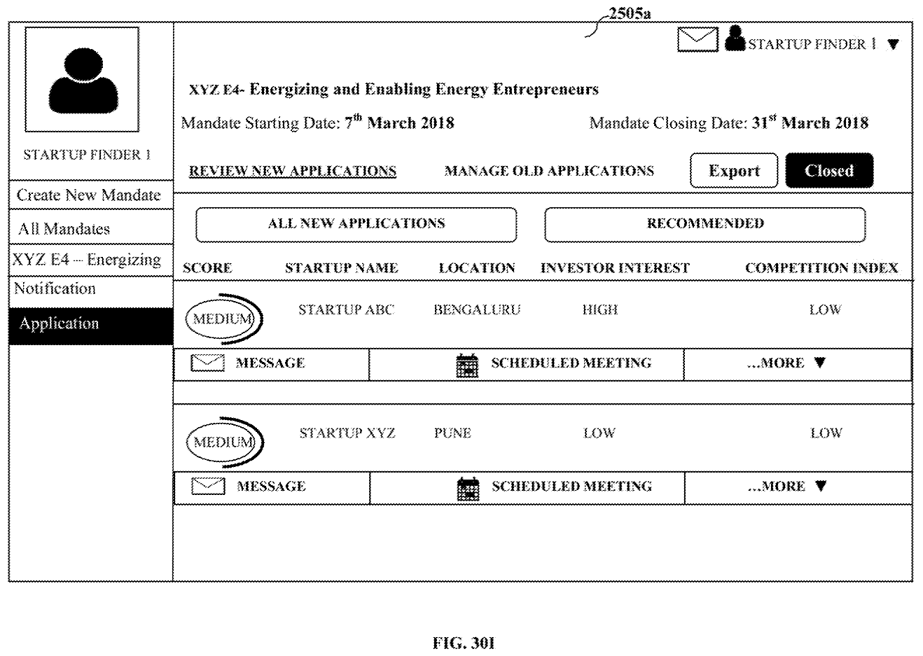

FIGS. 30A-30I exemplarily illustrate screenshots of the graphical user interface (GUI) 2505a provided by the system 100 shown in FIG. 1 and FIG. 25, for quantitatively analyzing an idea and generating decision-based contextual recommendations on the idea. In an embodiment, the idea analysis and recommendation platform (IARP) 104 shown in FIG. 1, can be used as a research tool that allows users, for example, investors and startup finders to search for startups in a particular technology or domain. These users may select one or more technologies of interest on the GUI 2505a and view a description of the selected technologies on the GUI 2505a as exemplarily illustrated in FIG. 30A. The IARP 104 displays descriptive information about a technology, for example, investments committed, number of global deals made, the measurement indices such as the market buzz index, the competition index, the investor interest index, the entrepreneur interest index, etc., computed by the idea analytics engine 109 shown in FIG. 1, on the GUI 2505a as exemplarily illustrated in FIG. 30B. The IARP 104 also allows users to review applications of startups that have applied for investment on the GUI 2505a as exemplarily illustrated in FIG. 30C. The IARP 104 displays the recommended startups and the new startups on the GUI 2505a. The IARP 104 displays, for example, the names of the startups, their locations, the measurement indices computed by the idea analytics engine 109 for their startup idea, and the recommendation score generated by the decision-based recommendation engine 110 shown in FIG. 1, in a dashboard view on the GUI 2505a as exemplarily illustrated in FIG 30C. The user may shortlist startups, track or monitor startups via a watchlist, or reject investing in the startups via the GUI 2505a exemplarily illustrated in FIG. 30C.

The IARP 104 allows the users to view a description of the startup as exemplarily illustrated in FIG. 30D. Moreover, the IARP 104 performs an analysis of the space related to a startup idea and allows the users to view analytics performed on the startup idea by displaying the computed measurement indices, for example, the investor interest index, the entrepreneur interest index, the market buzz index, the funding risk index, the geography risk index, and the recommendation score computed by the IARP 104 on the GUI 2505a as exemplarily illustrated in FIG. 30F. Furthermore, the IARP 104 performs an analysis of the global competition and displays the competition index that indicates where a startup stands with respect to other organizations in the same space by age, funding, and geography on the GUI 2505a as exemplarily illustrated in FIG. 30F. The IARP 104 also performs an analysis of a team associated with the startup, for example, using the commitment index, the domain skill index, and the technology skill index, and displays the results of the team analysis on the GUI 2505a as exemplarily illustrated in FIG. 30G. By analyzing the team, the IARP 104 determines whether the team members have the optimal combination of technology, sales and domain skills for executing an idea related to a startup. In an embodiment, the IARP 104 quantifies the skills of the team members of the organization, including their projected contribution to the organization, quality of their contribution, and projected result of the organizational intelligence.

The users may also download pitch decks and view documents 3001 and 3002 and the analytics reports 3003 generated by the IARP 104 via the GUI 2505a as exemplarily illustrated in FIG. 30H. The IARP 104 renders the analytics reports and other documents in a portable document format (PDF) for allowing the user to download them. The IARP 104 also displays a list of recommended startups on the GUI 2505a as exemplarily illustrated in FIG. 30I. The users may also interact with the entrepreneurs or founders of the startups, for example, by scheduling meetings with the founders or sending messages to the founders to obtain additional information of the startups via the GUI 2505a as exemplarily illustrated in FIG. 30I.

It is apparent in different embodiments that the various methods, algorithms, and computer readable programs disclosed herein are implemented on non-transitory computer readable storage media appropriately programmed for computing devices. The non-transitory computer readable storage media participate in providing data, for example, instructions that are read by a computer, a processor or a similar device. In different embodiments, the “non-transitory computer readable storage media” also refer to a single medium or multiple media, for example, a centralized database, a distributed database, and or associated caches and servers that store one or more sets of instructions that are read by a computer, a processor or a similar device. The “non-transitory computer readable storage media” also refer to any medium capable of storing or encoding a set of instructions for execution by a computer, a processor or a similar device and that causes a computer, a processor or a similar device to perform any one or more of the methods disclosed herein. Common forms of the non-transitory computer readable storage media comprise, for example, a floppy disk, a flexible disk, a hard disk, magnetic tape, a laser disc, a Blu-ray Disc® of the Blu-ray Disc Association, any magnetic medium, a compact disc-read only memory (CD-ROM), a digital versatile disc (DVD), any optical medium, a flash memory card, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read.

In an embodiment, the computer programs that implement the methods and algorithms disclosed herein are stored and transmitted using a variety of media, for example, the computer readable media in various manners. In an embodiment, hard-wired circuitry or custom hardware is used in place of, or in combination with, software instructions for implementing the processes of various embodiments. Therefore, the embodiments are not limited to any specific combination of hardware and software. The computer program codes comprising computer executable instructions can be implemented in any programming language. Examples of programming languages that can be used comprise C, C++, C#, Java®, JavaScript®, Fortran, Ruby, Perl®, Python®, Visual Basic®, hypertext preprocessor (PHP), Microsoft®.NET, Objective-C®, etc. Other object-oriented, functional, scripting, and/or logical programming languages can also be used. In an embodiment, the computer program codes or software programs are stored on or in one or more mediums as object code. In another embodiment, various aspects of the system 100 and the computer-implemented method disclosed herein are implemented in a non-programmed environment comprising documents created, for example, in a hypertext markup language (HTML), an extensible markup language (XML), or other format that render aspects of the graphical user interface (GUI) 2505a shown in FIG. 25 and FIGS. 26A-30I, or perform other functions, when viewed in a visual area or a window of a browser program. In another embodiment, various aspects of the system 100 and the computer-implemented method disclosed herein are implemented as programmed elements, or non-programmed elements, or any suitable combination thereof.

Where databases are described such as the idea database 115, the keyword database 116, the related information database 117, and the organization database 118 shown in FIG. 1, the internal MySQL® primary database 127, the internal MySQL® failover database 128, the incremental backup database 129, the full backup database 130, and the offline report database 131 shown in FIG. 25, it will be understood by one of ordinary skill in the art that (i) alternative database structures to those described may be employed, and (ii) other memory structures besides databases may be employed. Any illustrations or descriptions of any sample databases disclosed herein are illustrative arrangements for stored representations of information. In an embodiment, any number of other arrangements are employed besides those suggested by tables illustrated in the drawings or elsewhere. Similarly, any illustrated entries of the databases represent exemplary information only; one of ordinary skill in the art will understand that the number and content of the entries can be different from those disclosed herein. In another embodiment, despite any depiction of the databases as tables, other formats including relational databases, object-based models, and/or distributed databases are used to store and manipulate the data types disclosed herein. Object methods or behaviors of a database can be used to implement various processes such as those disclosed herein. In another embodiment, the databases are in a known manner, stored locally or remotely from a device that accesses data in such a database. In embodiments where there are multiple databases in the system 100, the databases are integrated to communicate with each other for enabling simultaneous updates of data linked across the databases, when there are any updates to the data in one of the databases.

The system 100 and the computer-implemented method disclosed herein can be configured to work in a network environment comprising one or more computers that are in communication with one or more devices via a network. In an embodiment, the computers communicate with the devices directly or indirectly, via a wired medium or a wireless medium such as the Internet, a local area network (LAN), a wide area network (WAN) or the Ethernet, a token ring, or via any appropriate communications mediums or combination of communications mediums. Each of the devices comprises processors, examples of which are disclosed above, that arc adapted lo communicate with the computers. In an embodiment, each of the computers is equipped with a network communication device, for example, a network interface card, a modem, or other network connection device suitable for connecting to a network. Each of the computers and the devices executes an operating system, examples of which are disclosed above. While the operating system may differ depending on lite type of computer, the operating system provides the appropriate communications protocols to establish communication links with the network. Any number and type of machines may be in communication with the computers.

The system 100 and the computer-implemented method disclosed herein are not limited to a particular computer system platform, processor, operating system, or network. In an embodiment, one or more embodiments of the system 100 and the computer-implemented method disclosed herein are distributed among one or more computer systems, for example, servers configured to provide one or more services to one or more client computers, or to perform a complete task in a distributed system. For example, one or more embodiments of the system 100 and the computer-implemented method disclosed herein are performed on a client-server system that comprises components distributed among one or more server systems that perform multiple functions according to various embodiments. These components comprise, for example, executable, intermediate, or interpreted code, which communicate over a network using a communication protocol. The system 100 and the computer-implemented method disclosed herein are not limited to be executable on any particular system or group of systems, and are not limited to any particular distributed architecture, network, or communication protocol.

The foregoing examples and illustrative implementations of various embodiments have been provided merely for explanation and are in no way to be construed as limiting of the system 100 and the computer-implemented method disclosed herein. While the system 100 and the computer-implemented method have been described with reference to various embodiments, illustrative implementations, drawings, and techniques, it is understood that the words, which have been used herein, are words of description and illustration, rather than words of limitation. Furthermore, although the system 100 and the computer-implemented method have been described herein with reference to particular means, materials, techniques, and embodiments, the system 100 and the computer-implemented method are not intended to be limited to the particulars disclosed herein, rather, the system 100 and the computer-implemented method extend to all functionally equivalent structures, methods and uses, such as are within the scope of the appended claims. While multiple embodiments are disclosed, it will be understood by those skilled in the an, having the benefit of the teachings of this specification, that the system 100 and the computer-implemented method disclosed herein are capable of modifications and other embodiments may be effected and changes may be made thereto, without departing from the scope and spirit of the system 100 and the computer-implemented method disclosed herein.

What is claimed is:

1. A system for quantitatively analyzing an idea and generating decision-based contextual recommendations on the idea, the system comprising:
a non-transitory computer readable storage medium for storing computer program instructions defined by modules of the system; and
at least one processor communicatively coupled to the non-transitory computer readable storage medium for executing the computer program instructions defined by the modules of the system, the modules of the system comprising:
an idea communication module configured to receive an idea input and user-defined parameters from a user device;
a context extraction module configured to extract context from the received idea input;
a data extraction module configured to selectively extract data sets associated with the extracted context of the received idea input, from at least one of a plurality of internal data sources and external data sources;
an idea analytics engine configured to compute a plurality of measurement indices related to an idea defined in the received idea input by performing a quantitative analysis of the selectively extracted data sets with reference to configurable thresholds and/or based on predetermined criteria, wherein the plurality of measurement indices comprises a market buzz index, a competition index, an investor interest index, an entrepreneur interest index, a domain skill index, a technology skill index, a commitment index, a funding risk index, and a geography risk index;
the idea analytics engine further configured to compute an execution risk index that determines capability of execution of the idea using the user-defined parameters, in communication with one or more of the plurality of internal data sources and external data sources; and
a decision-based recommendation engine configured to generate a recommendation score based on the computed measurement indices and the computed execution risk index for generating decision-based contextual recommendations to arrive at one or more decisions related to the idea.

2. The system according to claim 1, wherein the idea relates to a business idea of one of an individual and an organization, and wherein the user-defined parameters comprise a stage related to the idea, and wherein the context of the received idea input comprises at least one of domain and technology related to the idea.

3. The system according to claim 1, wherein the plurality of internal data sources and external data sources comprises global databases of existing ideas and organizational intelligence, cloud databases, partner databases, research databases, publication databases, web sources, a database of organizations that stores information about organizations related to ideas, an internal database of ideas and organizational intelligence, a related information database, a keyword database, search engine databases, professional network databases, and social media databases.

4. The system according to claim 1, wherein, for the generation of the recommendation score, the idea analytics engine is configured to supplement weightages assigned to the computed measurement indices based on a weighted importance matrix and compute the execution risk index based on a weighted execution matrix using the user-defined parameters, and wherein the decision-based recommendation engine is configured to generate the recommendation score by combining predetermined weightages assigned to the computed measurement indices with the supplemented weightages and a predetermined weightage assigned to the computed execution risk index

5. The system according to claim 4, wherein the idea analytics engine is configured to generate the weighted importance matrix and the weighted execution matrix by executing a machine learning model on selective data sets extracted from at least one of the plurality of internal data sources and external data sources based on one of the extracted context of the received idea input, the user-defined parameters, and any combination thereof, and wherein the user-defined parameters comprise a stage related to the idea.

6. The system according to claim 1, wherein the data sets comprise data related to one of organizational intelligence information, profile information, work history, technology expertise, technical experience, domain experience, efficiency of each team member of an organization, deficiency of the each team member of the organization, performance indicators that indicate performance of the organization, professional network data, social media data, search engine data, media content, market data, research data, company data, founding data, funding data, entrepreneurial data, technology data, domain data, geographical data, revenue data, and any combination thereof.

7. The system according to claim 1, wherein the commitment index measures commitment of a team to execute the idea, and wherein the idea analytics engine is configured to compute the commitment index using user information associated with a user of the user device, member information of team members linked to the user, and information of an organization of the user and the team members, and wherein the idea analytics engine is configured to perform an analysis of a team associated with the organization using the commitment index and at least one of the computed measurement indices, wherein the at least one of the computed measurement indices is selected from the domain skill index and the technology skill index.

8. The system according to claim 1, wherein the modules of the system further comprise a report generation module configured to generate an analytics report comprising a graphical visualization of a description of the idea received from the user device, a description of the quantitative analysis of the received idea input, the generated recommendation score, and the generated decision-based contextual recommendations related to the idea, and wherein the generated decision-based contextual recommendations comprise competition information, team commitment information, suggested actions, trends associated with the idea, and content related to the idea, and wherein the content comprises patent information, research paper information, news, media content, and entrepreneurial venture information related to the idea, and wherein the generated decision-based contextual recommendations and the generated analytics report are rendered on a graphical user interface displayed on the user device.

9. The system according to claim 1, wherein the modules of the system further comprise a keyword recommendation module configured to generate keywords related to the received idea input, in communication with a keyword database, and render the generated keywords on a graphical user interface displayed on the user device.

10. The system according to claim 1, wherein the modules of the system further comprise one or more schedulers configured to track organizations locally and globally, and periodically update the plurality of internal data sources, in communication with one or more of the plurality of external data sources.

11. A computer-implemented method comprising instructions stored on a non-transitory computer readable storage medium and executed on a hardware processor provided in a computer system for quantitatively analyzing an idea and generating decision-based contextual recommendations on the idea, the computer-implemented method comprising the steps of:
receiving, by an idea communication module, an idea input and user-defined parameters from a user device;
extracting, by a context extraction module, context from the received idea input; selectively extracting, by a data extraction module, data sets associated with the extracted context of the received idea input, from at least one of a plurality of internal data sources and external data sources;
computing, by an idea analytics engine, a plurality of measurement indices related to an idea defined in the received idea input by performing a quantitative analysis of the selectively extracted data sets with reference to configurable thresholds and/or based on predetermined criteria, wherein the plurality of measurement indices comprises a market buzz index, a competition index, an investor interest index, an entrepreneur interest index, a domain skill index, a technology skill index, a commitment index, a funding risk index, and a geography risk index;
computing, by the idea analytics engine, an execution risk index that determines capability of execution of the idea using the user-defined parameters, in communication with one or more of the plurality of internal data sources and external data sources; and generating, by a decision-based recommendation engine, a recommendation score based on the computed measurement indices and the computed execution risk index for generating decision-based contextual recommendations to arrive at one or more decisions related to the idea.

12. The computer-implemented method according to claim 11, further comprising the step of receiving, by the idea communication module, supplementary search criteria for analyzing the idea input, wherein the supplementary search criteria comprise location associated with the idea input for the quantitative analysis of the idea input.

13. The computer-implemented method according to claim 11, wherein the idea relates to a business idea of one of an individual and an organization, and wherein the user-defined parameters comprise a stage related to the idea, and wherein the context of the received idea input comprises at least one of domain and technology related to the idea.

14. The computer-implemented method according to claim 11, wherein the plurality of internal data sources and external data sources comprises global databases of existing ideas and organizational intelligence, cloud databases, partner databases, research databases, publication databases, web sources, a database of organizations that stores information about organizations related to ideas, an internal database of ideas and organizational intelligence, a related information database, a keyword database, search engine databases, professional network databases, and social media databases.

15. The computer-implemented method according to claim 11, wherein the generation of the recommendation score comprises:
supplementing, by the idea analytics engine, weightages assigned to the computed measurement indices based on a weighted importance matrix;
computing, by the idea analytics engine, the execution risk index based on a weighted execution matrix; and
generating, by the decision-based recommendation engine, the recommendation score by combining predetermined weightages assigned to the computed measurement indices with the supplemented weightages and a predetermined weightage assigned to the computed execution risk index.

16. The computer-implemented method according to claim 15, wherein the weighted importance matrix and the weighted execution matrix are generated by the idea analytics engine by executing a machine learning model on selective data sets extracted from at least one of the plurality of internal data sources and external data sources based on one of the extracted context of the received idea input, the user-defined parameters, and any combination thereof, and wherein the user-defined parameters comprise a stage related to the idea.

17. The computer-implemented method according to claim 11, wherein the data sets comprise data related to one of organizational intelligence information, profile information, work history, technology expertise, technical experience, domain experience, efficiency of each team member of an organization, deficiency of the each team member of the organization, performance indicators that indicate performance of the organization, professional network data, social media data, search engine data, media content, market data, research data, company data, founding data, funding data, entrepreneurial data, technology data, domain data, geographical data, revenue data, and any combination thereof.

18. The computer-implemented method according to claim 11, wherein the commitment index measures commitment of a team to execute the idea, and wherein the commitment index is computed, by the idea analytics engine, using user information associated with a user of the user device, member information of team members linked to the user, and information of an organization of the user and the team members, and wherein the idea analytics engine is configured to perform an analysis of a team associated with the organization using the commitment index and at least one of the computed measurement indices, wherein the at least one of the computed measurement indices is selected from the domain skill index and the technology skill index.

19. The computer-implemented method according to claim 11, further comprising the step of generating, by a report generation module, an analytics report comprising a graphical visualization of a description of the idea received from the user device, a description of the quantitative analysis of the received idea input, the generated recommendation score, and the generated decision-based contextual recommendations related to the idea, and wherein the generated decision-based contextual recommendations comprise competition information, team commitment information, suggested actions, trends associated with the idea, and content related to the idea, and wherein the content comprises patent information, research paper information, news, media content, and entrepreneurial venture information related to the idea, and wherein the generated decision-based contextual recommendations and the generated analytics report are rendered on a graphical user interface displayed on the user device.

20. A non-transitory computer-readable storage medium having embodied thereon, computer program codes comprising instructions executable by at least one processor for quantitatively analyzing an idea and generating decision-based contextual recommendations on the idea, the instructions when executed by the processor cause the processor to:
receive an idea input and user-defined parameters from a user device;
extract context from the received idea input;
selectively extract data sets associated with the extracted context of the received idea input, from at least one of a plurality of internal data sources and external data sources;
compute a plurality of measurement indices related to an idea defined in the received idea input by performing a quantitative analysis of the selectively extracted data sets with reference to configurable thresholds and/or based on predetermined criteria, wherein the plurality of measurement indices comprises a market buzz index, a competition index, an investor interest index, an entrepreneur interest index, a domain skill index, a technology skill index, a commitment index, a funding risk index, and a geography risk index;
compute an execution risk index that determines capability of execution of the idea using the user-defined parameters, in communication with one or more of the plurality of internal data sources and external data sources; and
generate a recommendation score based on the computed measurement indices and the computed execution risk index for generating decision-based contextual recommendations to arrive at one or more decisions related to the idea.
